(19) United States
(12) Patent Application Publication
(10) Pub. No.: US 2023/0315480 A1
(43) Pub. Date: Oct. 5, 2023

(54) COMPUTER-READABLE RECORDING MEDIUM STORING INSTRUCTION SEQUENCE GENERATION PROGRAM, INSTRUCTION SEQUENCE GENERATION METHOD, AND INFORMATION PROCESSING DEVICE

(71) Applicant: Fujitsu Limited, Kawasaki-shi (JP)

(72) Inventor: Kentaro KAWAKAMI, Kawasaki (JP)

(73) Assignee: Fujitsu Limited, Kawasaki-shi (JP)

(21) Appl. No.: 18/157,942

(22) Filed: Jan. 23, 2023

(30) Foreign Application Priority Data
Mar. 30, 2022 (JP) 2022-057711

(51) Int. Cl. G06F 9/38; G06F 9/30

(52) U.S. Cl. CPC G06F 9/3887; G06F 9/30123

(57) ABSTRACT

An instruction sequence generation program for a process including: inputting an instruction sequence for an assembler that processes predetermined operations, and generating the instruction sequence based on a number of SIMD registers, a number of registers to hold values dependent on input values, and a number of registers to hold values independent of input values.

### CROSS-REFERENCE TO RELATED APPLICATION

This application is based upon and claims the benefit of priority of the prior Japanese Patent Application No. 2022-57711, filed on Mar. 30, 2022, the entire contents of which are incorporated herein by reference.

### FIELD

The embodiments discussed herein are related to an instruction sequence generation program, an instruction sequence generation method, and an information processing device.

### BACKGROUND

A just in time (JIT) compiler technique is one of the techniques for raising the execution speed of programs. The JIT compiler technique is a technique that generates a suitable machine language instruction sequence at the time of program execution according to parameters, the processing contents, and the processor status resolved at the time of execution. The machine language instruction sequence generated using the JIT compiler technique is processed faster than an execution program constituted by a versatility processable machine language instruction sequence generated by an ahead of time (AOT) compiler.

Japanese Laid-open Patent Publication No. 2005-122141, Japanese Laid-open Patent Publication No. 2019-185486, and Japanese Laid-open Patent Publication No. 2007-272672 are disclosed as related art.

### SUMMARY

According to an aspect of the embodiments, a computer-readable recording medium storing an instruction sequence generation program for causing a computer to execute a process including: inputting an instruction sequence for an assembler that processes predetermined operations; specifying registers designated as transfer destination operands and registers designated as transfer source operands, for each of instructions; specifying the registers designated as the transfer destination operands in a predetermined instruction as registers intended to hold data from an immediately following instruction to an instruction in which the registers are used as the transfer source operands; propagating distinction, as to whether or not the registers designated as the transfer source operands and the registers intended to hold the data are the registers that are to hold values dependent on input values to be input to the predetermined operations, from immediately preceding instructions, for each of the instructions; distinguishing, for each of the instructions, whether or not the registers designated as the transfer destination operands are the registers that are to hold the values dependent on the input values, according to whether or not the registers designated as the transfer source operands of the instruction include the registers that are to hold the values dependent on the input values; computing a number of registers required to hold the values dependent on the input values and a number of registers required to hold the values independent of the input values, through the instruction sequence; treating the number of the registers required to hold the values dependent on the input values for each of the predetermined operations, as a number of temporary registers that store the values during the operations, and generating count information on the registers in which the number of registers required to hold the values independent of the input values is treated as a number of coefficients; and generating the instruction sequence that performs the predetermined operations on the input values, of which the number equals to the number of a plurality of first single instruction multiple data (SIMD) registers, by using the count information on the registers.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram illustrating a C++ pseudo-source program containing operations, and FIG. 1B is a pseudocode for prototype declarations of a cos function and a log function provided by a math library;

FIG. 2 is a diagram illustrating a flowchart when a computer executes an executable program obtained by compiling the source program in FIG. 1A;

FIG. 3A is a diagram illustrating a pseudocode of a C++ source program that executes processing equivalent to the processing of the source program, with a single instruction multiple data (SIMD) instruction, and FIG. 3B is a pseudocode for prototype declarations of the cos function and the log function provided by a library;

FIG. 4 is a diagram illustrating a flowchart when the computer executes an executable program obtained by compiling the source program in FIG. 3A;

FIG. 5 is a diagram illustrating a C++ pseudo-source program that is premised to be compiled by a JIT compiler technique;

FIG. 6 is a diagram illustrating a flowchart when the computer executes an executable program obtained by compiling the source program;

FIG. 7 is a diagram illustrating a flowchart when the computer executes a code corresponding to a gen_v_cos( ) function on the first line in a machine language executable program obtained by compiling the source program;

FIG. 8 is a diagram illustrating a flowchart when the computer executes a code corresponding to a gen_v_log( ) function on the second line in the machine language executable program obtained by compiling the source program;

FIG. 9 is a schematic diagram illustrating difficulties;

FIG. 10 is a hardware configuration diagram of an information processing device according to a first embodiment;

FIG. 11 is a schematic diagram of a register file included in a processor according to the first embodiment;

FIG. 12 is a functional configuration diagram of the information processing device according to the first embodiment;

FIG. 13 is a schematic diagram illustrating a flow of processing performed by the information processing device according to the first embodiment;

FIG. 14 is a diagram illustrating a flowchart of an instruction sequence generation method according to the first embodiment;

FIG. 15 is a diagram illustrating a flowchart of an instruction sequence generation process according to the first embodiment;

FIG. 16 is a diagram illustrating a flowchart of the instruction sequence generation process when instruction sequences for an optional number of operations are generated in the first embodiment;

FIG. 17 is a schematic diagram illustrating use purposes of SIMD registers used in the first embodiment;

FIG. 18 is a schematic diagram (part 1) illustrating instruction sequences obtained by the instruction sequence generation process according to the first embodiment;

FIG. 19 is a schematic diagram (part 2) illustrating instruction sequences obtained by the instruction sequence generation process according to the first embodiment;

FIG. 20 is a schematic diagram (part 3) illustrating instruction sequences obtained by the instruction sequence generation process according to the first embodiment;

FIG. 21 is a schematic diagram illustrating a method for generating an instruction sequence for cos in the first embodiment;

FIG. 22 is a diagram explaining a method for generating an instruction sequence for log in the first embodiment;

FIG. 23 is a schematic diagram illustrating a flow of a table generation process performed by the information processing device according to the first embodiment;

FIG. 24 is a diagram illustrating a flowchart of a table generation method according to the first embodiment;

FIG. 25 is a diagram illustrating a flowchart of a function extraction process according to the first embodiment;

FIG. 26 is a diagram illustrating an example of the function extraction process according to the first embodiment;

FIG. 27 is a diagram illustrating an example of a file extracted in function units;

FIGS. 28A and 28B are divided portions of a diagram illustrating a flowchart of the table generation process according to the first embodiment;

FIG. 29A is a diagram (1) illustrating an example of the table generation process according to the first embodiment;

FIG. 29B is a diagram (2) illustrating an example of the table generation process according to the first embodiment;

FIG. 29C is a diagram (3) illustrating an example of the table generation process according to the first embodiment;

FIG. 29D is a diagram (4) illustrating an example of the table generation process according to the first embodiment;

FIG. 30 is a diagram illustrating an example of the definition of a table;

FIG. 31 is a diagram illustrating an example of the definition of a template;

FIG. 32A is a diagram illustrating a C++ pseudo-source program in which a summation operation is used in a second embodiment, and FIG. 32B is a schematic diagram of an application program that performs processing equivalent to the processing of this source program;

FIG. 33A is a diagram illustrating a C++ pseudo-source program in which a mean operation is used in the second embodiment, and FIG. 33B is a schematic diagram of the application program that performs processing equivalent to the processing of this source program;

FIG. 34 is a diagram illustrating a flowchart of an instruction sequence generation process according to the second embodiment;

FIG. 35 is a schematic diagram (part 1) illustrating instruction sequences obtained by the instruction sequence generation process according to the second embodiment;

FIG. 36 is a schematic diagram (part 2) illustrating instruction sequences obtained by the instruction sequence generation process according to the second embodiment;

FIG. 37 is a schematic diagram (part 3) illustrating instruction sequences obtained by the instruction sequence generation process according to the second embodiment;

FIG. 38 is a diagram illustrating a difficulty caused when there are many arithmetic functions;

FIG. 39 is a functional configuration diagram of an information processing device according to a third embodiment;

FIG. 40 is a diagram explaining the storage of coefficients carried out in a first generation method;

FIG. 41 is a diagram explaining the storage of coefficients carried out in a second generation method;

FIG. 42 is a diagram explaining the storage of coefficients carried out in a third generation method;

FIG. 43 is a schematic diagram illustrating a flow of processing performed by the information processing device according to the third embodiment;

FIG. 44 is a diagram illustrating a flowchart of an instruction sequence generation method according to the third embodiment;

FIG. 45 is a diagram illustrating a flowchart of an instruction sequence generation process according to the third embodiment;

FIG. 46 is a diagram illustrating a flowchart of the second generation process;

FIG. 47 is a diagram illustrating an example of a number u in the second generation process;

FIG. 48 is a diagram illustrating a flowchart of the third generation process;

FIG. 49 is a diagram illustrating an example of the number u in the third generation process;

FIG. 50 is a diagram illustrating a flowchart of a fourth generation process; and

FIG. 51 is a diagram illustrating a flowchart of a group count computation process.

### DESCRIPTION OF EMBODIMENTS

The machine language instruction sequence generated using the JIT compiler technique has room for improvement in terms of speeding up the execution program. According to one aspect, an object is to speed up a program.

Prior to the description of the present embodiments, the matters as the basics of the present embodiments will be described.

In a source program, a code for performing a variety of operations is sometimes described. If such operations can be executed at high speed, the execution speed of the operations described in the source program will also be enhanced. Thus, the source program containing operations will be described below.

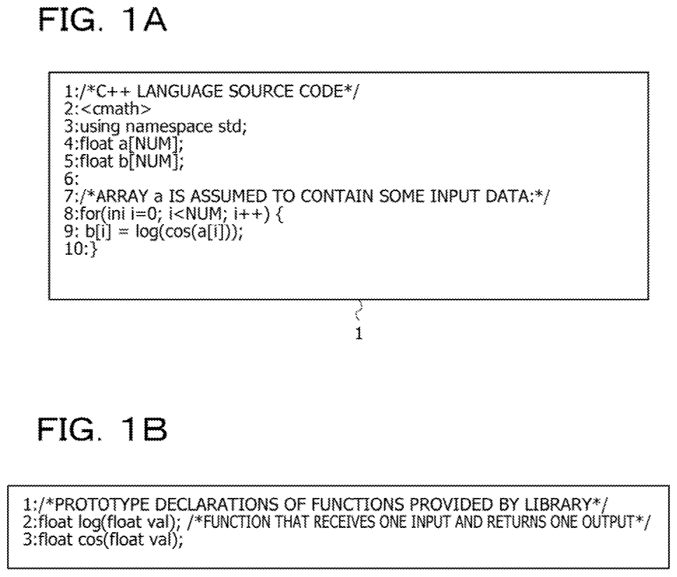

FIG. 1A is a diagram illustrating a C++ pseudo-source program containing operations. This source program 1 is a program that performs an operation combining a cos function and a log function, by a loop length NUM within a loop process by the for statement on the eighth to tenth lines. In C++, these functions are provided by a math library.

FIG. 1B is a diagram illustrating a pseudocode for prototype declarations of the cos function and the log function provided by the math library.

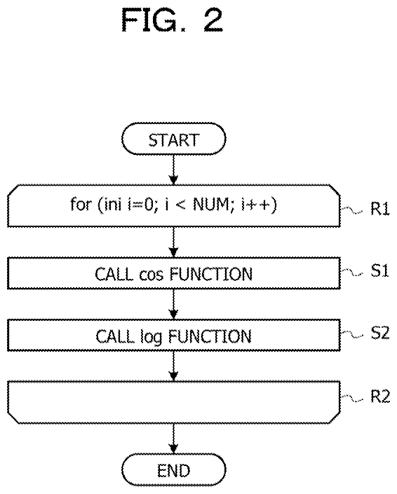

FIG. 2 is a diagram illustrating a flowchart when a computer executes an executable program obtained by compiling the source program 1 in FIG. 1A. In this flowchart, a trapezoidal box R1 indicates start of a loop in which steps S1 and S2, sandwiched by the R1 and a blank reverse trapezoidal box R2, are repeated for a certain number of times as defined in R1. This is also true in all flowcharts depicted in the following descriptions and in the drawings, but explanations and labels for the trapezoidal/reverse trapezoidal boxes are omitted for avoiding redundancy.

First, on the ninth line of the source program 1, the value of cos(a[i]) is obtained by calling the cos function with an array element a[i] as input (step S1).

Next, the log function is called with cos(a[i]) as input, and log(cos(a[i])) obtained by this is stored in an array element b[i] (step S2). Thereafter, steps S1 and S2 are repeated while i is incremented by one at a time within the range of 0≤i≤NUM.

According to this, since step S1 is executed NUM times between the start and end of the loop process, the cos function will be called NUM times. Similarly, also the log function is called NUM times by executing step S2 NUM times.

Accordingly, in this example, the number of function calls between the start and end of the loop process is given as NUM×2.

However, when the respective functions are called more times than the loop length NUM in this manner, the execution speed of the executable program slows down, resulting in poor efficiency.

Next, an example of executing processing equivalent to this using a single instruction multiple data (SIMD) instruction will be described.

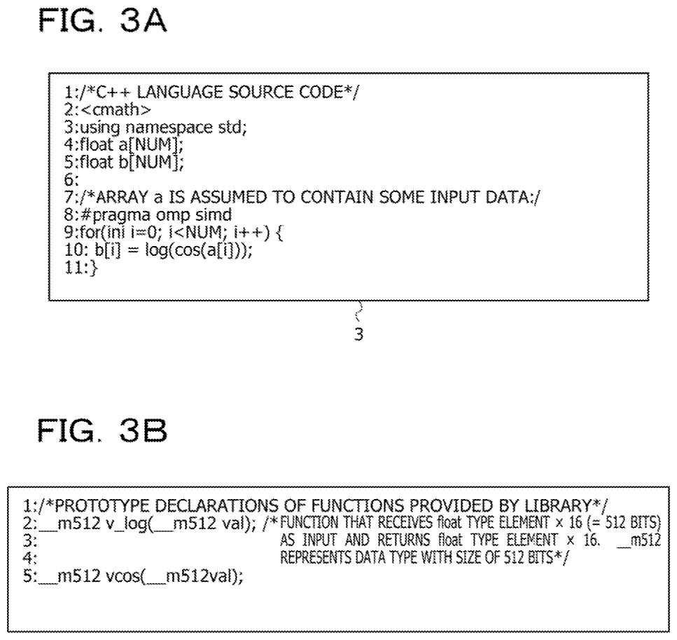

FIG. 3A is a diagram illustrating a pseudocode of a C++ source program 3 that executes processing equivalent to the source program 1 with a SIMD instruction.

In this example, a developer describes the directive statement “#pragma omp simd” to a compiler on the eighth line of the source program 3. With this directive statement, the compiler having an optimization function will execute the loop process by the for statement on the ninth to eleventh lines with the SIMD instruction and generate an executable program. The cos function and the log function are described inside the loop process, where an executable program that executes the processing of these functions by calling functions implemented by the SIMD instruction is generated, and the functions implemented by the SIMD instruction are provided by the math library corresponding to SIMD operations.

FIG. 3B is a pseudocode for prototype declarations of the cos function and the log function provided by the math library corresponding to the SIMD operation.

In the example in FIG. 3B, the processing of the log function is achieved by a v_log function that receives 512-bit data in which 16 pieces of 32-bit float (floating point) type data are concatenated, calculates log of each float type element, and returns 512-bit data obtained by concatenating 16 float type elements as the result of the calculation. Similarly, also the cos function is achieved in relation to a v_cos function.

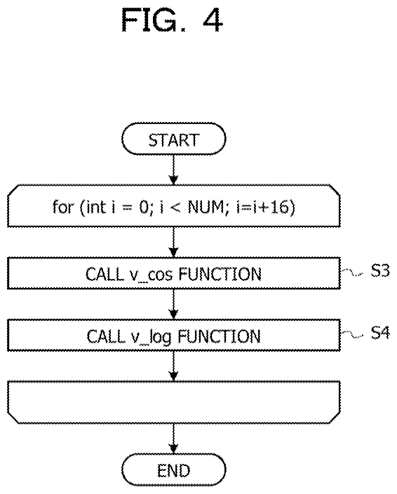

FIG. 4 is a diagram illustrating a flowchart when the computer executes an executable program obtained by compiling the source program 3 in FIG. 3A.

First, on the tenth line of the source program 3, the values of cos(a[i]) to cos(a[i+15]) are obtained by calling the v_cos function with 16 elements, namely, array elements a[i] to a[i+15], as input (step S3).

Next, the v_log function is called with cos(a[i]) to cos(a[i+15]) as input, and log(cos(a[i])) to log(cos(a[i+15])) obtained by this v_log function are stored in array elements b[i] to b[i+15], respectively (step S4). Thereafter, steps S3 and S4 are repeated while i is incremented by 16 at a time within the range of 0≤i≤NUM. Note that the loop length NUM is assumed to be divisible by 16 in this example.

According to this, since step S3 is executed NUM/16 times between the start and end of the loop process, the v_cos function will be called NUM/16 times. Similarly, also the v_log function is called NUM/16 times by executing step S4 NUM/16 times.

Accordingly, in this example, the number of function calls between the start and end of the loop process is given as NUM/16×2.

As a result, the number of function calls is reduced compared with the example in FIG. 1A in which the number of function calls is NUM×2, and the execution speed of the executable program may be enhanced.

Next, a source program that performs processing equivalent to the processing of the source program 3 using a JIT compiler technique will be described.

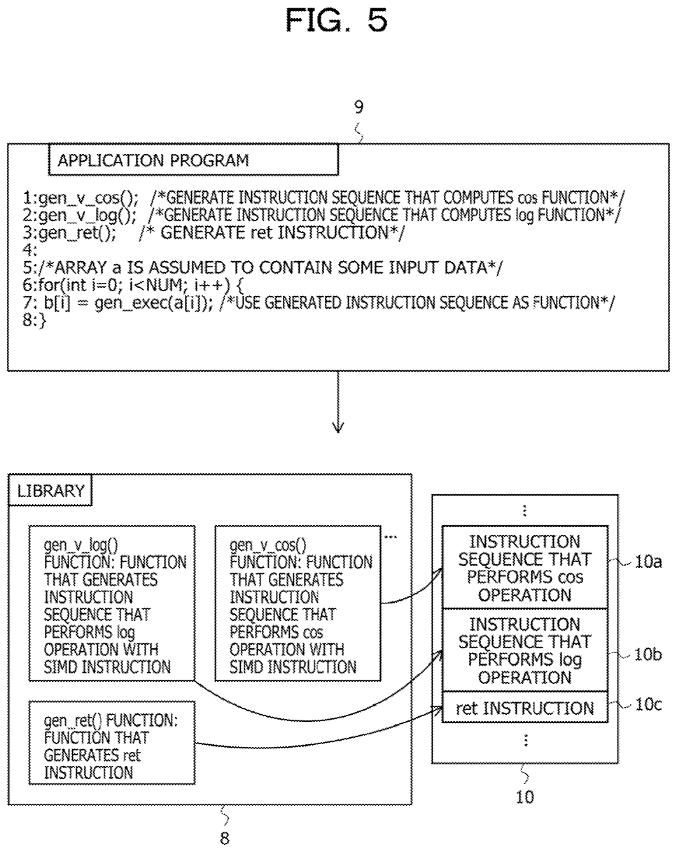

FIG. 5 is a diagram illustrating a C++ pseudo-source program that is premised to be compiled by a JIT compiler technique.

The gen_v_cos( ) function on the first line of this source program 9 is a function that generates an instruction sequence of SIMD instruction that achieves the cos function when an executable program obtained by compiling the source program 9 is executed. The generated instruction sequence is an instruction sequence that receives 512-bit data in which 16 float type elements are concatenated, calculates the cos value of each of the 16 float type elements, and returns the result of the calculation as 512-bit data in which the 16 float type elements are concatenated.

Similarly, the gen_v_log( ) function on the second line is a function that generates an instruction sequence of SIMD instruction that achieves the log function when the executable program is executed. The generated instruction sequence is an instruction sequence that receives 512-bit data in which 16 float type elements are concatenated, calculates the log value of each of the 16 float type elements, and returns the result of the calculation as 512-bit data in which the 16 float type elements are concatenated.

Then, the gen_ret( ) function on the third line is a function that generates a ret instruction to return to the main routine when the executable program is executed.

In this example, it is assumed that each of these gen_v_cos( ) function, gen_v_log( ) function, and gen_ret( ) function is defined in a library 8.

Meanwhile, the loop process by the for statement on the sixth to eighth lines of the source program 9 indicates processing equivalent to the processing of the loop process on the ninth to eleventh lines of the source program 3 (refer to FIG. 3A). In addition, the gen_exec( ) function on the seventh line described inside this loop process is a function that performs processing equivalent to “log(cos(a[i]))”, using the instruction sequence generated by each of the gen_v_cos( ) function and the gen_v_log( ) function.

When the computer executes such an executable program obtained by compiling the source program 9, instruction sequences 10a to 10c separately for a cos operation, a log operation, and the ret instruction are generated in a memory 10 of the computer. In this example, since each function among the gen_v_cos( ) function, the gen_v_log( ) function, and the gen_ret( ) function is called in succession in the first to third lines of the source program 9, the instruction sequences 10a to 10c are also in succession in the memory 10.

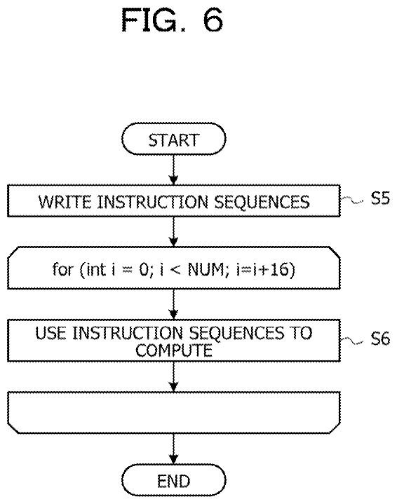

FIG. 6 is a diagram illustrating a flowchart when the computer executes the executable program obtained by compiling the source program 9.

First, the computer writes the instruction sequences 10a to 10c into the memory 10 by executing the first to third lines of the source program 9 (step S5).

Next, when the computer executes the seventh line of the source program 9, the gen_exec( ) function uses the instruction sequences 10a and 10b to compute log(cos(a[i])) to log(cos(a[i+15])) and store the result of the computation in b[i] to b[i+15] (step S6). Thereafter, step S6 is repeated while i is incremented by 16 at a time within the range of 0≤i≤NUM.

According to this, since step S6 is executed NUM/16 times, the area containing the instruction sequences 10a and 10b in the memory 10 is called NUM/16 times in total between the start and end of the loop process. Therefore, the execution speed of the executable program may be raised compared with the example in FIG. 4 in which the number of function calls is NUM/16×2.

Using the JIT compiler technique in this manner raises the execution speed, but the JIT compiler technique has room for further raising the execution speed as described below.

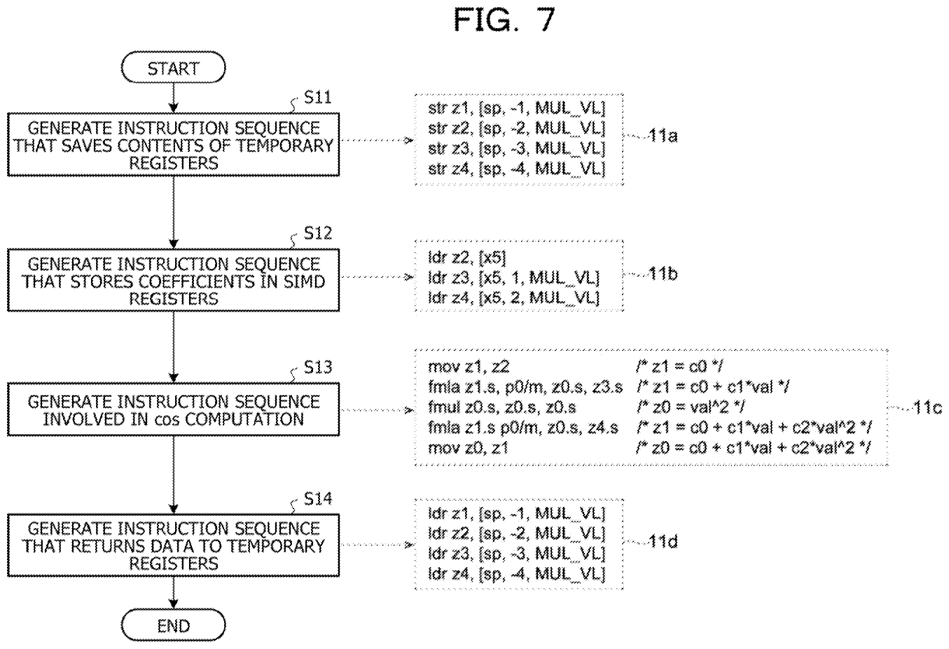

FIG. 7 is a diagram illustrating a flowchart when the computer executes a code corresponding to the gen_v_cos( ) function on the first line in the executable program obtained by compiling the source program 9.

Note that, in the following, an instruction set obtained by extending the Armv8-A instruction set of ARM Ltd. with scalable vector extension (SVE) will be described as an example. In that instruction set, 32 SIMD registers are identified by the character strings “z0”, “z1”, . . . , and “z31”. In addition, 32 scalar registers are identified by the character strings “x0”, “x1”, . . . , and “x31”.

Furthermore, it is assumed that the cos value is calculated by the following formula.

cos(val)=c0+c1×val+c2×val\hat{ }2

In the above, c0, c1, and c2 denote coefficients, and val denotes input data.

In this case, the computer first generates an instruction sequence 11a that saves the contents of temporary registers to stack areas of the memory 10 (step S11). The temporary register is a register for storing values during cos computation, the coefficients c0, c1, and c2, and the like.

In this example, the SIMD registers “z1” to “z4” are used as temporary registers. In addition, the first instruction “str z1, [sp, −1, MUL_VL]” in the instruction sequence 11a is a store instruction that stores the contents of the SIMD register of “z1” to the stack area whose address is smaller than a stack pointer “sp” by one SIMD register. Similarly, succeeding “str z2, [sp, −2, MUL_VL]”, “str z3, [sp, −3, MUL_VL]”, and “str z4, [sp, −4, MUL_VL]” are store instructions that separately store the contents of the SIMD registers “z2” to “z4” to the stack areas.

Next, the computer generates an instruction sequence 11b that stores the coefficients c0, c1, and c2 in the SIMD registers from the memory 10 (step S12).

Here, it is assumed that the address of the coefficient c0 in the memory 10 is stored in the scalar register of “x5”. In this case, the first instruction “Idr z2, [x5]” in the instruction sequence 11b is a load instruction that stores the coefficient c0 stored at the address indicated by the scalar register of “x5”, in the SIMD register of “z2”.

In addition, the next instruction “Idr z3, [x5, 1, MUL_VL]” is a load instruction that stores the coefficient c1 stored at the address greater than the address indicated by the scalar register of “x5” by one SIMD register, in the SIMD register of “z3”.

Similarly, the instruction “Idr z4, [x5, 2, MUL_VL]” is a load instruction that stores the coefficient c2 stored at the address greater than the address indicated by the scalar register of “x5” by two SIMD registers, in the SIMD register of “z4”.

Next, the computer generates an instruction sequence 11c involved in cos computation (step S13).

A mov instruction contained in the instruction sequence 11c is a move instruction that copies data between registers. In addition, a fmla instruction is a multiply-add operation instruction for floating point data, and fmul denotes a multiply instruction for floating point data. Furthermore, “p0” denotes a predicate register, and “/m” represents a merging predicate. The meaning of each instruction contained in the instruction sequence 11c is as indicated by the comment text beginning with “/*”. The predicate register is called a mask register in CPUs based on the x64 architecture. In the present specification, the mask register is used as a synonym for the predicate register, and a mask instruction is used as a synonym for a predicate instruction.

Next, the computer generates an instruction sequence 11d that returns the data saved beforehand in the stack areas of the memory 10 to the temporary registers (step S14). The first instruction “Idr z1, [sp, −1, MUL_VL]” in the instruction sequence 11d is a load instruction that returns data saved in the stack area whose address is smaller than the stack pointer “sp” by one SIMD register, to the SIMD register of “z1”. Similarly, “Idr z2, [sp, −2, MUL_VL]”, “Idr z3, [sp, −3, MUL_VL]”, and “Idr z4, [sp, −4, MUL_VL]” are load instructions that return the data placed in the stack areas whose addresses are smaller than the stack pointer “sp” by two to four SIMD registers, to the SIMD registers “z2” to “z4”.

The above will obtain the instruction sequence 10a including the instruction sequences 11a to 11d (refer to FIG. 5). Next, the instruction sequence generated by the gen_v_log( ) function will be described.

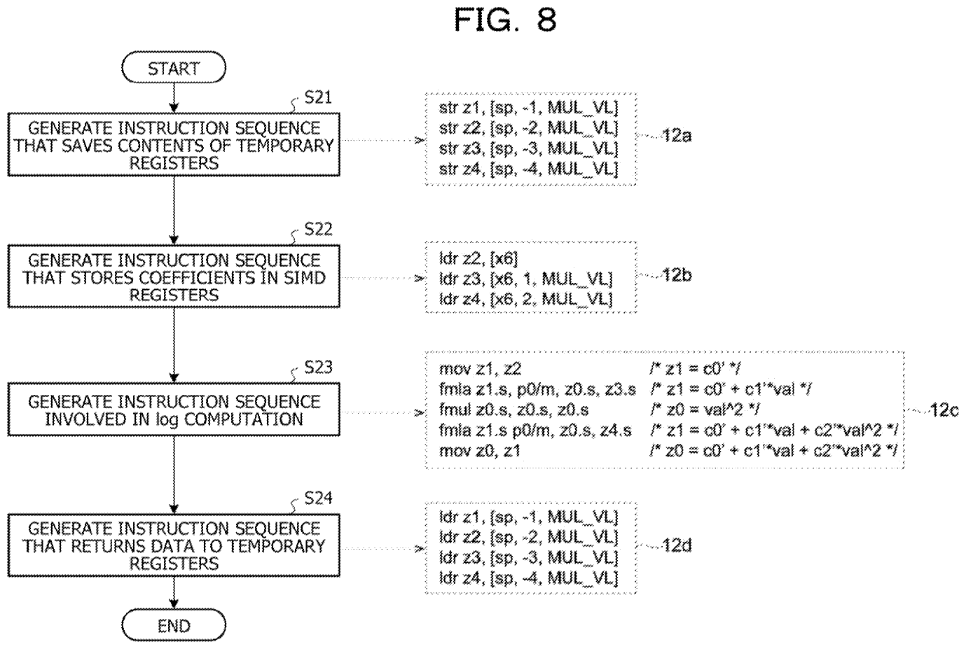

FIG. 8 is a diagram illustrating a flowchart when the computer executes a code corresponding to the gen_v_log( ) function on the second line in the executable program obtained by compiling the application program 9.

Note that, in the following, it is assumed that the log value is calculated by the following formula.

log(val)=c0′+c1′×val+c2′×val\hat{ }2

In the above, c0′, c1′, and c2′ denote coefficients, and val denotes an input element.

In this case, the computer generates the instruction sequence 10b including instruction sequences 12a to 12d by executing the process as follows. Note that, since the meanings of these instruction sequences 12a to 12d are the similar to the meaning of the instruction sequences 11a to 11d described above, the description thereof will be omitted below.

First, the computer generates the instruction sequence 12a that saves the contents of temporary registers to stack areas of the memory 10 (step S21).

Next, the computer generates the instruction sequence 12b that stores the coefficients c0′, c1′, and c2′ in the SIMD registers from the memory 10 (step S22). Note that, in this example, it is assumed that the address of the coefficient c0′ in the memory 10 is stored in the scalar register of “x6”.

Next, the computer generates the instruction sequence 12c involved in log computation (step S23).

Then, the computer generates the instruction sequence 12d that returns the data saved beforehand in the stack areas of the memory 10 to the temporary registers (step S24). Thereafter, the computer generates a ret instruction 13 (step S25).

The above will obtain the instruction sequence 10b including the instruction sequences 12a to 12d (refer to FIG. 5).

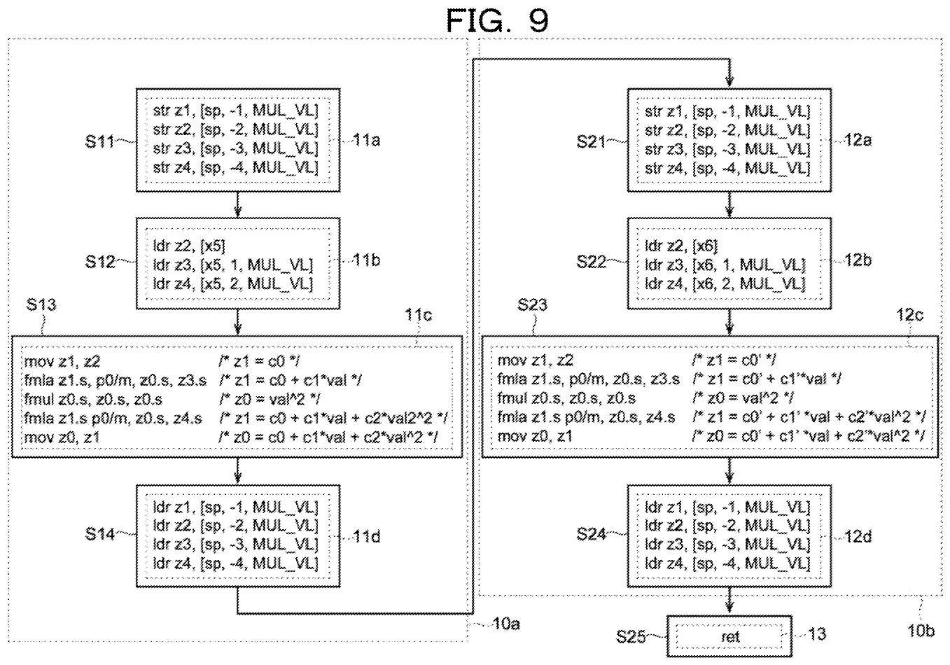

FIG. 9 is a schematic diagram illustrating difficulties caused by the instruction sequences 10a and 10b generated as described above.

Difficulty 1

The instruction sequences 11b and 12b include the load instructions that store the coefficients c0, c1, and c2 and the coefficients c0′, c1′, and c2′ in the SIMD registers from the memory 10. As described with reference to FIG. 6, since the number of function calls in this example is NUM/16, the instruction sequences 11b and 12b are executed also NUM/16 times.

However, calling the same instruction sequence 11b a plurality of times every NUM/16 times of execution is redundant. This similarly applies also to the instruction sequence 12b.

Difficulty 2

In the instruction sequence 11c, the destination register of a certain instruction is used as the source register of the immediately following instruction. For example, in the instruction “mov z1, z2”, “z1” denotes the destination register. In the immediately following instruction “fmla z1.s, p0/m, z0.s, z3.s”, which is an instruction that computes (the value of the z1 register+the value of the z0 register×the value of the z3 register) and substitutes the result into the z1 register, “z1” serves as the source register (one of the input values of the computation). In the following, when the destination register of a certain instruction is used as the source register of the immediately following instruction in this manner, this will be expressed that there is a dependency relationship between these instructions.

The processor executes this instruction sequence 11c through a pipeline process including an instruction fetch (IF) stage, an instruction decode (ID) stage, an execution (EX) stage, and a writeback (WB) stage. At this time, when there is a dependency relationship between instructions, the input data to be supplied to an arithmetic logic unit (ALU) of the next instruction will not be allowed to be fixed unless the immediately preceding instruction completes the WB stage and the result is fixed, which will not allow the immediately following instruction to use the ALU to execute the EX stage. As a result, a stall occurs in the pipeline process and the execution speed of the executable program slows down.

Difficulty 3

After the instruction sequence 11d returns the data saved beforehand in the stack areas of the memory 10 to the temporary registers, the immediately following instruction sequence 12a again saves these pieces of data to the stack areas. These instruction sequences 11d and 12a are redundant when the cos and log computations are performed in succession, and this slows down the execution speed of the executable program.

Difficulty 4

As described with reference to FIG. 6, since the number of function calls in this example is NUM/16, the instruction sequences 11d and 12a are executed also NUM/16 times.

However, calling the same instruction sequences 11a and 12d a plurality of times every NUM/16 times of execution is redundant. The present embodiments capable of solving the difficulties 1 to 4 will be described below.

### First Embodiment

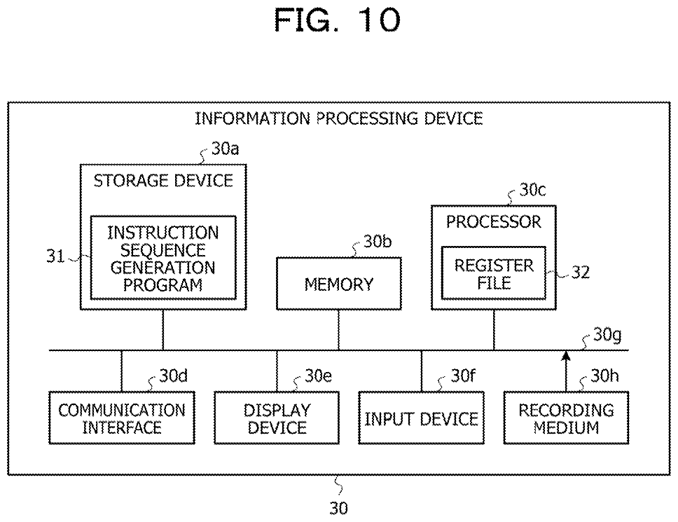

FIG. 10 is a hardware configuration diagram of an information processing device according to the present embodiment. The information processing device 30 is a computer such as a high performance computer (HPC) or a server and includes a storage device 30a, a memory 30b, a processor 30c, a communication interface 30d, a display device 30e, and an input device 30f. These units are interconnected to each other by a bus 30g.

Among these, the storage device 30a is a non-volatile storage device such as a hard disk drive (HDD) or a solid state drive (SSD) and stores the instruction sequence generation program 31 according to the present embodiment. The instruction sequence generation program 31 is a program obtained by compiling a source program and is a machine language binary file executable by the processor 30c.

Note that the instruction sequence generation program 31 may be recorded beforehand in a computer-readable recording medium 30h, and the processor 30c may read the instruction sequence generation program 31 in the recording medium 30h.

As the recording medium 30h described above, for example, physically portable recording media such as a compact disc-read only memory (CD-ROM), a digital versatile disc (DVD), and a universal serial bus (USB) memory are included. In addition, a semiconductor memory such as a flash memory or a hard disk drive may be used as the recording medium 30h. The recording medium 30h mentioned above is not a temporary medium such as a carrier wave having no physical form.

Furthermore, the instruction sequence generation program 31 may be stored beforehand in a device connected to a public network, the Internet, a local area network (LAN), or the like, and the processor 30c may read and execute the stored instruction sequence generation program 31.

Meanwhile, the memory 30b is hardware that temporarily stores data, such as a dynamic random access memory (DRAM), into which the above-mentioned instruction sequence generation program 31 will be loaded.

The processor 30c is hardware such as a central processing unit (CPU) or a graphical processing unit (GPU) that, for example, controls each unit of the information processing device 30 and executes the instruction sequence generation program 31 in cooperation with the memory 30b. In addition, the processor 30c includes a register file 32 for holding data involved in calculation operations.

Furthermore, the communication interface 30d is an interface for connecting the information processing device 30 to a network such as a local area network (LAN).

Then, the display device 30e is hardware such as a liquid crystal display device and displays prompts that prompt the developer to input various sorts of information. In addition, the input device 30f is hardware such as a keyboard and a mouse.

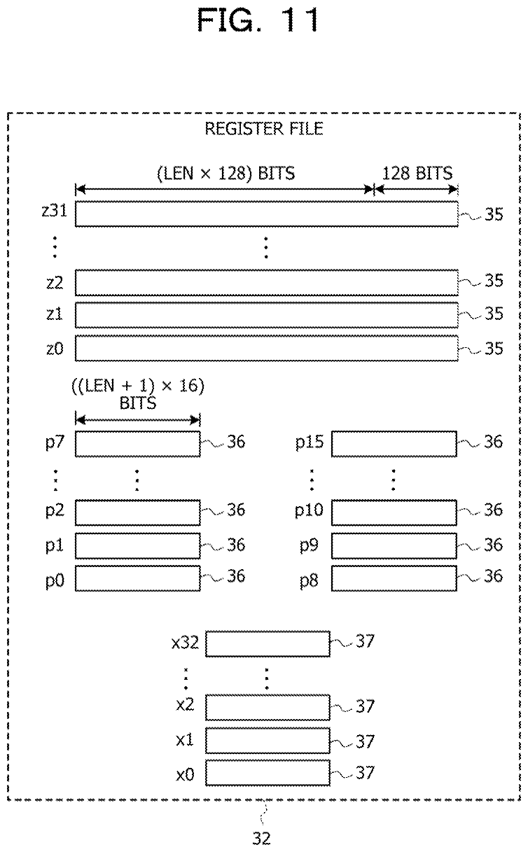

FIG. 11 is a schematic diagram of the register file 32 included in the processor 30c. In the following, a case where the processor 30c executes an instruction set obtained by extending the Armv8-A instruction set with SVE will be described as an example.

As illustrated in FIG. 11, the register file 32 includes a plurality of SIMD registers 35, predicate registers 36, and scalar registers 37 separately.

In the case of a CPU based on the Armv8-A architecture of ARM Ltd., the vendor that develops the CPU is permitted to implement the bit length of an SVE register, which is a SIMD register, by selecting one from among 128, 256, 384, . . . , and 2048. In FIG. 11, when LEN=3 is adopted, the bit length of the SIMD register will have 512 bits. In the following, the plurality of SIMD registers 35 will be identified from each other by the character strings “z0”, “z1”, . . . , and “z31”.

Meanwhile, the predicate registers 36 are registers having a bit length of ((LEN+1)×16) for executing the mask instruction and are identified by the character strings “p0”, “p1”, . . . , and “p15”.

In addition, the scalar registers 37 are registers for holding scalar variables. In the following, the plurality of scalar registers 37 will be identified from each other by the character strings “x0”, “x1”, . . . , and “x31”.

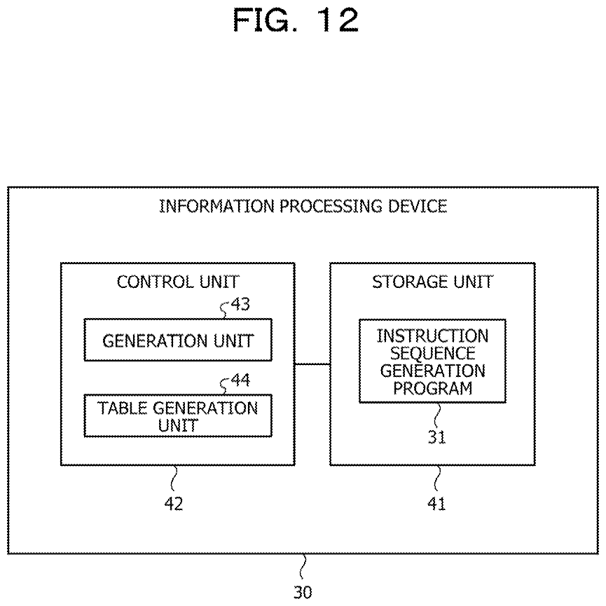

FIG. 12 is a functional configuration diagram of the information processing device 30. As illustrated in FIG. 12, the information processing device 30 includes a storage unit 41 and a control unit 42.

Among these, the storage unit 41 is a processing unit that stores the instruction sequence generation program 31. As an example, the storage unit 41 is achieved by the storage device 30a and the memory 30b in FIG. 10.

Meanwhile, the control unit 42 is a processing unit that controls each unit of the information processing device 30 and includes a generation unit 43 and a table generation unit 44. The generation unit 43 is a processing unit that generates an instruction sequence when the instruction sequence generation program 31 is executed. The table generation unit 44 is a processing unit that generates a table used for generating instruction sequences. Such functions of the control unit 42 are achieved by the memory 30b and the processor 30c executing the instruction sequence generation program 31 in cooperation. Note that description of the table and the processing of the table generation unit 44 will be given later.

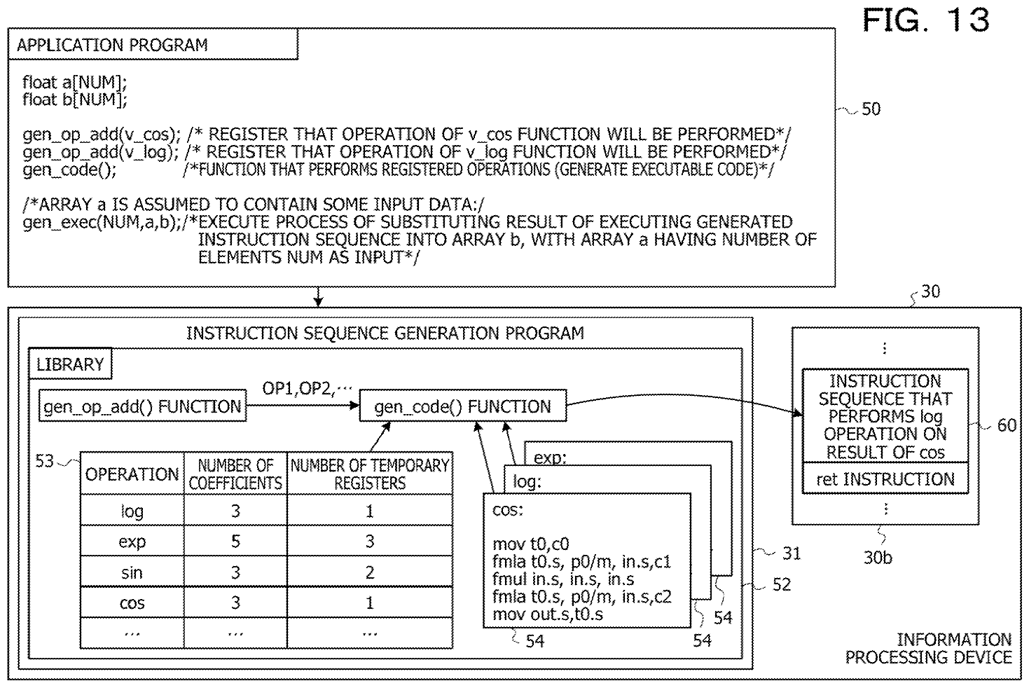

FIG. 13 is a schematic diagram illustrating a flow of processing performed by the information processing device 30.

In this example, the information processing device 30 executes the instruction sequence generation program 31, which is a machine language binary file obtained by compiling an application program 50.

Note that the application program 50 may be compiled by the information processing device 30, or may be compiled by a computer different from the information processing device 30.

It is assumed that each of functions gen_op_add(v_cos), gen_op_add(v_log), gen_code( ), and gen_exec(NUM, a, b) is described in the application program 50.

Among these, the gen_op_add(v_cos) function is a function that registers, in the memory 30b, that the cos operation will be performed in the SIMD registers 35. As an example, the gen_op_add(v_cos) function registers, in the memory 30b, that the cos operation will be performed in the SIMD registers 35, by storing the character string “OP1” indicating that the operation is classified as cos, in a predetermined area of the memory 30b.

Similarly, the gen_op_add(v_log) function is a function that registers, in the memory 30b, that the log operation will be performed in the SIMD registers 35, by storing the character string “OP2” indicating that the type of operation is log, in a predetermined area of the memory 30b.

Note that cos is an example of a first operation, and log is an example of a second operation.

Meanwhile, the gen_code( ) function is a function that generates an instruction sequence, using operations represented by the character strings such as “OP1” and “OP2” stored in the memory 30b. Here, it is assumed that the gen_code( ) function generates an instruction sequence 60 for executing an operation log(cos) that performs cos and log in this order.

The gen_exec(NUM, a, b) function is a function that stores the execution result of the instruction sequence 60 generated by the gen_code( ) function, in an array b. Note that the input data for the operation executed by the instruction sequence is stored in each element of an array a. In addition, NUM denotes the number of elements of the arrays a and b targeted for the operation log(cos) to be executed.

The information processing device 30 executes the instruction sequence generation program 31 obtained by compiling such an application program 50. A library 52 is linked to the instruction sequence generation program 31 at the time of compilation. The linked library 52 includes a table 53 in which the number of coefficients involved in an operation and the number of temporary registers to store values during the operation are associated with the operation. Note that the table 53 is an example of count information on the registers.

For example, the number of coefficients involved in the cos operation is three, and the number of temporary registers to store values during the cos operation is one. In addition, the number of coefficients involved in the log operation is also three, and the number of temporary registers to store values during the log operation is also one. Note that the coefficients involved in the cos operation is an example of first coefficients, and the coefficients involved in the log operation is an example of second coefficients.

Furthermore, the library 52 includes templates 54 indicating definitions of a plurality of instructions (instruction sequences) involved in operations, for each operation. For example, the template 54 for cos indicates that the cos operation can be executed by executing the respective instructions “mov t0, c0”, “fmla t0.s, p0/m, in.s, c1”, “fmul in.s, in.s, in.s”, “fmla t0.s, p0/m, in.s, c2”, and “mov out.s, t0.s” in this order. Here, in means the input data, tN (N=0, 1, 2, . . . ) means the values during the operation, cN (N=0, 1, 2, . . . ) means coefficients, and out means SIMD registers to separately store the operation results. On the Armv8-A architecture, “.s” means that the SIMD registers are used as SIMD for 32-bit data, and besides, there are “.b”, “.h”, and “.d”, which represent SIMD for 8, 16, and 64-bit data, respectively. Note that the table 53 and the templates 54 are generated by the table generation unit 44.

In this case, the generation unit 43 specifies that cos and log are the operations intended to be executed, by referring to the character strings “OP1” and “OP2” stored in the memory 30b by the gen_op_add(v_cos) and gen_op_add(v_log) functions, respectively, by executing the gen_code( ) function.

Next, the generation unit 43 specifies each of the number of coefficients and the number of temporary registers corresponding to each of the specified operations cos and log, from the table 53, by executing the gen_code( ) function.

Furthermore, the generation unit 43 specifies the templates 54 corresponding to each of the specified operations cos and log, by executing the gen_code( ) function.

Then, the generation unit 43 generates the instruction sequence 60 in the memory 30b, based on each of the specified number of coefficients and number of temporary registers, and templates 54, by executing the gen_code( ) function. The generated instruction sequence 60 is an instruction sequence that performs cos and log in this order as described above. Note that the generation unit 43 appends the ret instruction for returning to the main routine of the instruction sequence generation program 31, to the end of the instruction sequence 60, by executing the gen_code( ) function.

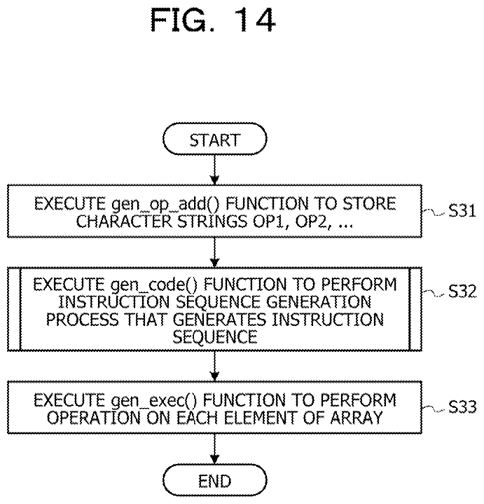

FIG. 14 is a diagram illustrating a flowchart of an instruction sequence generation method according to the present embodiment. First, the generation unit 43 stores the character string “OPi” (i=1, 2, . . . ) indicating one or more operations, in the memory 30b, by executing the gen_op_add( ) function (step S31).

Next, the generation unit 43 performs an instruction sequence generation process that generates the instruction sequence 60, by executing the gen_code( ) function (step S32). The details of the above-mentioned instruction sequence generation process will be described later.

Thereafter, the generation unit 43 performs the operation indicated by the instruction sequence 60 on each element of the array, by executing the gen_exec( ) function (step S33).

With the above, the basic process of the instruction sequence generation method according to the present embodiment is finished. Next, the instruction sequence generation process in step S32 will be described.

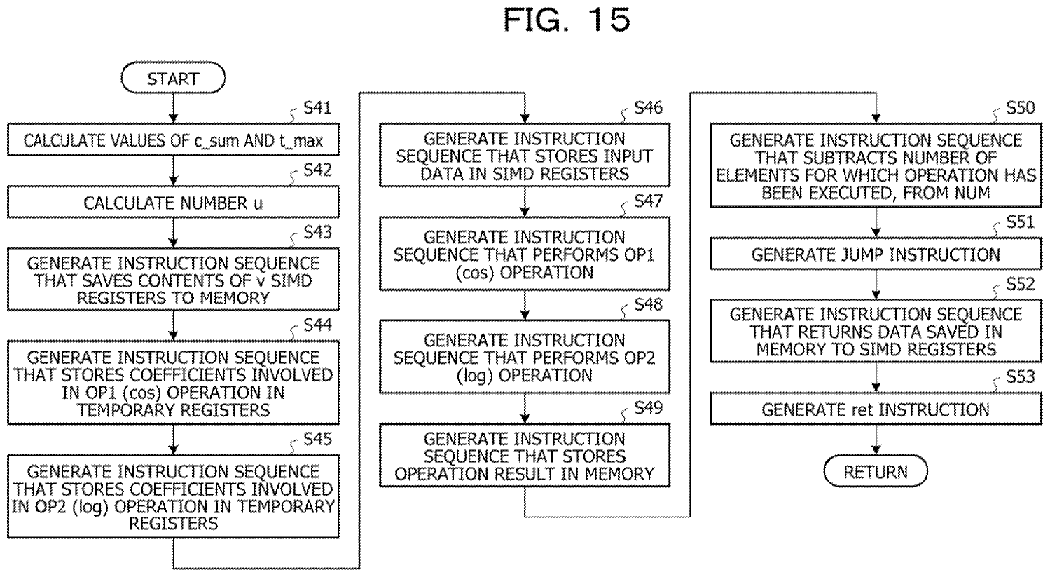

FIG. 15 is a diagram illustrating a flowchart of the instruction sequence generation process according to the present embodiment. First, the generation unit 43 calculates the value of each of c_sum and t_max, by referring to the table 53 (step S41).

Among these, c_sum denotes the sum of the number of coefficients involved in each operation indicated by the character strings “OP1” and “OP2” stored in the memory 30b. In the following, it is assumed that the operations indicated by the character strings “OP1” and “OP2” are cos and log, respectively. In this case, c_sum will have six. Meanwhile, t_max denotes the maximum value of the number of temporary registers involved (or required) in each of the operations indicated by the character strings “OP1” and “OP2”. In this example, t_max will have one.

Next, the generation unit 43 calculates the number u of SIMD registers 35 that can store the input data in one loop process (step S42). The method for calculating the number u is not particularly limited, but in the present embodiment, the generation unit 43 calculates the number u in accordance with the following formula.

u=floor((R−c_sum)/(1+t_max))

In the above, R denotes the number of SIMD registers 35, and floor denotes an operation for rounding down decimal places. In this formula, “R−c_sum” is given for the reason in consideration that the total number of SIMD registers available for use purposes other than the use purpose of storing coefficients in all iterations of the loop process will be “R−c_sum” because c_sum of SIMD registers 35, of which the number is R in total, are used to store coefficients. In addition, “1+t_max” represents that (1+t_max) SIMD registers 35 are used every time the input data is stored in one SIMD register. This gives the number u of SIMD registers 35 that can store the input data in one loop process as “floor((R−c_sum)/(1+t_max))” as described above. When R is 32 as in the present embodiment, u=floor((32−6)/(1+1))=floor(13)=13 is given.

Next, the generation unit 43 generates an instruction sequence that saves the contents of v SIMD registers 35 to the memory 30b (step S43). The method for calculating the number v is not particularly limited, but in the present embodiment, the generation unit 43 calculates the number v in accordance with the following formula.

v=(1+t_max)×u+c_sum

This is because the number of SIMD registers 35 for storing coefficients is “c_sum”, the number of SIMD registers 35 used in all loop processes is “(1+t_max)×u”, and the contents of all of these SIMD registers 35 have to be saved. Note that, in the above example, v=(1+1)×13+6=32 is given.

Next, the generation unit 43 generates an instruction sequence that stores the coefficients involved in the operation (cos) corresponding to the character string “OP1” in the SIMD registers 35 for temporary registers (step S44).

Subsequently, the generation unit 43 generates an instruction sequence that stores the coefficients involved in the operation (log) corresponding to the character string “OP2” in the SIMD registers 35 for temporary registers (step S45).

Next, the generation unit 43 generates an instruction sequence that stores the input data in each element of the u SIMD registers 35 (step S46).

Thereafter, the generation unit 43 generates an instruction sequence that performs the operation (cos) corresponding to the character string “OP1” separately for each element of the u SIMD registers 35 (step S47).

Similarly, the generation unit 43 generates an instruction sequence that performs the operation (log) corresponding to the character string “OP2” separately for each element of the u SIMD registers 35 (step S48).

By performing steps S47 and S48 in succession in this manner, the instruction sequence 60 (refer to FIG. 13) for executing the operation log(cos) will be obtained.

Next, the generation unit 43 generates an instruction sequence that stores the operation result in step S48 in the memory 30b (step S49).

Subsequently, the generation unit 43 generates an instruction that subtracts the number of elements of the array a for which the operation log(cos) has been executed, from NUM (step S50).

Next, the generation unit 43 determines whether the value obtained by subtracting the number of elements of the array a for which the operation log(cos) has been executed, from NUM is greater than zero and, when determining to be greater than zero, generates a jump instruction that jumps to the top of the instruction sequence generated in step S46 (step S51).

Subsequently, the generation unit 43 generates an instruction sequence that returns the data saved beforehand in the memory 30b in step S33 to the SIMD registers 35 (step S52).

Thereafter, the generation unit 43 generates the ret instruction for returning to the main routine (step S53).

With the above, the basic process of the instruction sequence generation process in step S32 is finished. Note that, in this example, the instruction sequences for executing two operations indicated by the character strings “OP1” and “OP2” are generated in steps S47 and S48, respectively, but the number of operations is not limited to two and may be an optional number.

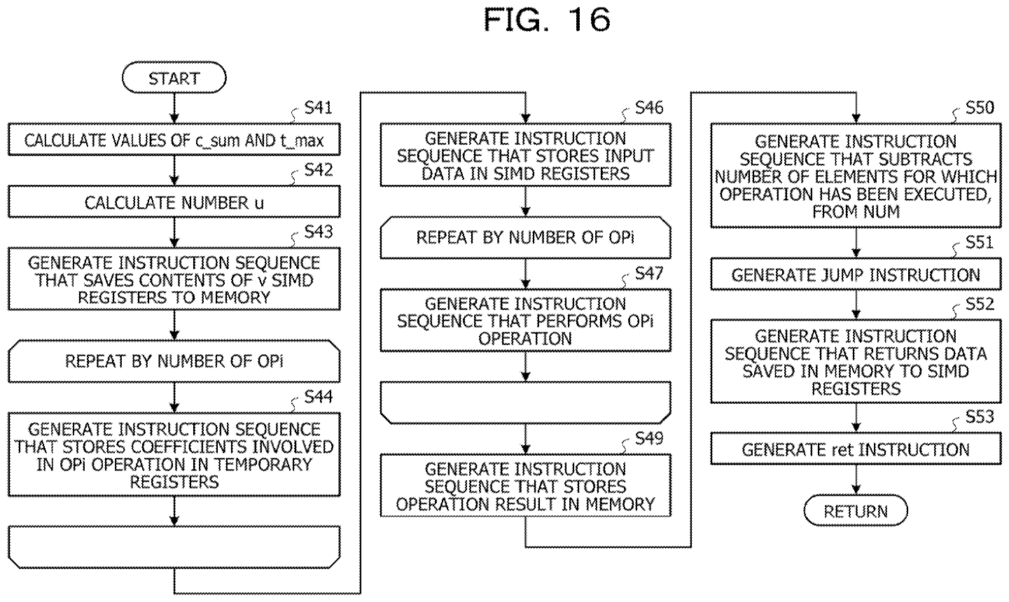

FIG. 16 is a diagram illustrating a flowchart of the instruction sequence generation process when instruction sequences for an optional number of operations are generated. Note that, in FIG. 16, the same steps as in FIG. 15 will be given the same reference signs as in FIG. 15, and the description thereof will be omitted below.

As illustrated in FIG. 16, when the number of operations is optional, each of steps S44 and S47 only has to be repeated by the number of operations.

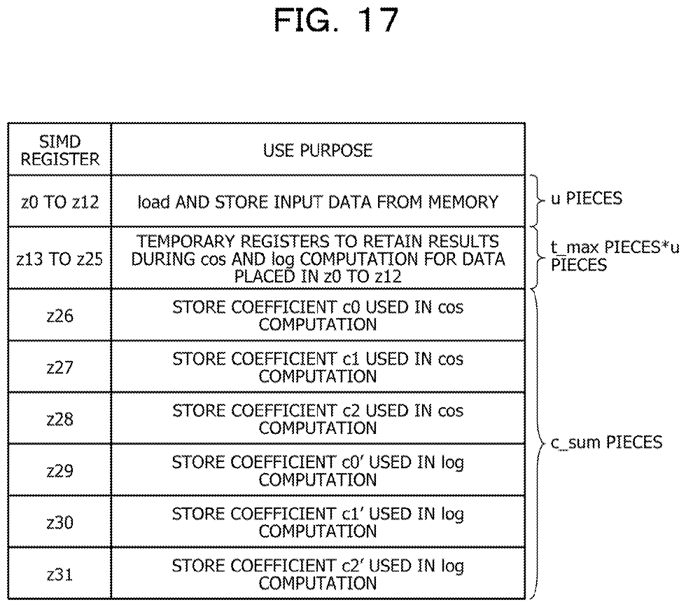

FIG. 17 is a schematic diagram illustrating use purposes of the SIMD registers 35 used in the present embodiment.

As illustrated in FIG. 17, in this example, thirteen (=u) SIMD registers 35 from “z0” to “z12” are used as registers for storing the input data placed in the memory 30b.

In addition, thirteen (=t_max×u) SIMD registers 35 from “z13” to “z25” are used as temporary registers for retaining the results during the cos and log operations.

Then, six (=c_sum) SIMD registers 35 from “z26” to “z31” are used as registers for storing coefficients involved in each of the cos and log operations.

Next, the instruction sequences obtained by the instruction sequence generation process in FIG. 15 will be described.

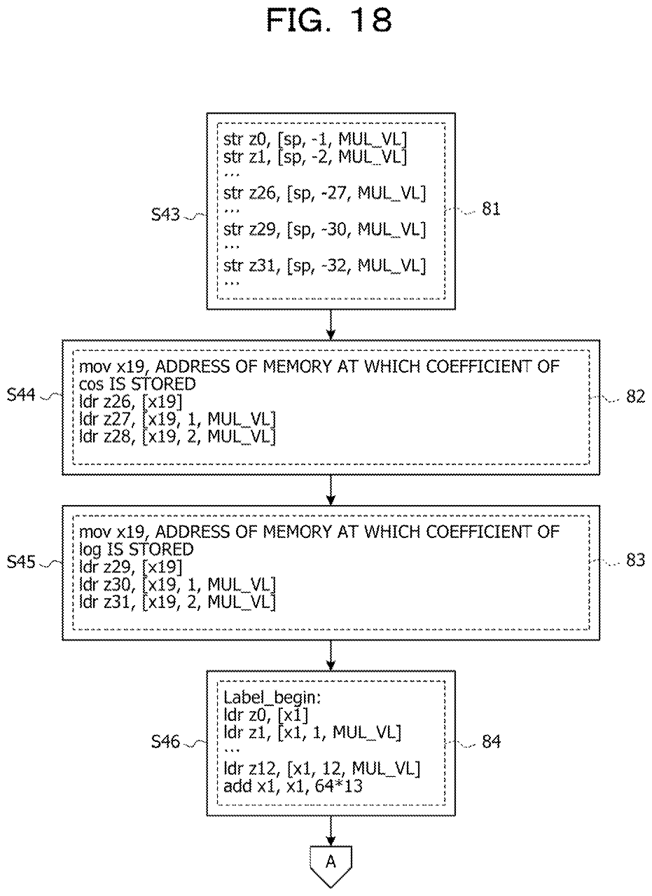

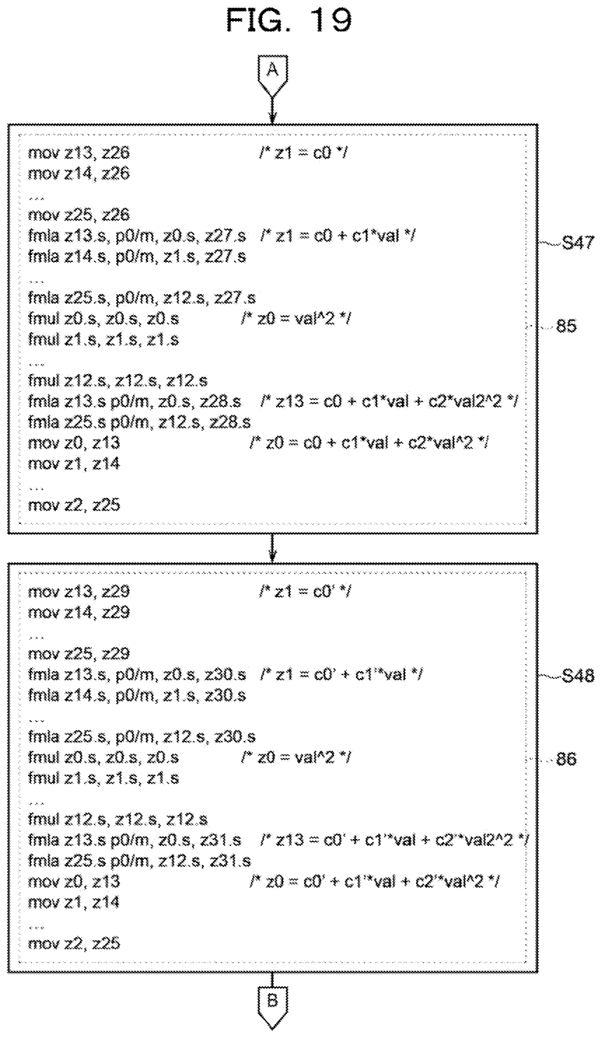

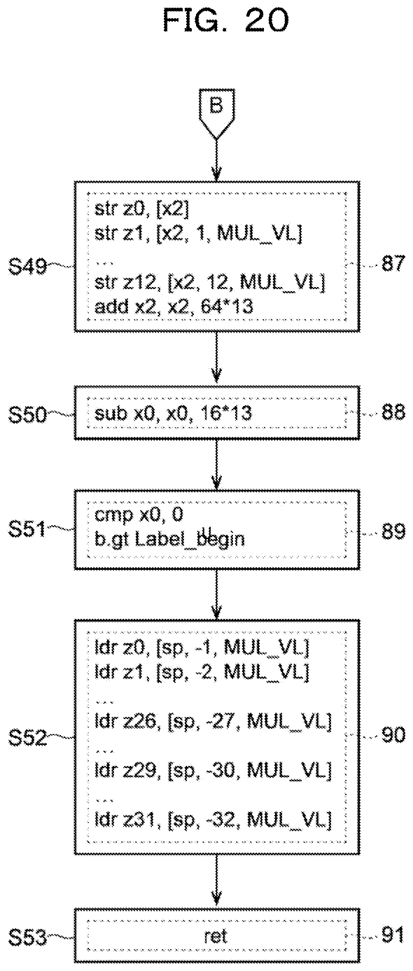

FIGS. 18 to 20 are schematic diagrams illustrating instruction sequences obtained by the instruction sequence generation process.

First, in step S43, the generation unit 43 generates an instruction sequence 81 that saves the contents of the 32 SIMD registers 35 from “z0” to “z31” to the memory 30b. The instruction “str z26, [sp, −27, MUL_VL]” in the generated instruction sequence 81 is an example of an eighth instruction that stores the contents of the SIMD register 35 of “z26” for storing the coefficient c0 involved in the cos computation, in the memory 30b. Note that the SIMD register 35 of “z26” is an example of a second SIMD register, and the coefficient c0 is an example of the first coefficient.

Similarly, the instruction “str z29, [sp, −30, MUL_VL]” is an example of a ninth instruction that stores the contents of the SIMD register 35 of “z29” for storing the coefficient c0′ involved in the log computation, in the memory 30b. Furthermore, the SIMD register 35 of “z29” is an example of a third SIMD register, and the coefficient c0′ is an example of the second coefficient.

Next, in step S44, the generation unit 43 generates an instruction sequence 82 that stores the coefficients c0, c1, and c2 involved in the cos operation, in the SIMD registers 35 of “z26” to “z28” for temporary registers.

The mov instruction at the top of the generated instruction sequence 82 is an instruction that copies the address in the memory 30b at which the coefficient c0 is stored, to the scalar register 37 of “x19”. Note that, in this example, it is assumed that the coefficients c1 and c2 are stored at addresses obtained by subtracting one SIMD register and two SIMD registers from the address of the coefficient c0, respectively. Furthermore, the instruction “Idr z26, [x19]” in this instruction sequence 82 is an example of a third instruction.

Further in step S44, the generation unit 43 generates an instruction sequence 83 that stores the coefficients c0′, c1′, and c2′ involved in the log operation, in the SIMD registers 35 of “z29” to “z31” for temporary registers.

The mov instruction at the top of the instruction sequence 83 is an instruction that copies the address in the memory 30b at which the coefficient c0′ is stored, to the scalar register 37 of “x19”. In addition, in this example, it is assumed that the coefficients c1′ and c2′ are stored at addresses obtained by subtracting one SIMD register and two SIMD registers from the address of the coefficient c0′, respectively. Furthermore, the instruction “Idr z29, [x19]” in this instruction sequence 83 is an example of a seventh instruction.

Subsequently, in step S46, the generation unit 43 generates an instruction sequence 84 that stores the input data in each element of the 13 (=u) SIMD registers 35 from “z0” to “z12”.

The label “Label_begin” in the generated instruction sequence 84 is a label indicating a jump destination of the jump instruction described later.

In addition, here, it is assumed that the top address of the array a is stored in the scalar register 37 of “x1”. This will cause, for example, the instruction “Idr z0, [x1]” to store the input data stored in each of M elements “a[0]” to “a[M−1]” from the top of the array a, in the SIMD register 35 of “z0”. When the SIMD register has a bit length of 512 bits, since one SIMD register can accommodate 16 pieces of 32-bit floating point data, M=16 is given. In addition, the next instruction “Idr z1, [x1, 1, MUL_VL]” is an instruction that stores the input data stored in each of the next M elements “a[M]” to “a[2M−1]” of the array a, in the SIMD register 35 of “z1”.

Then, the last instruction “add x1, x1, 64*13” is an instruction that increments the address stored in “x1” by 64×13 (=M×u), which is the number of pieces of the input data stored in the 13 (=u) SIMD registers 35. Since the addresses are designated in byte units in the Armv8-A architecture, the input data intended to be processed next is shifted by 64 bytes. Here, 64 indicates a byte address (512 bits=64 bytes).

Next, in step S47, the generation unit 43 generates an instruction sequence 85 for performing the cos operation. This instruction sequence 85 is an example of a first instruction sequence. Note that the contents of the instruction sequence 85 and a method for generating the instruction sequence 85 will be described later.

Further in step S47, the generation unit 43 generates an instruction sequence 86 for performing the log operation. By generating the instruction sequence 86 that executes log immediately after the instruction sequence 85 that executes cos in this manner, the operation log(cos) will be performed on each element of the array a.

Subsequently, in step S49, the generation unit 43 generates an instruction sequence 87 that stores the operation result of step S48 in the memory 30b. For example, the first instruction “str z0, [x2]” of this instruction sequence 87 is an instruction that stores the computation result stored in the SIMD register 35 of “z0” in the address stored in the scalar register 37 of “x2”. In addition, the next instruction “str z1, [x2, 1, MUL_VL]” is an instruction that stores the computation result stored in SIMD register 35 of “z1” in the address obtained by incrementing the address stored in “x2” by one SIMD register.

In addition, the last instruction “add x2, x2, 64*13” is an instruction that increments the address stored in “x2” by 64×13 (=the number of bytes of the SIMD register size×u), which is the number of pieces of the input data stored in the 13 (=u) SIMD registers 35.

Next, in step S50, the generation unit 43 generates an instruction 88 that subtracts the number of elements 16×13 (=the number of pieces of float data that can be stored in one SIMD register×u) of the array a for which the operation log(cos) has been executed, from the NUM stored in the scalar register 37 of “x0”. In the generated instruction 88, the value obtained by subtracting 16×13, which is the number of elements for which the operation has been executed, from NUM is stored in the scalar register 37 of “x0”.

Next, in step S51, the generation unit 43 generates an instruction sequence 89. The instruction “cmp x0, 0” in the generated instruction sequence 89 is an instruction that determines whether the value obtained by subtracting the number of elements of the array a for which the operation log(cos) has been executed, from NUM is greater than zero. Then, the instruction “b.gt Label_begin” is an example of a fourth instruction and is a jump instruction that jumps to the label “Label_begin” at the top of the instruction sequence 84 when it is determined to be greater than zero.

Next, in step S52, the generation unit 43 generates an instruction sequence 90 that returns the data saved beforehand in the memory 30b in step S43 to the SIMD registers 35.

For example, the instruction “Idr z26, [sp, −27, MUL_VL]” of the generated instruction sequence 90 is an instruction that stores the contents stored in the memory 30b by the instruction “str z26, [sp, −27, MUL_VL]” in step S43, in the SIMD register 35 of “z26”.

Similarly, the instruction “Idr z29, [sp, −30, MUL_VL]” is an instruction that stores the contents stored in the memory 30b by the instruction “str z29, [sp, −30, MUL_VL]” in step S43, in the SIMD register 35 of “z29”.

Thereafter, in step S53, the generation unit 43 generates a ret instruction 91. With the above, the basic process of the instruction sequence generation process is finished.

According to the present embodiment, the generation unit 43 does not generate the same instructions as each instruction contained in the instruction sequence 82 between the jump instruction “b.gt Label_begin” in the instruction sequence 90 and the instruction sequence 82. Therefore, the same instruction sequence as the instruction sequence 82 will not be executed every time a jump is made by the jump instruction “b.gt Label_begin”, and redundant instruction execution such as the difficulty 1 described with reference to FIG. 9 is restrained, which will make the execution speed of the program faster.

Furthermore, the generation unit 43 generates the instruction sequence 81 that saves the contents of the SIMD registers 35 of “z0” to “z31” to the memory 30b, only once at a position before the instruction sequence 85 and does not generate the instruction sequence 81 at a position between the instruction sequence 85 for cos and the instruction sequence 86 for log.

Therefore, the execution speed of the program may be made fast compared with the case where the redundant instruction sequences 11d and 12a are generated between separate cos and log as in the difficulty 3 in FIG. 9.

Moreover, the generation unit 43 generates the instruction sequence 81 that saves the contents of the SIMD registers 35 to the memory 30b, only once at a position before both of the instruction sequences 82 and 83 that store the coefficients in the SIMD registers 35.

Therefore, the execution speed of the program may be made faster without calling the redundant instruction sequences 11a and 12d a plurality of times as in the difficulty 4 in FIG. 9.

Next, a method for generating the instruction sequence 85 for cos in step S47 will be described.

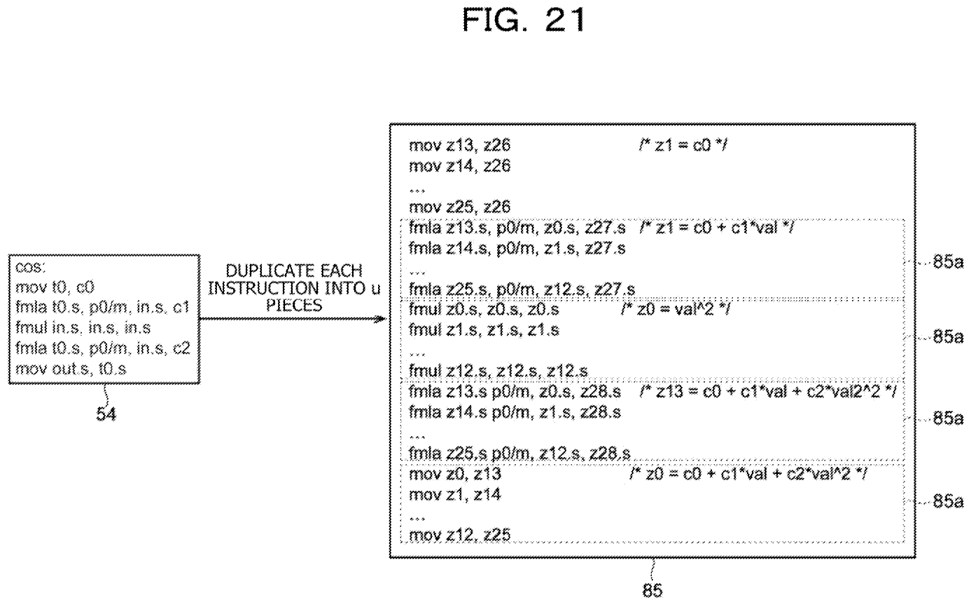

FIG. 21 is a schematic diagram illustrating a method for generating the instruction sequence 85 for cos. First, by referring to the template 54 for cos, the generation unit 43 specifies each of the instructions involved in the cos operation, namely, “mov t0, c0”, “fmla t0.s, p0/m, in.s, c1.s”, “fmul in.s, in.s, in.s”, “fmla t0.s, p0/m, in.s, c2.s”, and “mov out.s, t0.s”. Note that, among these instructions, “fmla t0.s, p0/m, in.s, c1.s” is an example of a first instruction, and “fmul in.s, in.s, in.s” is an example of a second instruction. In addition, “.s” in these instructions indicates that one SIMD register 35 is divided into storage areas having a capacity of 32 bits and is used as a plurality of 32-bit storage areas. Besides this, there are notations such as “.d” that treats the capacity of the storage area as 64 bits and “.h” that treats the capacity of the storage area as 16 bits.

Next, the generation unit 43 duplicates each instruction of the template 54 for cos into a plurality of pieces, by setting one of the plurality of SIMD registers 35 for each operand of the instructions included in the template 54. The instruction sequence 85 will be achieved by each instruction duplicated in this manner.

The SIMD registers 35 to be set for the operands of the instructions after duplication are resolved by the generation unit 43, based on the use purpose of each SIMD register 35 illustrated in FIG. 17.

For example, the instruction “mov t0, c0” at the top of the template 54 is an instruction that copies the coefficient c0 stored in the register for “c0” to the temporary register for “t0”. According to FIG. 17, the SIMD registers 35 of “z13” to “z25” are temporary registers. In addition, in the instruction sequence 82 in FIG. 18, the coefficient c0 is stored in the SIMD register 35 of “z26”.

Accordingly, the generation unit 43 sets each of the SIMD registers 35 of “z13” to “z25” for the first operand of the instruction “mov t0, c0” and sets the SIMD register 35 of “z26” for the second operand of the instruction “mov t0, c0”. This will produce 13 instructions “mov z13, z26”, “mov z14, z26”, . . . , and “mov z25, z26” duplicated from the top instruction “mov t0, c0” of the template 54.

Next, the second instruction “fmla t0.s, p0/m, in.s, c1.s” from the top in the template 54 for cos will be examined. This instruction is an instruction that adds c0 placed in the temporary register for “t0” to the product of the coefficient c1 placed in the register for “c1” and the input data val placed in the register for “in” and writes the result of the addition in the register for “t0”.

According to FIG. 17, the SIMD registers 35 of “z13” to “z25” are temporary registers. In addition, registers that store the input data placed in the memory 30b are u (=13) SIMD registers 35 from “z0” to “z12”. Furthermore, in the instruction sequence 82 in FIG. 18, the coefficient c1 is stored in the SIMD register 35 of “z27”.

Accordingly, the generation unit 43 sets each of the SIMD registers 35 of “z13” to “z25” for the first operand of the instruction “fmla t0.s, p0/m, in.s, c1.s”. Furthermore, the generation unit 43 sets the SIMD register 35 of “z27” for the fourth operand of the instruction “fmla t0.s, p0/m, in.s, c1.s”. In addition, the generation unit 43 sets any one of the SIMD registers 35 of “z0” to “z12” for the third operand of the instruction “fmla t0.s, p0/m, in.s, c1.s”.

This will produce u (=13) instructions “fmla z13.s, p0/m, z0.s, z27.s”, “fmla z14.s, p0/m, z1.s, z27.s”, . . . , and “fmla z25.s, p0/m, z12.s, z27.s” duplicated from the instruction “fmla t0.s, p0/m, in.s, c1.s”.

Next, the third instruction “fmul in.s, in.s, in.s.” from the top in the template 54 for cos will be examined. This instruction is an instruction that squares the input data val placed in the register for “in” and writes the result of the squaring to the register for “t0”.

As described above, registers that store the input data placed in the memory 30b are u (=13) SIMD registers 35 from “z0” to “z12”. Accordingly, the generation unit 43 sets each of the SIMD registers 35 of “z0” to “z12” for each operand of the instruction “fmul in.s, in.s, in.s”.

This will produce u (=13) instructions “fmul z0.s, z0.s, z0.s”, “fmul z1.s, z1.s, z1.s”, . . . , and “fmul z12.s, z12.s, z12.s” duplicated from the instruction “fmul in.s, in.s, in.s”.

Similarly to the above, the generation unit 43 also separately duplicates the remaining instructions “fmla t0.s, p0/m, in.s, c2.s” and “mov out.s, t0.s” of the template 54 for cos, to 13 instructions each.

In the present embodiment, u instructions duplicated from the same instruction of the template 54 will be called one instruction group 85a. Immediately after the instruction group 85a corresponding to a certain instruction of the template 54, the generation unit 43 generates the instruction group 85a corresponding to the instruction succeeding to the certain instruction. This allows to keep the instruction in which the SIMD registers 35 of “z0” to “z12” are set for the source operands away from being adjacent in the instruction group 85a immediately after the instruction in which the same SIMD registers 35 are set for the destination operands. Similarly, the instruction that uses “z13” to “z25” or “z0” to “z12” as source operands may be kept away from being adjacent immediately after the instruction that uses “z13” to “z25” or “z0” to “z12” as destination operands.

For example, the instruction group 85a corresponding to the instruction “fmla t0.s, p0/m, in.s, c1.s” will be examined. This instruction group 85a includes each of the instructions “fmla z13.s, p0/m, z0.s, z27.s”, “fmla z14.s, p0/m, z1.s, z27.s”, . . . , and “fmla z25.s, p0/m, z12.s, z27.s”. In these instructions, one of the SIMD registers 35 of “z0” to “z12” is set for an operand. However, this instruction group 85a does not have any instructions in which the same register among the SIMD registers 35 of “z0” to “z12” is set for an operand. This similarly applies also to the instruction group 85a corresponding to the instruction “fmul in.s, in.s, in.s”.

Furthermore, in the last instruction of the instruction group 85a corresponding to the instruction “fmla t0.s, p0/m, in.s, c1.s”, the SIMD register 35 of “z12” is set among the SIMD registers 35 of “z0” to “z12”. This SIMD register 35 is not the same as the SIMD register 35 of “z0” designated in the first instruction of the instruction group 85a of the instruction “fmul in.s, in.s, in.s”.

This allows to restrain the dependency relationship from arising between the respective instructions in the instruction sequence 85. Consequently, the occurrence of a stall may be suppressed in the pipeline process executed by the processor 30c, and the execution speed of the program may be enhanced.

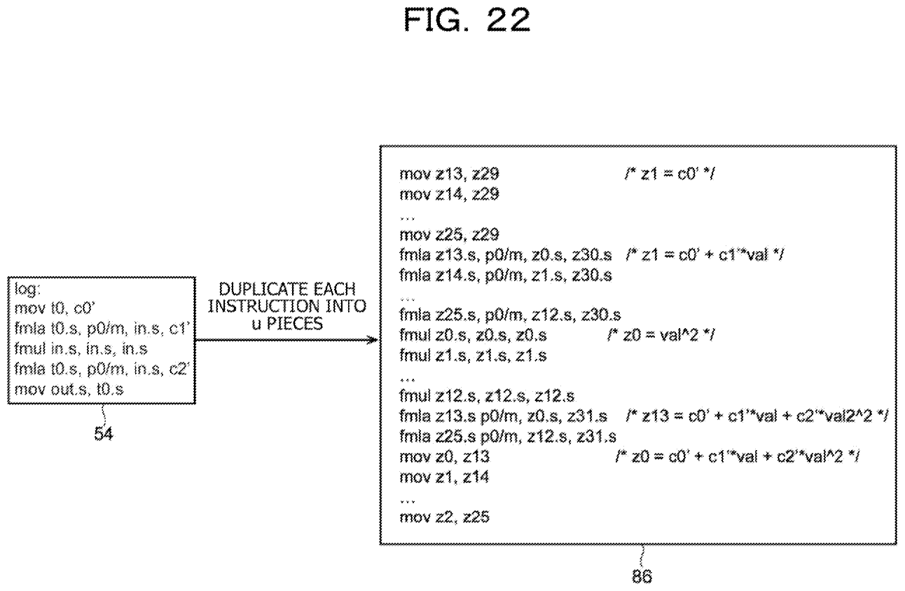

FIG. 22 explains a method for generating the instruction sequence 86 for log in step S48.

Since this method for generating the instruction sequence 86 is similar to the method for generating the instruction sequence 85 for cos (refer to FIG. 21), the description thereof will be omitted. Note that “fmla t0.s, p0/m, in.s, c1.s” included in the template 54 for log is an example of a fifth instruction, and “fmul in.s, in.s, in.s” is an example of a sixth instruction.

[Flow of Table Generation Process]

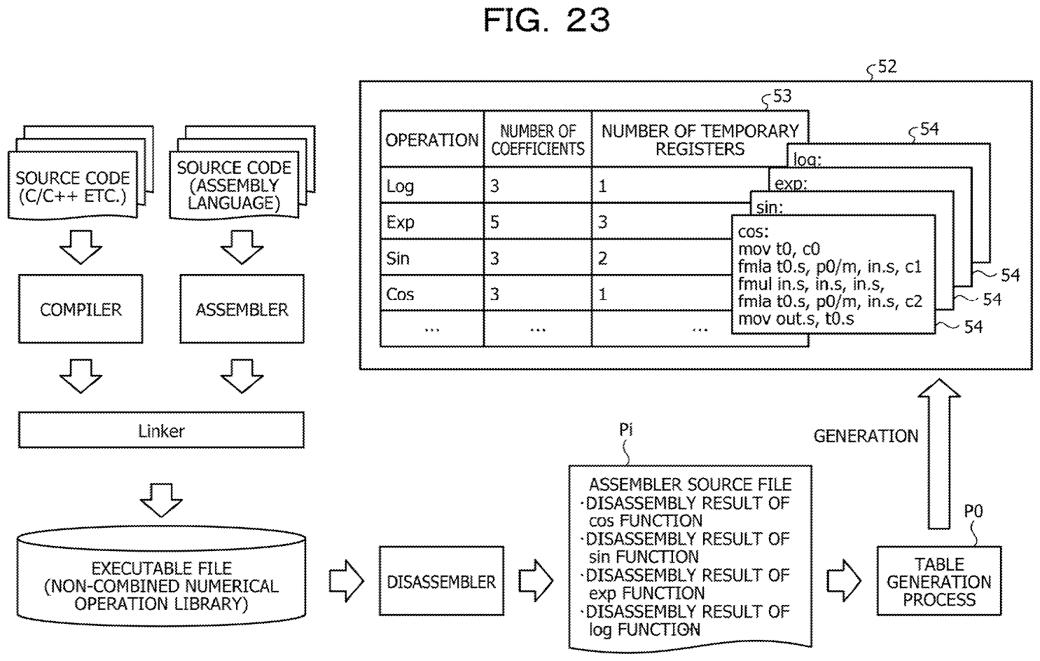

Next, a flow of a table generation process performed by the table generation unit 44 of the information processing device 30 according to the first embodiment will be described with reference to FIG. 23. FIG. 23 is a schematic diagram illustrating a flow of the table generation process performed by the information processing device according to the first embodiment. In a table generation process P0, an assembler source file Pi obtained by disassembling an executable file, which is a numerical operation library for numerical operations that have not been combined, is treated as input. The executable file is, for example, a file indicating the result of linking the result of compiling a source code written in the C or C++ language and the result of assembling a source code written in the assembly language, with a linker. The executable file contains the assembler result of the cos function, the sin function, the exp function, the log function, and the like, which are examples of non-combined numerical operations. The assembler source file Pi contains the disassembly result of the cos function, the disassembly result of the sin function, the disassembly result of the exp function, and the disassembly result of the log function. As an example, in the disassembly result of the cos function, the source code of the cos function written in the assembly language, which is the assembler instruction sequence, is described. Note that the source code only has to be existing open source software (OSS) or a product. In addition, the executable file may be existing open source software (OSS) or a product.

Then, the table generation process P0 generates a table 53 by inputting the disassembly results (assembler instruction sequence) of the target operation functions. The target operation functions mentioned here refer to the cos function, the sin function, the exp function, the log function, and the like. For example, the table generation process P0 inputs the assembler instruction sequence, which includes the disassembly results of the target operation functions contained in the assembler source file Pi, and works out the number of coefficients and the number of temporary registers for the target operations to add the worked-out number of coefficients and number of temporary registers to the table 53. The number of coefficients mentioned here refers to the number of registers used to hold constant coefficients. The number of temporary registers mentioned here refers to the number of registers to hold values during computation. For example, in the template 54 for the cos function, c0, c1, and c2 are the registers used to hold constant coefficients, and the number of coefficients is three. The register to hold values during computation is t0, and the number of temporary registers is one. Note that, in the template 54 for the cos function, in indicates a register containing an input value for which the cos function is to be computed. The register containing the computation result is indicated by out.

For example, the table generation process P0 specifies a register designated as a destination operand and a register designated as a source operand for each instruction of the input instruction sequence for the target operation. The table generation process P0 specifies a register designated as a destination operand in a certain instruction, as a register intended to hold the value from the immediately following instruction to the instruction in which the register is used as a source operand. Then, for each instruction, the table generation process P0 propagates distinction as to whether or not the register designated as a source operand and the register intended to hold the data is a register to store a value dependent on the input value, from the immediately preceding instruction. Then, for each instruction, the table generation process P0 distinguishes whether or not the register designated as a destination operand is a register to store a value dependent on the input value, according to whether or not the registers designated as source operands of the same instruction include the register to store a value dependent on the input value. Then, the table generation process P0 computes the number of registers involved (or required) to store values dependent on the input values, as the number of temporary registers, through the instruction sequence. In addition, the table generation process P0 computes the number of registers involved (or required) to store values independent of the input values, as the number of coefficients, through the instruction sequence. Then, the table generation process P0 adds the computed number of temporary registers and number of coefficients to the table 53. Then, the table generation process P0 replaces the operand of the instruction sequence for the target operation with a reallocated register to generate the template 54 for the target operation. Note that the register that stores the value dependent on the input value corresponds to t0 of the template 54 for the cos function, for example. The registers that store values independent of the input values correspond to c0, c1, and c2 of the template 54 for the cos function, for example.

[Flowchart of Table Generation Method]

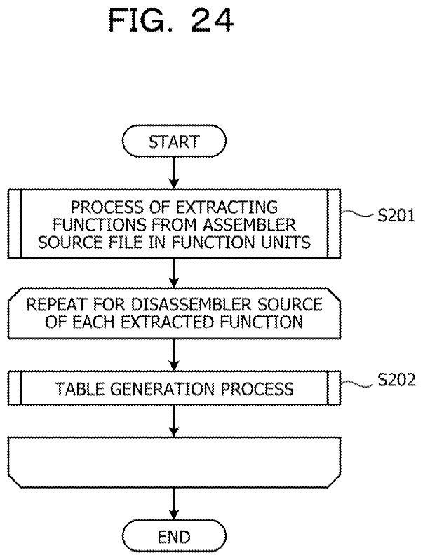

FIG. 24 is a diagram illustrating a flowchart of the table generation method according to the first embodiment. Note that the assembler source file Pi has been generated.

First, the table generation unit 44 extracts functions from the assembler source file Pi in function units (step S201). Note that a flowchart of the function extraction process will be described later.

Then, the table generation unit 44 repeats the following process by the number of extracted functions. The table generation unit 44 executes table generation process on the disassembler source of the extracted function (step S202). Note that a flowchart of the table generation process will be described later.

Then, the table generation unit 44 ends the process of the table generation method.

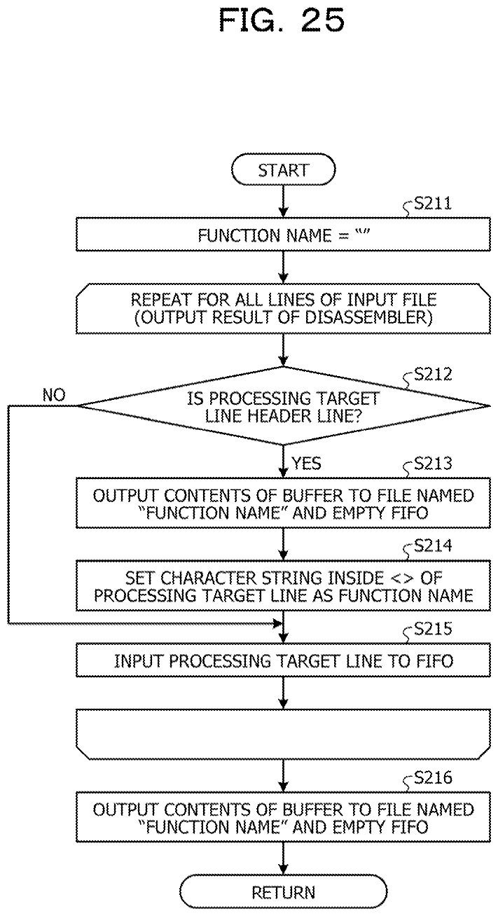

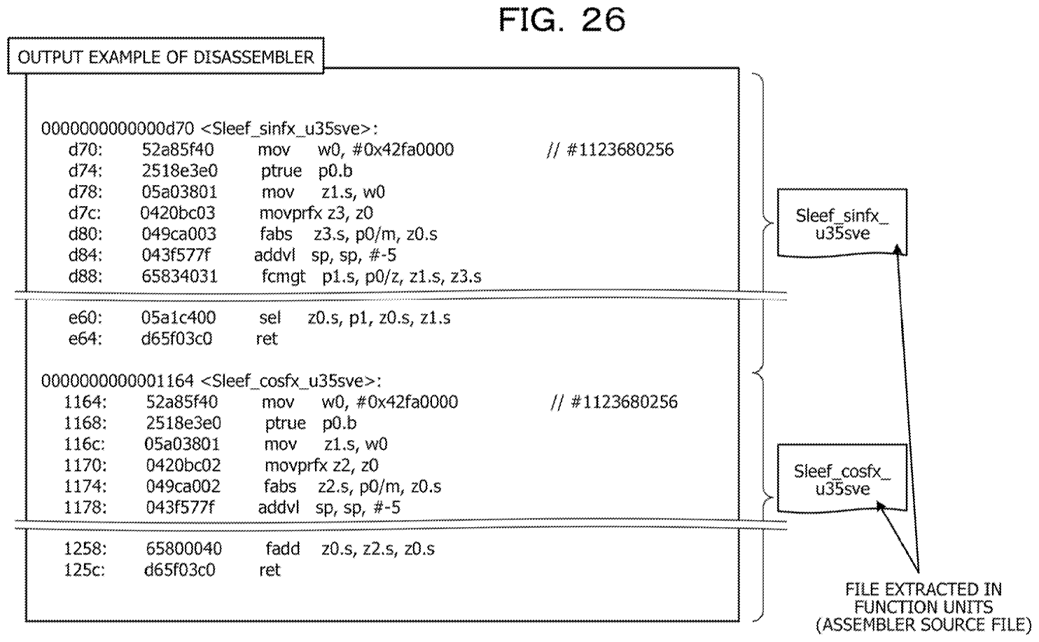

Next, a flowchart of the function extraction process according to the first embodiment illustrated in FIG. 25 will be described with reference to an example of the function extraction process in FIG. 26 as appropriate. FIG. 25 is a diagram illustrating a flowchart of the function extraction process according to the first embodiment. FIG. 26 is a diagram illustrating an example of the function extraction process according to the first embodiment.

As illustrated in FIG. 25, the table generation unit 44 clears the function name to ““ ”” (step S211).

The table generation unit 44 repeats the following processes (steps S212 to S215) for all lines of the input file (the output result of the disassembler). The table generation unit 44 determines whether or not the processing target line is a header line (step S212). For example, as illustrated in FIG. 26, the table generation unit 44 determines whether or not the processing target line is a header line, on the basis of whether or not there is a function name delimited by “< >”. Here, <Sleef_sinfx_u35sve> is described in the 0000 . . . d70 line. Since this line has the function name “Sleef_sinfx_u35sve” delimited by “< >”, this line is determined to be the header line.

Returning to FIG. 25, when it is determined that the processing target line is not the header line (step S212; No), the table generation unit 44 proceeds to step S215.

On the other hand, when it is determined that the processing target line is the header line (step S212; Yes), the table generation unit 44 outputs the contents of the buffer in the processing target line to a file named “function name” and empties a first in first out (FIFO) (step S213). Then, the table generation unit 44 sets the character string inside the “< >” of the processing target line, as the function name (step S214). For example, as illustrated in FIG. 26, for the 0000 . . . d70 line, the table generation unit 44 outputs “<Sleef_sinfx_u35sve>:” to a file named “function name” and sets the character string “Sleef_sinfx_u35sve” as the function name.

Returning to FIG. 25, the table generation unit 44 proceeds to step S215. In step S215, the table generation unit 44 inputs the processing target line to the FIFO (step S215).

Then, after repeating the processes for all lines of the assembler source file Pi, the table generation unit 44 outputs the contents of the buffer to a file named “function name” and empties the FIFO (step S216). For example, the table generation unit 44 extracts processes in function units. For example, as illustrated in FIG. 26, the table generation unit 44 extracts a process for the sin operation to a file whose function name is “Sleef_sinfx_u35sve”. In addition, the table generation unit 44 extracts a process for the cos operation to a file whose function name is “Sleef_cosfx_u35sve”.

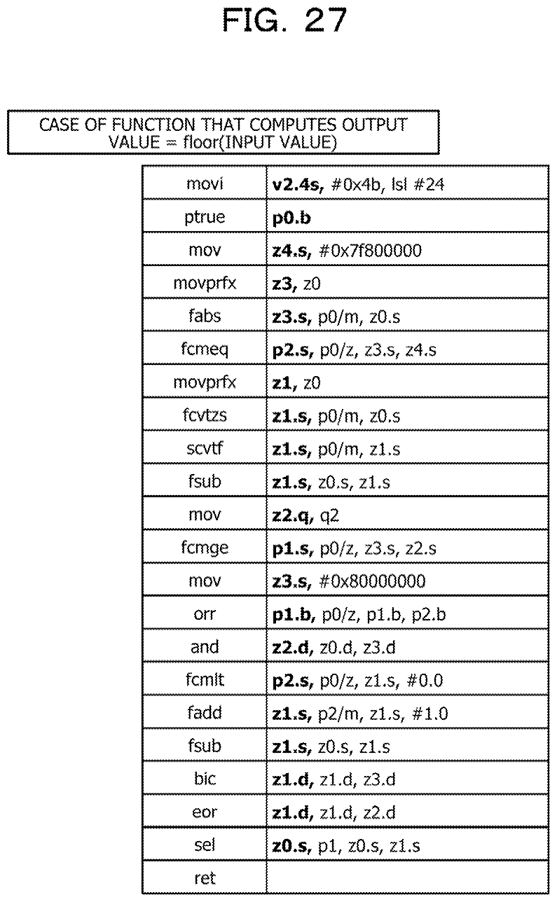

FIG. 27 is a diagram illustrating an example of a file extracted in function units. FIG. 27 represents the contents of the file obtained by the table generation unit 44 extracting a process for a floor operation. For example, an assembler for a function that computes the floor(input value) operation that inputs the input value as a parameter is represented. All the functions for operations including the floor operation are called in a state with the input value stored in the “z0” register (not illustrated) and return to the caller of the functions by finally executing the ret instruction in a state with the computation result stored in the “z0” register.

The bold characters indicate destination operands, and the non-bold characters indicate source operands. The constant coefficients are indicated by “#0x4b”, “Ist #24”, “#0x7f8000000”, and the like. In addition, the CPU registers are indicated by “v2”, “p0”, “z4”, and the like. The SIMD registers are indicated by “v” and “z”, and the predicate registers are indicated by “p”. For example, the first “movi v2.4s, #0x4b, Isl #24” is an instruction that regularly sets “#0x4b000000” that is not related to the input value, in the “v2” register. Meanwhile, in the “fabs z3.s, p0/m, z0.s” instruction, since the “z0” register that stores the input value is designated as a source operand, a value dependent on the input value will be set as the value of the “z3” register.

Taking such a floor operation as an example, the table generation process for adding the number of registers to the table 53 will be described below.

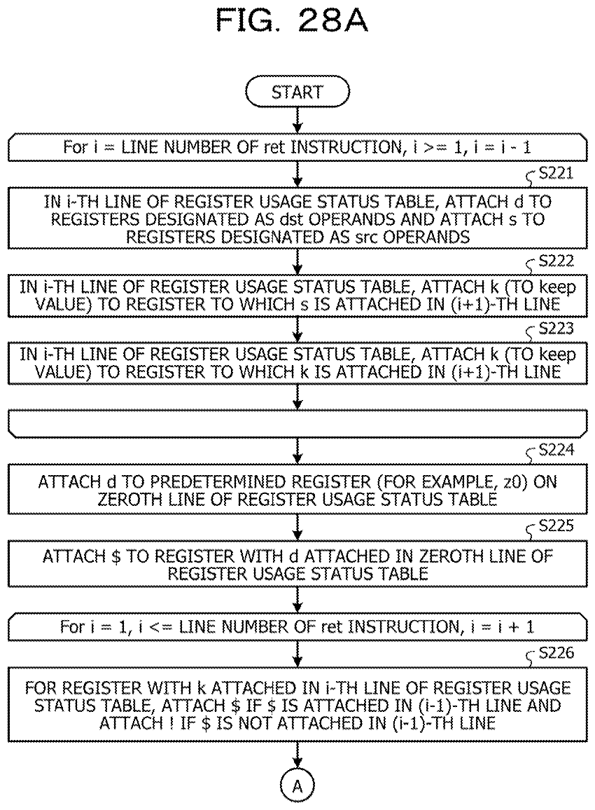

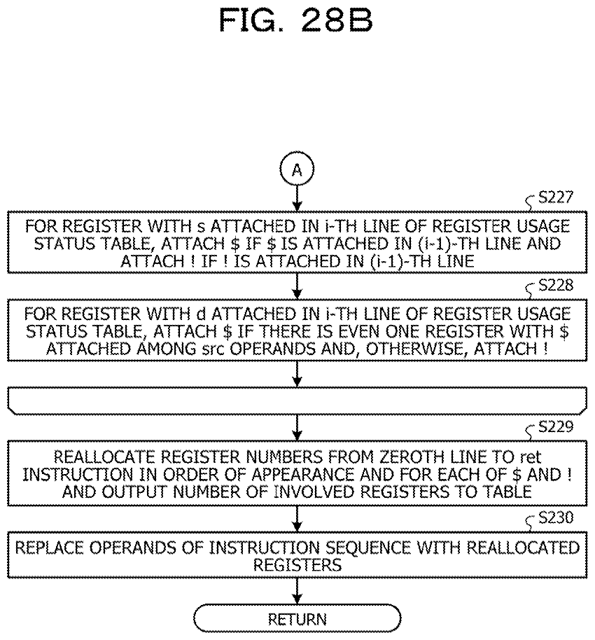

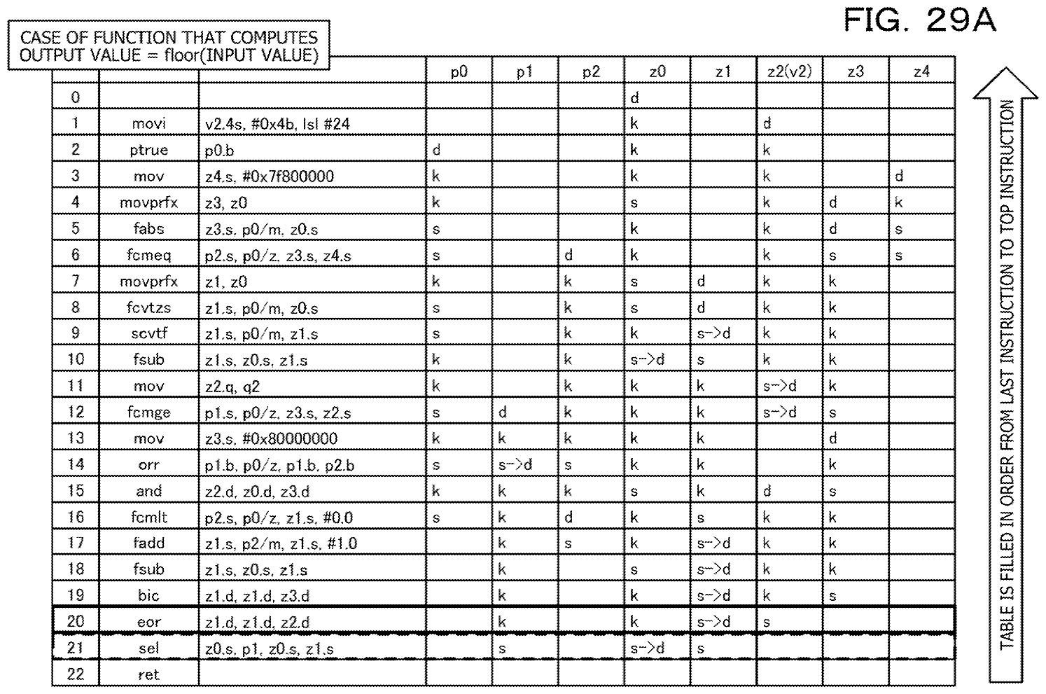

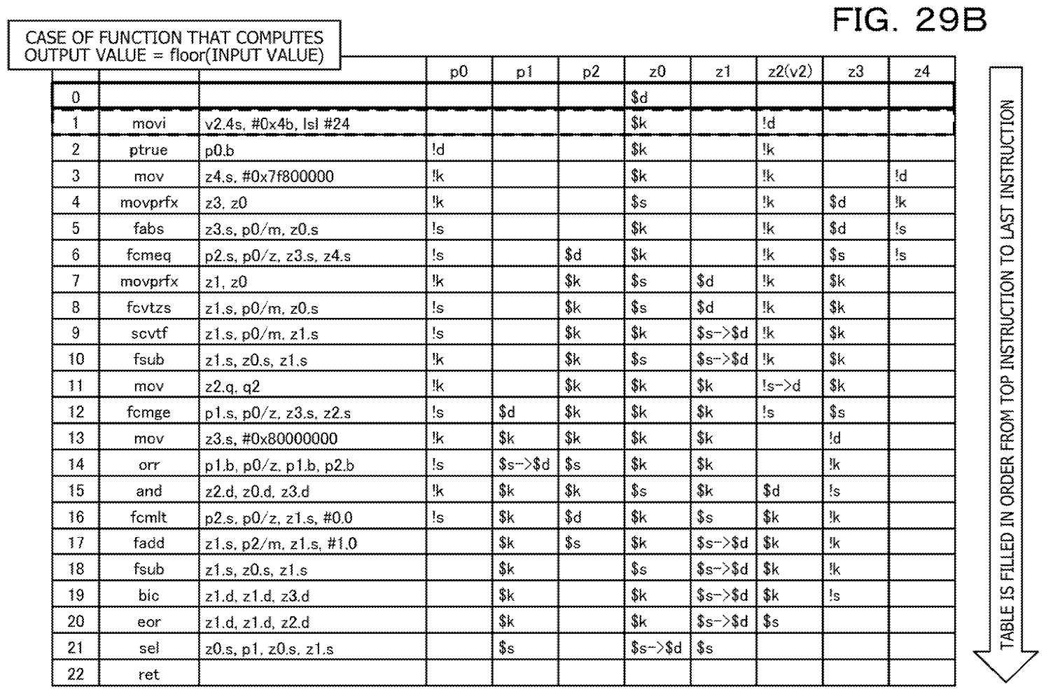

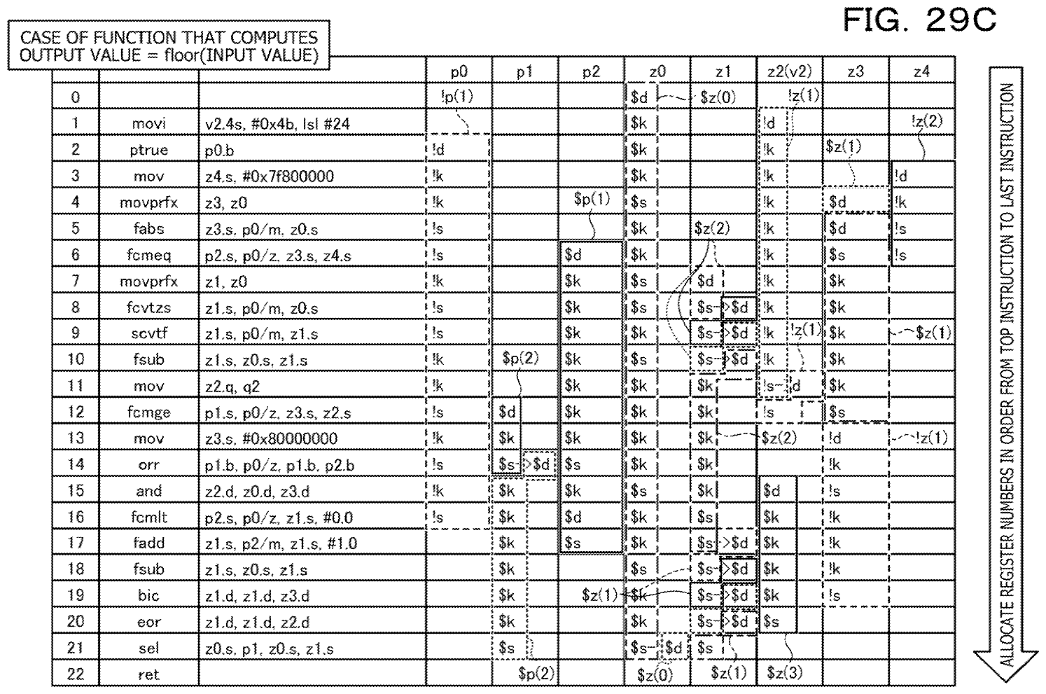

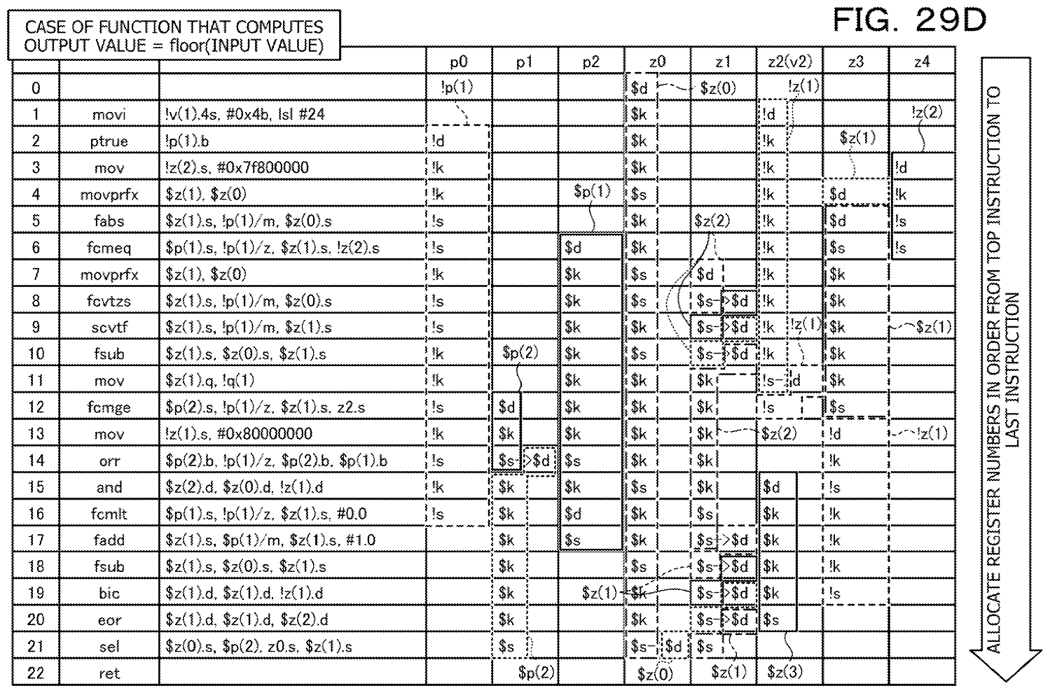

FIGS. 28A and 2B are a diagram illustrating a flowchart of the table generation process according to the first embodiment. FIGS. 29A to 29D are diagrams illustrating an example of the table generation process according to the first embodiment. Note that, here, the flowchart of the table generation process illustrated in FIGS. 28A and 2B will be described with reference to an example of the table generation process illustrated in FIGS. 29A to 29D as appropriate.

First, the table generation unit 44 acquires a source code that is the disassembly result of the floor function in the assembler source file Pi. Then, the table generation unit 44 associates each instruction of the instruction sequence that constitutes the source code with the line numbers and generates a register usage status table that associates the usage status of each register with each instruction. Note that, at the time point when the source code is acquired, nothing is set in the usage status of the registers for each instruction in the register usage status table.

Under such circumstances, for a line number i of the source code, the table generation unit 44 repeats the following processes (steps S221 to S223) from the line of the last instruction (ret instruction) to the first line of the top instruction. In the i-th line of the register usage status table, the table generation unit 44 attaches “d” to the registers designated as destination (dst) operands and attaches “s” to the registers designated as source (src) operands (step S221). For example, the table generation unit 44 specifies a register designated as a destination operand and a register designated as a source operand for each instruction of the input instruction sequence for the target operation.

Then, in the i-th line of the register usage status table, the table generation unit 44 attaches “k” (to keep the value) to a register to which “s” is attached in the (i+1)-th line (step S222). The register with “k” attached represents that the register is used as a source register in the (i+1)-th instruction and accordingly, has to hold the value. Furthermore, in the i-th line of the register usage status table, the table generation unit 44 attaches “k” (to keep the value) to a register to which “k” is attached in the (i+1)-th line (step S223). For example, the table generation unit 44 treats a register designated as a destination operand in a certain instruction, as a register intended to hold the value from the immediately following instruction to the instruction in which the register is used as a source operand.

For example, as illustrate in FIG. 29A, for the instruction “sel z0.s, p1, z0.s, z1.s” on the 21st line of the register usage status table, the “z0” register is a destination operand, and “p1”, “z0”, and “z1” are source operands. Thus, the table generation unit 44 attaches “d” to the “z0” register, which is the destination register, and attaches “s” to the “p1”, “z0”, and “z1”, which are the source registers.

In addition, for the instruction “eor z1.d, z1.d, z2.d” on the 20th line of the register usage status table, the “z1” register is a destination operand, and “z1” and “z2” are source operands. Thus, the table generation unit 44 attaches “d” to the “z1” register, which is the destination register, and attaches “s” to “z1” and “z2”, which are the source registers. In the instruction on the 21st line, “s” is attached to the “p1” and “z0” registers. Thus, the table generation unit 44 attaches “k” to the “p1” and “z0” registers. This is because the “p1” and “z0” registers are used as source registers in the succeeding instruction.

Returning to FIG. 28, subsequently, the table generation unit 44 attaches “d” to a predetermined register on the zeroth line of the register usage status table (step S224). Here, it is assumed that the predetermined register is the “z0” register. For example, as illustrated in FIG. 29A, the table generation unit 44 attaches “d” to the “z0” register in the zeroth line of the register usage status table. For example, this reflects that the instruction sequence in FIG. 27 is on the supposition of a state in which the input value is stored in the “z0” register.

Subsequently, the table generation unit 44 attaches “$” to the register with “d” attached in the zeroth line of the register usage status table (step S225). The sign “$” mentioned here indicates that the register with “$” attached is a register to store a value dependent on the input value. For example, as illustrated in FIG. 29B, since the register “z0” with “d” attached in the zeroth line is a register to store the input value, “$” is attached. For example, the input value is stored in the “z0” register, and the operation function is called.

Returning to FIG. 28, for the line number i of the source code, the table generation unit 44 repeats the following processes (steps S226 to S228) from the first line of the top instruction to the line of the last instruction (ret instruction). For the register with “k” attached in the i-th line of the register usage status table, the table generation unit 44 attaches “$” if “$” is attached in the (i−1)-th line and attaches “!” if “$” is not attached in the (i−1)-th line (step S226). The sign “$” mentioned here indicates that the register with “$” attached is a register to store a value dependent on the input value. The sign “!” mentioned here indicates that the register with “!” attached is a register to store a value independent of the input value. For example, for each instruction, the table generation unit 44 propagates distinction as to whether or not the register with “k” attached that is intended to hold the data is a register to store a value dependent on the input value, from the immediately preceding instruction.

Then, for the register with “s” attached in the i-th line of the register usage status table, the table generation unit 44 attaches “$” if “$” is attached in the (i−1)-th line and attaches “!” if “$” is not attached in the (i−1)-th line (step S227). For example, for each instruction, the table generation unit 44 propagates distinction as to whether or not the register with “s” attached that is designated as a source operand is a register to store a value dependent on the input value, from the immediately preceding instruction.

Then, for the register with “d” attached in the i-th line of the register usage status table, the table generation unit 44 attaches “$” when there is even one register with “$” attached among the source operand registers and, otherwise, attaches “!” (step S228). For example, for each instruction, the table generation unit 44 distinguishes whether or not the register with “d” attached that is designated as a destination operand is a register to store a value dependent on the input value, according to whether or not the registers designated as source operands of the same instruction include the register to store a value dependent on the input value.

For example, as illustrated in FIG. 29B, regarding the instruction “movi v2.4s, #0x4b, Is! #24” on the first line of the register usage status table, the table generation unit 44 attaches “$” to “k” for the register “z0” with “k” attached because “$” is attached in the zeroth line. For example, this is because the “z0” register is a register to store a value dependent on the input value in the instruction on the first line. In addition, for the “z2(v2)” register with “d” attached, the table generation unit 44 attaches “!” to “d” because “$” is not attached to even one source operand register in the instruction on the first line. For example, since the “z2(v2)” register with “d” attached is to store the value “#0x4b, Is! #24”, which is attained regardless of the input value, “!” indicating that the register is to store a value independent of the input value is attached to “d”.

In addition, regarding the instruction “mov z4.s, #0x7f800000” on the third line of the register usage status table, the table generation unit 44 attaches “!” to “k” for the “p0” and “z2(v2)” registers with “k” attached because “!” is attached on the second line. For example, this is because the “p0” and “z2(v2)” registers are still registers to store values independent of the input values in the instruction on the third line. For the “z0” register with “k” attached, the table generation unit 44 attaches “$” to “k” because “$” is attached in the second line. For example, this is because the “z0” register is a register to store a value dependent on the input value in the instruction on the third line. In addition, for the “z4” register with “d” attached, the table generation unit 44 attaches “!” to “d” because “$” is not attached to even one source operand register in the instruction on the third line. For example, the “z4” register with “d” attached is to store the value “#0x7f800000”, which is attained regardless of the input value, “!” indicating that the register is to store a value independent of the input value is attached to “d”.

In addition, regarding the instruction “movprfx z3, z0” on the fourth line of the register usage status table, the table generation unit 44 attaches “!” to “k” for the “p0”, “z2(v2)”, and “z4” registers with “k” attached because “!” is attached on the third line. For example, this is because the “p0”, “z2(v2)”, and “z4” registers are registers to store values independent of the input values in the instruction on the fourth line. For the “z0” register with “s” attached, the table generation unit 44 attaches “$” to “s” because “$” is attached in the third line. For example, this is because the “z0” register is a register to store a value dependent on the input value in the instruction on the fourth line. In addition, for the “z3” register with “d” attached, the table generation unit 44 attaches “$” to “d” because “$” is attached to the source operand “z0” register in the instruction on the fourth line. For example, in the instruction on the fourth line, since the value is transferred to the “z3” register from the “z0” register that is to store a value dependent on the input value, “$” indicating that the register is to store a value dependent on the input value is attached to the “z3” register.

Returning to FIG. 28, subsequently, the table generation unit 44 reallocates the register numbers from the zeroth line to the ret instruction of the register usage status table in the order of appearance and for each of “$” and “!” and outputs the number of involved registers to the table 53 (step S229). For example, the table generation unit 44 computes the number of registers (registers with “$” attached) involved to store values dependent on the input values as the number of temporary registers, through the instruction sequence. In addition, the table generation unit 44 computes the number of registers (registers with “!” attached) involved to store values independent of the input values, as the number of coefficients, through the instruction sequence. Then, the table generation unit 44 adds the computed number of temporary registers and number of coefficients to the table 53.

For example, as illustrated in FIG. 29C, the table generation unit 44 allocates “$z(0)” to “$d” on the zeroth line and to “$d” of the instruction immediately preceding the ret instruction. This is because the function for the operation is called in a state with the input value stored in the “z0” register and return to the caller of the functions by finally executing the ret instruction in a state with the computation result stored in the “z0” register.

The table generation unit 44 performs the following processes in order from the top instruction to the last instruction. The table generation unit 44 allocates “!p” to “!d” and allocates “$p” to “$d” for the column of p registers (mask registers). In addition, the table generation unit 44 allocates “!z” to “!d” and allocates “$z” to “$d” for the column of z registers (SIMD registers). Then, for “!k”, “$k”, “!s”, and “$s”, the table generation unit 44 allocates the same registers as the registers allocated in the directly previous line.

Then, for the p registers, the table generation unit 44 refers to the register usage status table and computes one, namely, “!p(1)” as the register (!) involved to store a value independent of the input value and two, namely, “$p(1)” and “$p(2)” as the registers ($) involved to store values dependent on the input values. For example, the table generation unit 44 computes one p register for the use purpose of storing coefficients and two p registers for the use purpose of holding values during computation. In addition, for the z registers, the table generation unit 44 refers to the register usage status table and computes two, namely, “!z(1)” and “!z(2)” as the registers (!) involved to store values independent of the input values and three, namely, “$z(1)”, “$z(2)”, and “$z(3)” as the registers ($) involved to store values dependent on the input values. For example, the table generation unit 44 computes two z registers for the use purpose of storing coefficients and three z registers for the use purpose of holding values during computation. Then, the table generation unit 44 adds the number of registers for the use purpose of storing coefficients and the number of registers for the use purpose of holding values during computation to the table 53 for each of p register and z register.

Returning to FIG. 28, subsequently, the table generation unit 44 replaces the operands of the instruction sequence with the reallocated registers (step S230).

For example, as illustrated in FIG. 29D, the table generation unit 44 rewrites the operands based on the reallocated register numbers, in order from the top instruction to the last instruction. As an example, for the instruction on the fourth line, “movprfx z3, z0” is rewritten to “movprfx $z(1), $z(0)”. For the instruction on the fifth line, “fabs z3.s, p0/m, z0.s” is rewritten to “fabs $z(1).s, !p(1)/m, $z(0).s”.

Returning to FIG. 28, the table generation unit 44 ends the table generation process.

[Example of Definition of Table]

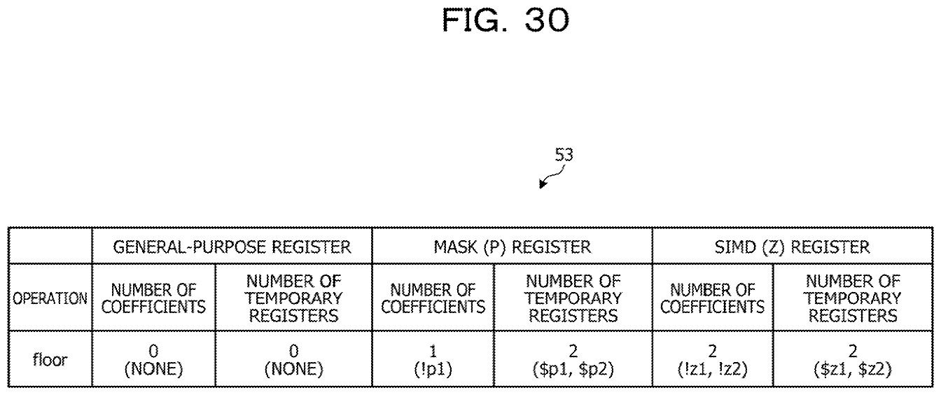

Here, an example of the table 53 generated by the table generation unit 44 will be described with reference to FIG. 30. FIG. 30 is a diagram illustrating an example of the definition of the table. FIG. 30 represents the table 53 that stores the number of coefficients and the number of temporary registers of each register in the floor operation. The information on the floor operation in the table 53 is the result of processing in S229 in FIG. 28. Here, when the operation is floor, for the mask (P) registers, the number of coefficients used in the operation is one indicating “!p(1)”, and the number of temporary registers is two indicating “$p(1)” and “$p(2)”. For the SIMD (Z) registers, the number of coefficients used in the operation is two indicating “!z(1)” and “!z(2)”, and the number of temporary registers is three indicating “$z(1)”, “$z(2)”, and “$z(3)”. For general-purpose registers, the number of coefficients and the number of temporary registers used in the operation are both zero. The number of coefficients refers to the number of registers for the use purpose of storing coefficients, which are the registers involved to store values independent of the input values. The number of temporary registers refers to the number of registers for the use purpose of holding values during computation, which are the registers involved to store values dependent on the input values.

Note that, when the operation is floor, the number of coefficients and the number of temporary registers for each of the mask (P) registers and the SIMD (z) registers are computed and added to the table 53. However, in the cases of other operations, information only on the SIMD (z) registers may be concerned. For example, when the SIMD (z) register and the mask (P) register are used in the disassembly result of the operation, the information on the mask (P) register and the SIMD (z) register are stored. In addition, when only the SIMD (z) register is used in the disassembly result of the operation, only the information on the SIMD (z) register is stored. In addition, when the general-purpose register is used for the disassembly result of the operation, the information on the general-purpose register is also stored.

[Example of Definition of Template]

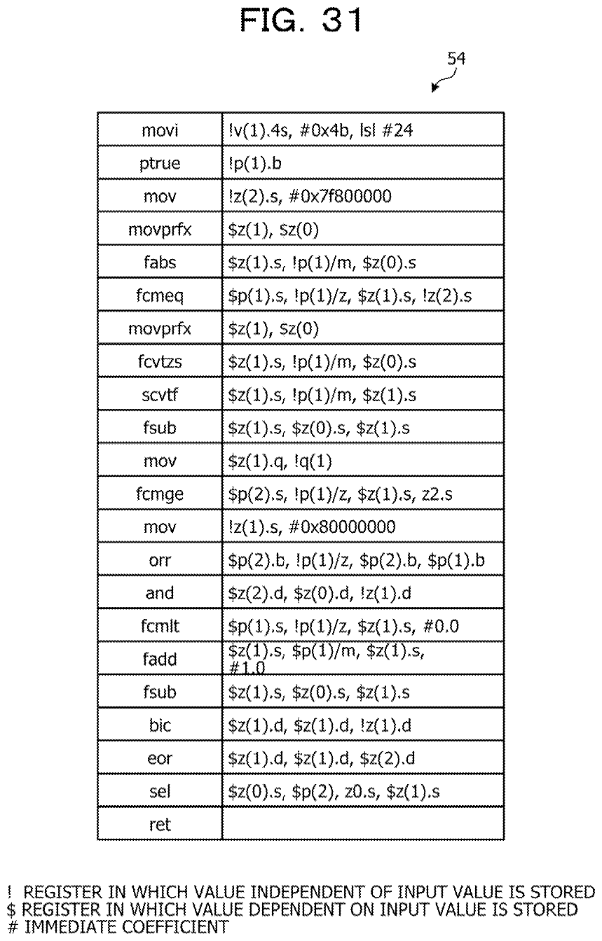

In addition, an example of the template 54 generated by the table generation unit 44 will be described with reference to FIG. 31. FIG. 31 is a diagram illustrating an example of the definition of the template. FIG. 31 represents the template 54 for the floor operation. This template 54 is the result of processing in S230 in FIG. 28. Here, the registers with “!” attached are registers to store values independent of the input values and correspond to registers with names beginning with “c” in the template 54 illustrated in FIG. 23. In addition, the registers with “$” attached are registers to store values dependent on the input values and correspond to registers with names beginning with “t” in the template 54 illustrated in FIG. 23. Note that, although the table generation unit 44 expresses the registers in the template 54 using “!” and “$”, the table generation unit 44 is not limited to this and may express the registers using “c” and “t” or may express the registers using other characters or the like.

Then, the table 53 indicating the number of coefficients and the number of temporary registers for each operation and the templates 54 for each operation are stored in the library 52. Then, the generation unit 43 performs the instruction sequence generation process that generates the instruction sequence 60, by executing the instruction sequence generation program 31 linked with the library 52 (refer to FIG. 13).

This allows the table generation unit 44 to efficiently and automatically generate the table 53 in the library 52 for numerical operations. As a result, by generating the instruction sequence 60 that performs predetermined operations on a plurality of input values, using the automatically generated table 53, the generation unit 43 may enhance the execution speed of the application program 50.

In addition, the table generation unit 44 reallocates the register numbers distinguishing between the registers to hold values dependent on the input values and the registers to hold values independent of the input values, from the top instruction to the last instruction of the instruction sequence for the operation, and generates the table 53 based on the reallocated register numbers. This allows the table generation unit 44 to optimize the registers to be used, by distinguishing beforehand between the registers to hold values dependent on the input values and the registers to hold values independent of the input values, and to automatically generate the table 53.

In addition, the table generation unit 44 replaces the operands of the instruction sequence for the operation with the registers indicated by the reallocated register numbers. This allows the table generation unit 44 to efficiently generate the instruction sequence (template 54) according to the table 53.

Although the present embodiment has been described in detail above, the present embodiment is not limited to the above. For example, although the instruction sequences 85 and 86 that execute cos and log in succession have been described above, the generation unit 43 may generate an instruction sequence that executes only one of the cos and log operations.

Furthermore, the types of operations are not limited to cos and log, and the generation unit 43 may generate an instruction sequence that executes any of exp, log 2, log 3, log 10, sin, tan, sinh, cosh, tanh, asin, acos, atan, sqrt, abs, round, ceil, floor, and pow operations. Note that log 2, log 3, and log 10 are logarithms with bases 2, 3, and 10, respectively. In addition, asin, acos, and atan are the inverse functions of sin, cos, and tan, respectively. The operation sqrt is for calculating a square root, and the operation abs is for calculating an absolute value. The operation round is for rounding off, and the operation ceil is for rounding up decimal places. The operation floor is for rounding down decimal places, and pow is an exponentiation.

In addition, the generation unit 43 may generate an instruction sequence that executes logical operations such as not, and, or, and xor. Furthermore, the generation unit 43 may generate an instruction sequence that executes bit operations such as left shift and right shift or the four arithmetic operations such as add, sub, mul, and div.

### Second Embodiment

In the present embodiment, each operation of sum (sum) and mean (mean) enabled to raise the execution speed of the program will be described.

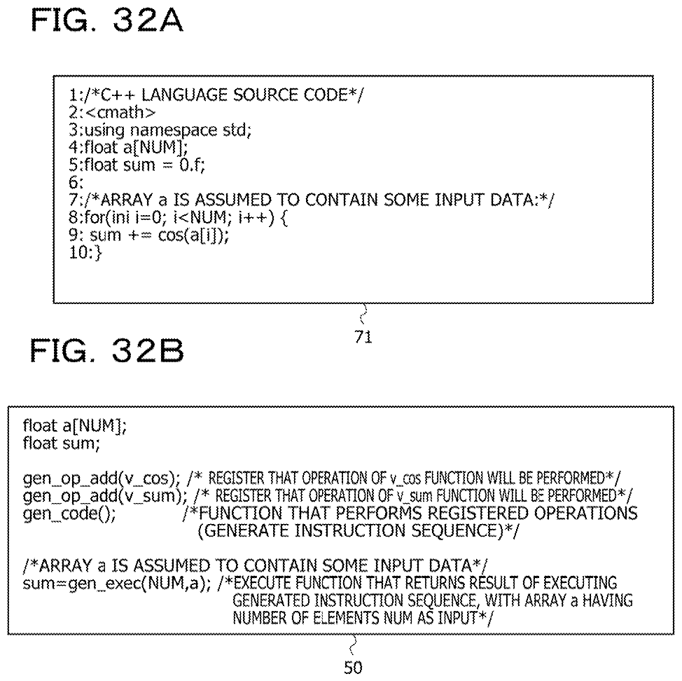

FIG. 32A is a C++ pseudo-source program in which a sum operation (sum) is used.

This source program 71 is a program that works out the sum (sum) of the cos operation results for array elements a[i] within a loop process by the for statement on the eighth to tenth lines.

FIG. 32B is a schematic diagram of an application program 50 that performs processing equivalent to the processing of the source program 71.

A program developer describes each of functions gen_op_add(v_cos), gen_op_add(v_sum), gen_code( ), and gen_exec(NUM, a) in this application program 50.

Among these, the gen_op_add(v_cos) function is the same function as described with reference to FIG. 13. In addition, the gen_op_add(v_sum) function is a function that stores the character string “OPi” indicating that the type of operation is sum, in a memory 30b.

The gen_code( ) function is a function that generates an instruction sequence, using operations represented by a character string such as “OPi” stored in the memory 30b. In this example, it is assumed that the gen_code( ) function generates an instruction sequence for executing an operation that calculates the sum of cos operation results.

The gen_exec(NUM, a) function is a function that executes a function that outputs the execution result of the instruction sequence generated by the gen_code( ) function, as a return value. Note that the input data for the operation executed by the instruction sequence is stored in each element of an array a. In addition, NUM denotes the number of elements in the array a.

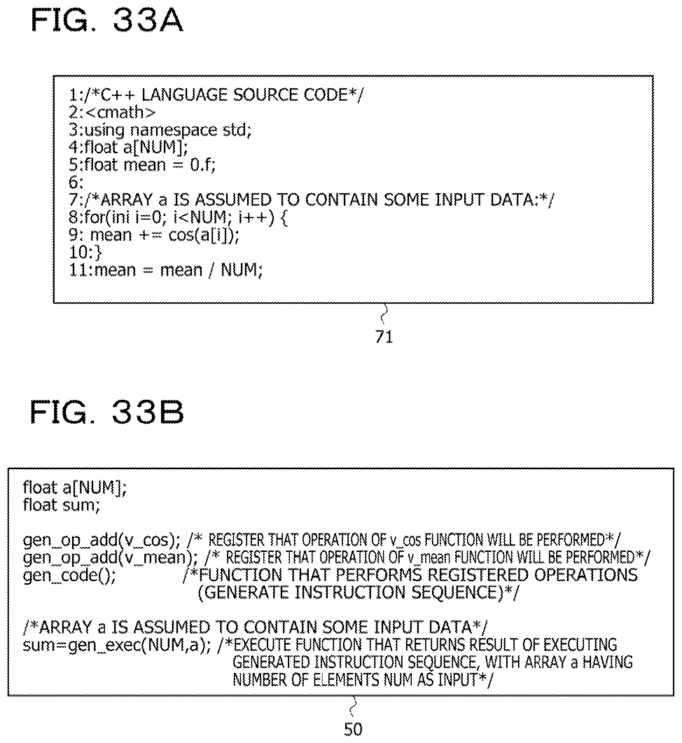

FIG. 33A is a C++ pseudo-source program in which a mean operation (mean) is used.

This source program 72 is a program that stores the mean value of cos(a[i]) calculated in the immediately preceding loop process, in a variable mean, on the last eleventh line.

FIG. 33B is a schematic diagram of the application program 50 that performs processing equivalent to the processing of the source program 72.

The program developer describes each of functions gen_op_add(v_cos), gen_op_add(v_mean), gen_code( ), and gen_exec(NUM, a) in this application program 50.

Among these, the gen_op_add(v_cos) function is the same function as described with reference to FIG. 13. In addition, the gen_op_add(v_mean) function is a function that stores the character string “OPi” indicating that the type of operation is mean, in the memory 30b.

The gen_code( ) function is a function that generates an instruction sequence, using operations represented by a character string such as “OPi” stored in the memory 30b. In this example, it is assumed that the gen_code( ) function generates an instruction sequence for executing an operation that calculates a mean value of cos operation results.

The gen_exec(NUM, a) function is a function that executes a function that outputs the execution result of the instruction sequence generated by the gen_code( ) function, as a return value. Note that it is assumed that the input data for the operation executed by the instruction sequence is stored in each element of the array a. In addition, NUM denotes the number of elements in the array a.

As in the first embodiment, a generation unit 43 of an information processing device 30 performs an instruction sequence generation process that generates an instruction sequence by executing the gen_code( ) function described in the application program 50 in FIGS. 32B and 33B.

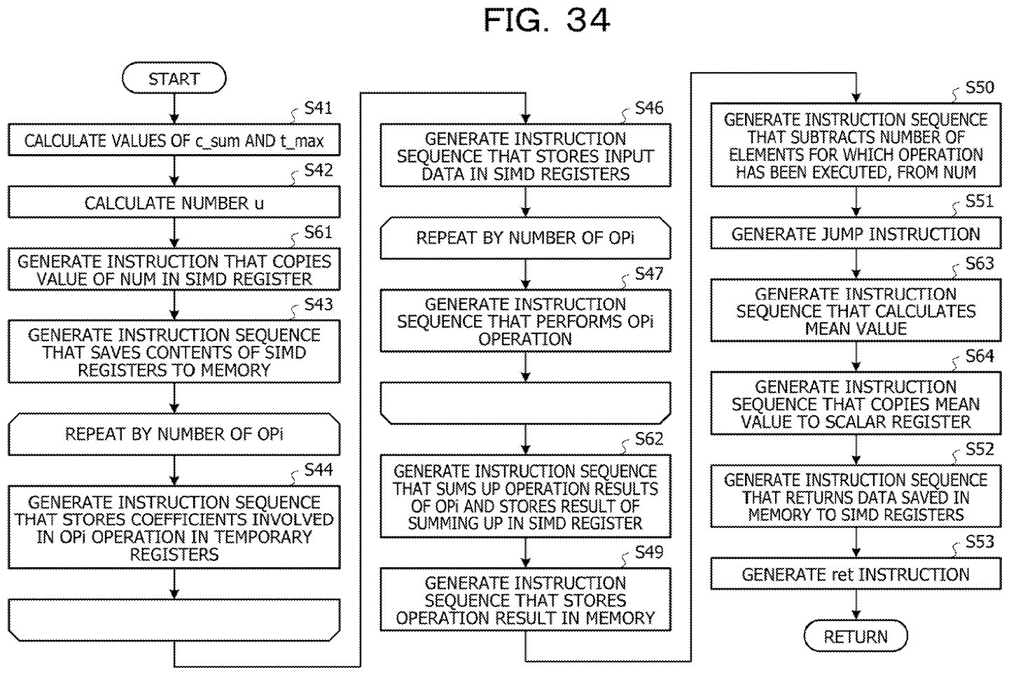

FIG. 34 is a flowchart of the above-mentioned instruction sequence generation process. Note that, in FIG. 34, the same steps as the steps described with reference to FIG. 16 will be given the same reference signs as in FIG. 16, and the description thereof will be omitted below.

As illustrated in FIG. 34, in the present embodiment, the generation unit 43 executes the respective steps in FIG. 16 as well as steps S61, S62, S63, and S64.

In step S61, the generation unit 43 generates an instruction that copies the value of NUM stored in a certain scalar register 37 to a different scalar register 37.

In addition, in step S62, the generation unit 43 generates an instruction sequence that sums up the operation results of “OPi” stored in each SIMD register 35 and stores the result of summing up in another SIMD register 35.

In step S63, the generation unit 43 generates an instruction sequence that calculates a mean value by dividing the result of the operation in step S62 by NUM when the operation intended to be executed last, among the operations indicated by each of a plurality of character strings “OPi”, is “mean”.

Then, in step S64, the generation unit 43 generates an instruction that copies the calculated mean value to the scalar register 37.

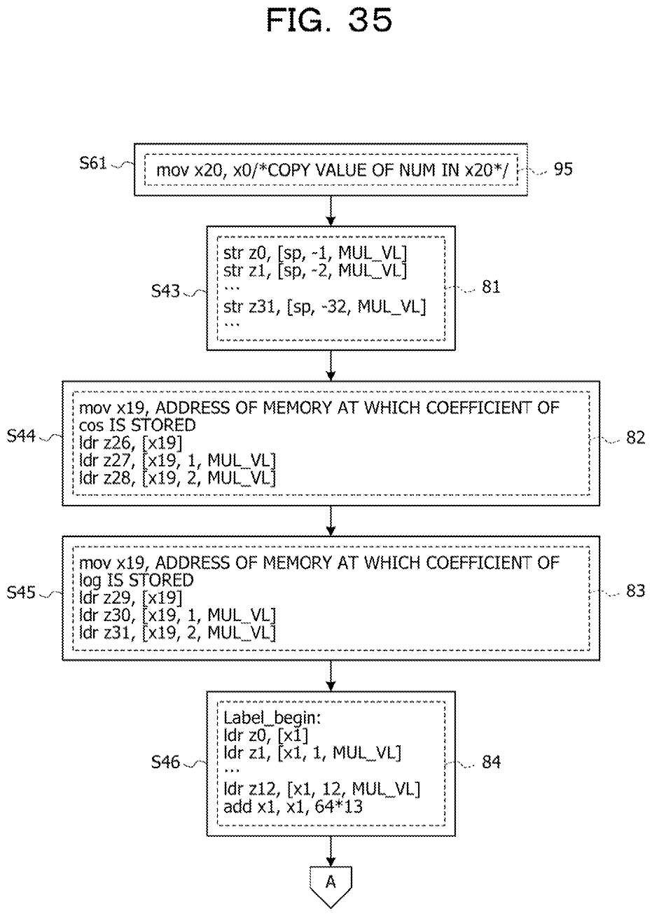

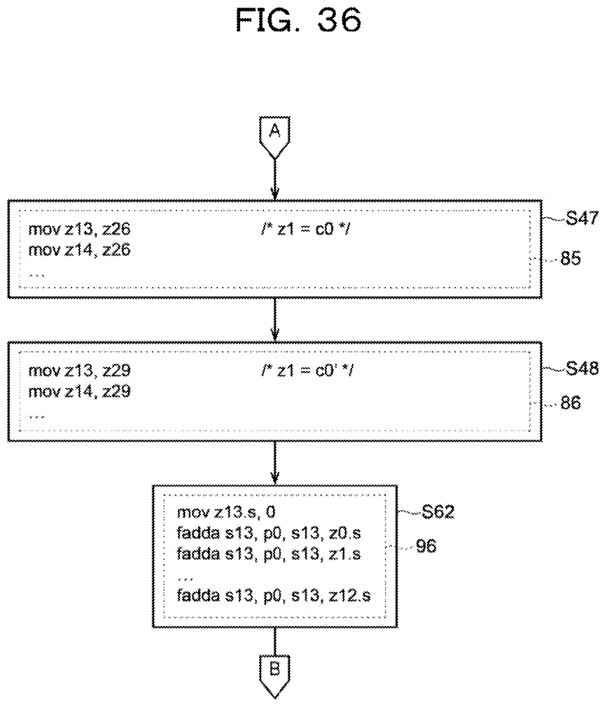

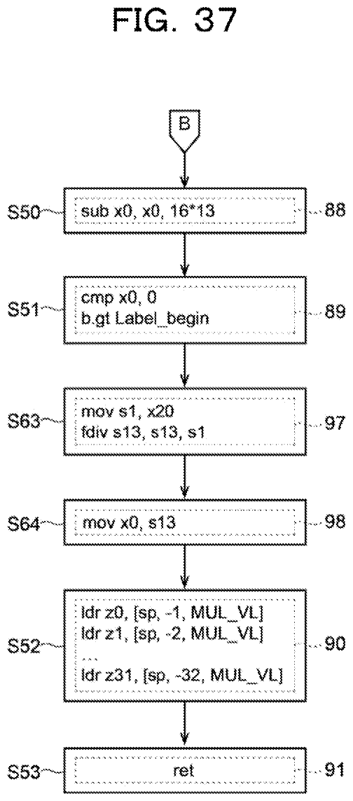

Next, the instruction sequences obtained by the instruction sequence generation process in FIG. 34 will be described. FIGS. 35 to 37 are schematic diagrams illustrating instruction sequences obtained by the instruction sequence generation process. Note that, in FIGS. 35 to 37, the same steps and instruction sequences as those described with reference to FIGS. 18 to 20 will be given the same reference signs as those in these figures, and the description thereof will be omitted below. In addition, in the following, it is supposed that the cos and log operations are performed in this order, as in FIGS. 18 to 20.

First, in step S61, the generation unit 43 generates an instruction 95 that copies the value of NUM stored in the scalar register 37 of “x0” to the scalar register 37 of “x20”.

Thereafter, the generation unit 43 generates respective instruction sequences 82 to 86 by performing steps S44 to S48 similarly to the first embodiment.

Next, in step S62, the generation unit 43 generates an instruction sequence 96 that sums up a plurality of values stored in each of u SIMD registers 35 from “z0” to “z12” and stores the result of summing up in the SIMD register 35 indicated by “s13”. Note that “s13” is an operand that means that the 32 bits on the least significant bit (LSB) side of the SIMD register 35 of “z13” are used as a scalar register.

In addition, the first instruction “mov z13.s, 0” of this instruction sequence 96 is an instruction that copies zero to each 32-bit storage area of the SIMD register 35 of “z13”.

Furthermore, the next instruction “fadda s13, p0, s13, z0.s” in the instruction sequence 96 is an instruction that adds the values stored in all the storage areas of the SIMD register 35 of “z0” and stores the result of the addition in the lower 32 bits of the SIMD register 35 of “z13”. This similarly applies also to the instructions after this in the instruction sequence 96.

This will store the result of adding a plurality of values stored in each of the SIMD registers 35 of “z0” to “z12” in the lower 32 bits of the SIMD register 35 of “z13”, when the execution of the instruction sequence 96 is finished.

Thereafter, the generation unit 43 generates an instruction 88 and an instruction sequence 89 by performing steps S50 and S51 similarly to the first embodiment.

Next, in step S63, the generation unit 43 generates an instruction sequence 97 that works out a mean value by dividing the result of the operation in step S62 by NUM.

The first instruction “mov s1, x20” of this instruction sequence 97 is an instruction that stores the value of NUM copied to the scalar register 37 of “x20” in step S61, in the lower 32 bits of the SIMD register 35 of “z1”.

In addition, the next instruction “fdiv s13, s13, s1” is an instruction that divides the addition result stored in the SIMD register 35 of “z13” by the value of NUM stored in the SIMD register 35 of “z1” and stores the result of the division in the SIMD register 35 of “z13”. This will store the mean value in the SIMD register 35 of “z13”.

Subsequently, in step S64, the generation unit 43 generates the instruction “mov x0, s13” as an instruction 98 that copies the mean value stored in the SIMD register 35 of “z13” to the scalar register 37 of “x0”. Note that the reason why the scalar register 37 of “x0” is adopted as the copy destination is that the Armv8-A architecture specifications stipulate that the return value of the function be stored in the scalar register 37 of “x0”.

With the above, the basic process of the instruction sequence generation process according to the present embodiment is finished. According to the present embodiment described above, in addition to the log and cos operations described in the first embodiment, operations such as sum and mean can be performed.

Incidentally, in the information processing device 30 described above, by referring to a table 53, the generation unit 43 calculates the value of each of c_sum indicating the sum of the number of coefficients involved in each operation and t_max indicating the maximum value of the number of temporary registers involved in each operation, for each of operations to be combined, as illustrated in FIGS. 15 and 16. Combining each of operations mentioned here means, for example, the operation log(cos( ) obtained by combining the cos function and the log function when each of operations refers to the cos function and the log function. Then, the generation unit 43 uses c_sum and t_max to calculate the number u of SIMD registers 35 that can store the input data in one loop process, and executes the instruction sequence generation process using at least the u SIMD registers 35, which is the case that has been described. Note that it is assumed that the instruction sequence generation process mentioned here will be hereinafter referred to as a “first generation process” by a “first generation method”.

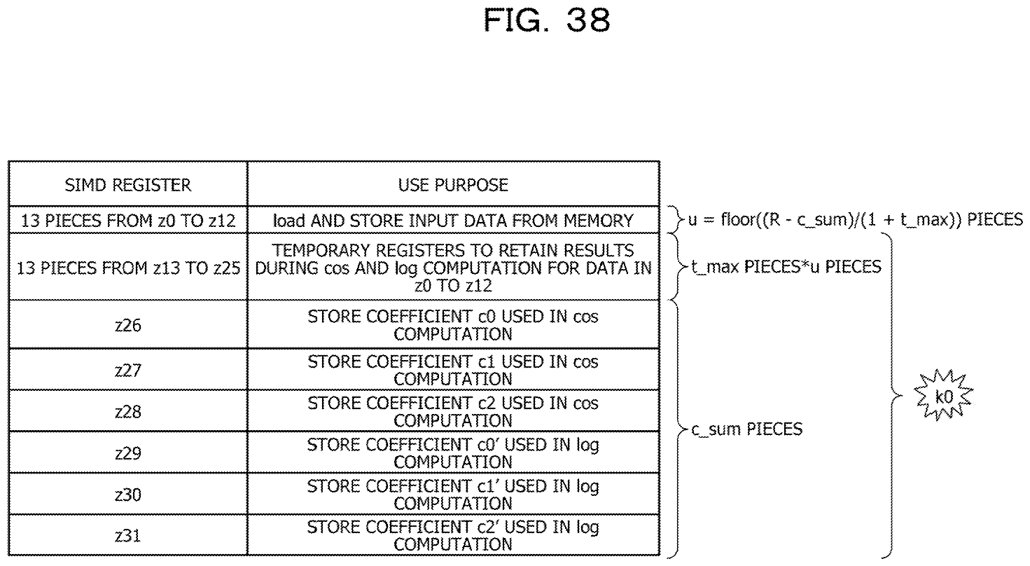

However, when the number of arithmetic functions to be combined increases, the generation unit 43 is sometimes not allowed to apply the first generation process. FIG. 38 is a diagram illustrating a difficulty caused when there are many arithmetic functions. FIG. 38 represents a schematic diagram illustrating the use purposes of the SIMD registers 35 illustrated in FIG. 17. In this example, 13 (=u) SIMD registers 35 from “z0” to “z12” are used as registers for storing the input data placed in the memory 30b. In addition, 13 (=t_max×u) SIMD registers 35 from “z13” to “z25” are used as temporary registers for retaining the results during the cos and log operations. Then, six (=c_sum) SIMD registers 35 from “z26” to “z31” are used as registers for storing coefficients involved in each of the cos and log operations.

This example is a case where there are two arithmetic functions, namely, cos and log, to be combined. However, when the number of arithmetic functions to be combined increases, c_sum indicating the sum of the number of coefficients involved in each operation and t_max indicating the maximum value of the number of temporary registers involved in each operation increase, and the SIMD registers 35 involved to store the input data placed in the memory 30b may no longer be secured. For example, when c_sum and t_max increase (reference sign k0) and u becomes zero or less, the SIMD registers 35 involved to store the input data may no longer be secured. As a result, the generation unit 43 will not be allowed to generate instruction sequences for each of operations to be combined.

Thus, a third embodiment capable of solving such a difficulty will be described below.

### Third Embodiment

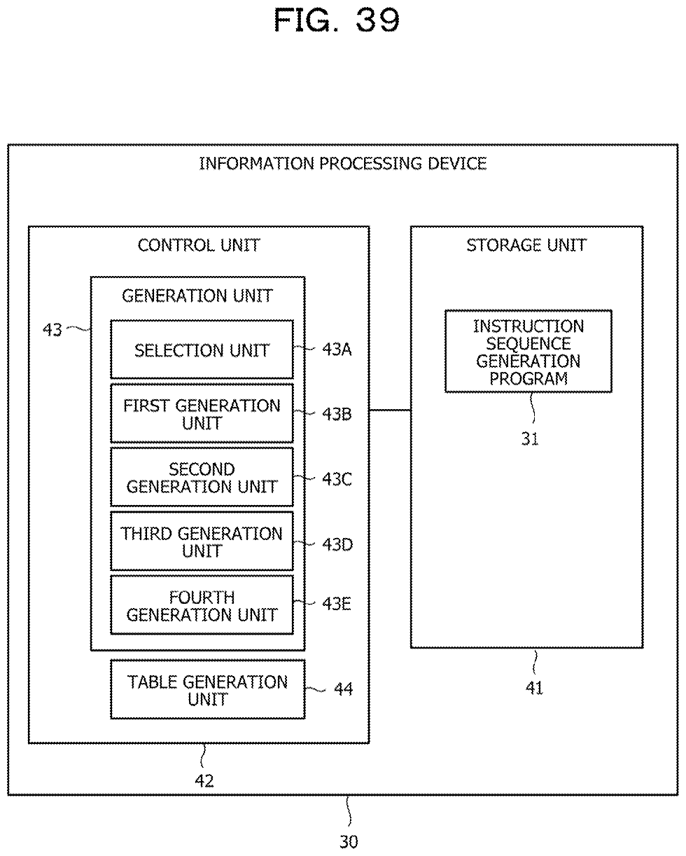

First, a configuration of an information processing device 30 will be described with reference to FIG. 39. FIG. 39 is a functional configuration diagram of the information processing device 30 according to the third embodiment. Note that components same as the components of the information processing device 30 according to the first embodiment illustrated in FIG. 12 will be indicated with the same reference signs, and the description of overlapped configuration and action of the components will be omitted. The difference between the first embodiment and the third embodiment is that a generation unit 43 includes a selection unit 43A, a first generation unit 43B, a second generation unit 43C, a third generation unit 43D, and a fourth generation unit 43E. Note that the first generation unit 43B corresponds to the generation unit 43 of the first embodiment. For example, the first generation unit 43B is a processing unit that generates an instruction sequence when an instruction sequence generation program 31 is executed by a first generation method (hereinafter referred to as a first generation process).

The selection unit 43A selects a generation method that executes the instruction sequence generation process.

For example, the selection unit 43A calculates an index value D1 indicating whether or not the SIMD registers 35 are sufficient when the instruction sequence generation process is executed by the first generation method. For example, in the present embodiment, the selection unit 43A calculates the index value D1 in accordance with the following formula. D1=R−(c_sum+t_max)

In the above, R denotes the number of SIMD registers 35. The sum of the number of coefficients involved in each operation is denoted by c_sum. The maximum value of the number of temporary registers involved in each operation is denoted by t_max. For example, the formula for calculating the index value D1 is a formula that computes the total number of SIMD registers available for use purposes other than the use purpose of storing coefficients because c_sum of SIMD registers 35, of which the number is R in total, are used to store coefficients, and t_max of SIMD registers 35 are used for operations.

Then, when the index value D1 is greater than zero, the selection unit 43A selects the first generation method. In addition, when the index value D1 is equal to or less than zero, the selection unit 43A calculates an index value D2 indicating whether or not the SIMD registers 35 are sufficient when the instruction sequence generation process is executed by a second generation method. The “second generation method” mentioned here is a method that executes a process of compressing coefficients involved in each operation to store the compressed coefficients in the SIMD registers 35 and generating an instruction sequence by decompressing the coefficients compressed at the time of the operation when the instruction sequence generation program 31 is executed (hereinafter referred to as a second generation process). For example, in the present embodiment, the selection unit 43A calculates the index value D2 in accordance with the following formula. D2=R−(c_max+t_max+c_R)

In the above, the maximum value of the number of coefficients involved in each operation is denoted by c_max. The maximum value of the number of temporary registers involved in each operation is denoted by t_max. In addition, the number of SIMD registers 35 involved when coefficient data is compressed and stored is denoted by c_R. The number c_R is simply calculated in accordance with the following formula. c_R=ceiling (Bit Width of SIMD Register/(c_sum×16)) For example, the formula for calculating the index value D2 is a formula that computes the total number of SIMD registers available for use purposes other than the use purpose of storing coefficients because “c_max+c_R” of SIMD registers 35, of which the number is R in total, are used to store the compressed coefficients and to store the decompressed coefficients and t_max of SIMD registers 35 are used for operations.

Then, when the index value D2 is greater than zero, the selection unit 43A selects the second generation method. In addition, when the index value D2 is equal to or less than zero, the selection unit 43A calculates an index value D3 indicating whether or not the SIMD registers 35 are sufficient when the instruction sequence generation process is executed by a third generation method. The “third generation method” mentioned here is a method that executes a process of generating an instruction sequence by using a general-purpose register and a plurality of SIMD registers 35 when the instruction sequence generation program 31 is executed (hereinafter referred to as a third generation process). For example, in the present embodiment, the selection unit 43A calculates the index value D3 in accordance with the following formula. D3=gR−c_sum

In the above, the number of general-purpose registers is denoted by gR. The sum of the number of coefficients involved in each operation is denoted by c_sum. For example, the formula for calculating the index value D3 is a formula that computes the total number of general-purpose registers available for use purposes other than the use purpose of storing coefficients because c_sum of general-purpose registers, of which the number is gR in total, are used to store coefficients.

Then, when the index value D3 is equal to or greater than zero, the selection unit 43A selects the third generation method. In addition, when the index value D3 is smaller than zero, the selection unit 43A executes the instruction sequence generation process by a fourth generation method. The “fourth generation method” mentioned here is a method that executes a process of dividing successive operations into a plurality of groups under predetermined conditions and repeating the operations by the number of groups, using one of the first generation method, the second generation method, and the third generation method, to generate an instruction sequence (hereinafter referred to as a fourth generation process).

When the selection unit 43A selects the first generation method, the first generation unit 43B generates an instruction sequence based on the first generation process when the instruction sequence generation program 31 is executed.

When the selection unit 43A selects the second generation method, the second generation unit 43C generates an instruction sequence based on the second generation process when the instruction sequence generation program 31 is executed.

When the selection unit 43A selects the third generation method, the third generation unit 43D generates an instruction sequence based on the third generation process when the instruction sequence generation program 31 is executed.

When the selection unit 43A selects the fourth generation method, the fourth generation unit 43E generates an instruction sequence based on the fourth generation process when the instruction sequence generation program 31 is executed.

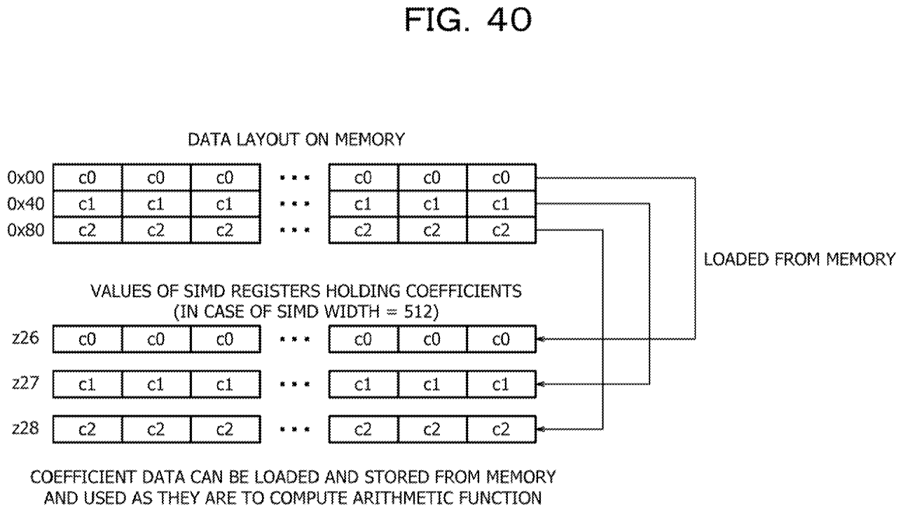

FIG. 40 is a diagram explaining the storage of coefficients carried out in the first generation method. As illustrated in FIG. 40, the diagram explains loading of coefficients when the first generation unit 43B generates an instruction sequence 82 that stores, for example, the coefficients c0, c1, and c2 involved in the cos operation in the SIMD registers 35 of “z26” to “z28” for temporary registers from a memory 30b (refer to step S44 in FIG. 18).

The coefficient c0 is stored at an address 0x00 of the memory 30b. The coefficient c1 is stored at an address 0x40 of the memory 30b. The coefficient c2 is stored at an address 0x80 of the memory 30b. The first generation unit 43B stores the coefficient c0 in the SIMD register 35 of “z26” for a temporary register from the address 0x00 of the memory 30b. The first generation unit 43B stores the coefficient c1 in the SIMD register 35 of “z27” for a temporary register from the address 0x40 of the memory 30b. The first generation unit 43B stores the coefficient c2 in the SIMD register 35 of “z28” for a temporary register from the address 0x80 of the memory 30b.

Thereafter, the first generation unit 43B is allowed to use the coefficients c0, c1, and c2 stored in the SIMD registers 35 of “z26” to “z28” for temporary registers as they are to compute the arithmetic function.

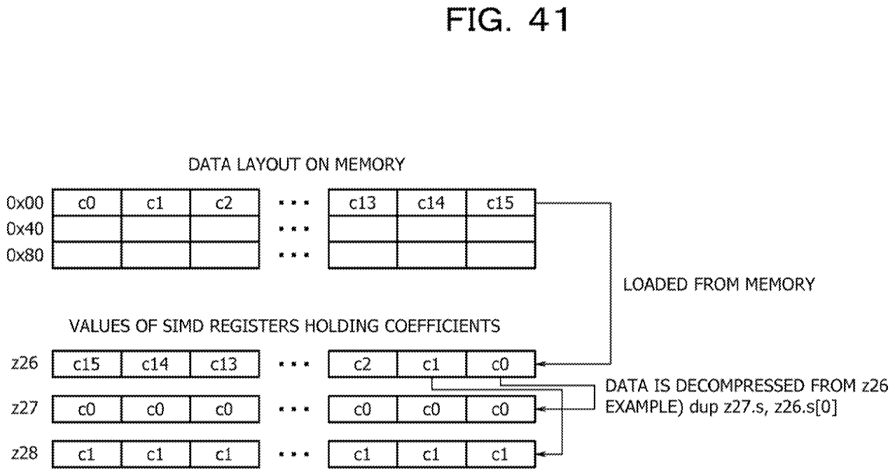

FIG. 41 is a diagram explaining the storage of coefficients carried out in the second generation method. As illustrated in FIG. 41, for example, the coefficients c0, c1, and c2 involved in the cos operation are compressed in advance and held in the memory 30b. The second generation unit 43C stores the compressed coefficients c0, c1, and c2 in the SIMD register 35 of “z26” for a temporary register from the memory 30b.

Thereafter, the second generation unit 43C decompresses the coefficient c0 into the SIMD register 35 of “z27” from the SIMD register 35 of “z26” if applicable. Here, the “dup z27.s, z26.s[0]” instruction is simply used for the decompression of the coefficient c0. In addition, the second generation unit 43C decompresses the coefficient c1 into the SIMD register 35 of “z28” from the SIMD register 35 of “z26” if applicable. Here, the “dup z28.s, z26.s[1]” instruction is simply used for the decompression of the coefficient c1.

This allows the second generation unit 43C to suppress the number of c_sum indicating the sum of the number of coefficients involved in each operation even if the number of arithmetic functions to be combined increases, by decompressing the compressed and held coefficients into the SIMD registers 35 for storing the coefficients involved in operations if applicable. As a result, the second generation unit 43C may secure the SIMD registers 35 involved to store the input data placed in the memory 30b. Then, even if the number of arithmetic functions to be combined increases, the second generation unit 43C may generate an instruction sequence for each of operations to be combined.

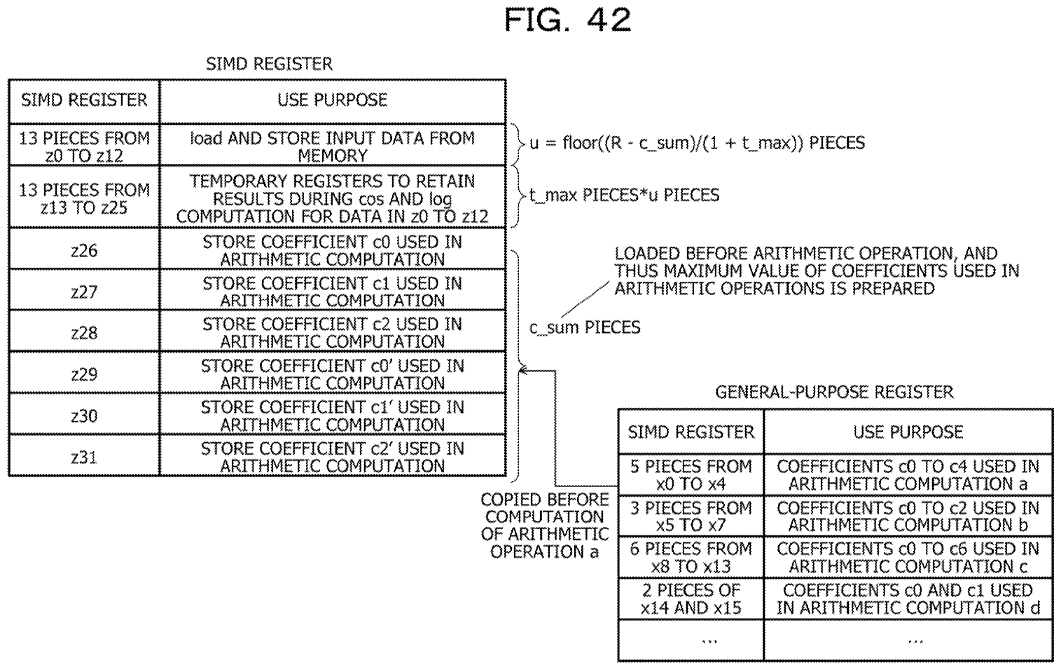

FIG. 42 is a diagram explaining the storage of coefficients carried out in the third generation method. As illustrated in FIG. 42, the third generation unit 43D stores the coefficients involved in operations in the general-purpose registers beforehand from the memory 30b and stores the coefficients involved in operations in the SIMD registers 35 for temporary registers from the general-purpose registers immediately before operations.

Since the third generation unit 43D stores the coefficients involved in operations in the SIMD registers 35 for temporary registers from the general-purpose registers immediately before operations, the maximum value (c_max) of the coefficients used in the arithmetic operations only has to be prepared for the number of SIMD registers 35 to store the coefficients.

This allows the third generation unit 43D to suppress the number of SIMD registers 35 for temporary registers to store coefficients, by using the general-purpose registers. As a result, even if the number of arithmetic functions to be combined increases, the third generation unit 43D may secure the SIMD registers 35 involved to store the input data placed in the memory 30b. Then, even if the number of arithmetic functions to be combined increases, the third generation unit 43D may generate an instruction sequence for each of operations to be combined.

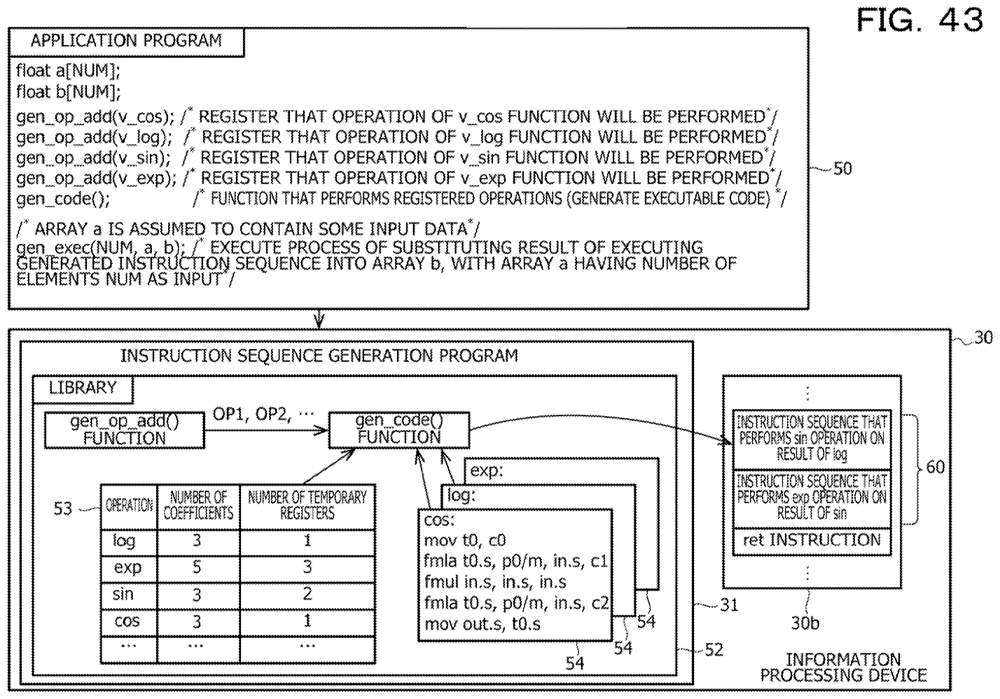

FIG. 43 is a schematic diagram illustrating a flow of processing performed by the information processing device 30 according to the third embodiment.

In this example, the information processing device 30 executes the instruction sequence generation program 31, which is a machine language binary file obtained by compiling an application program 50.

Note that the application program 50 may be compiled by the information processing device 30, or may be compiled by a computer different from the information processing device 30.

It is assumed that each of functions gen_op_add(v_cos), gen_op_add(v_log), gen_op_add(v_sin), gen_op_add(v_exp), gen_code( ), and gen_exec(NUM, a, b) is described in the application program 50.

Among these, the gen_op_add(v_cos) function is a function that registers, in the memory 30b, that the cos operation will be performed in the SIMD registers 35. As an example, the gen_op_add(v_cos) function registers, in the memory 30b, that the cos operation will be performed in the SIMD registers 35, by storing the character string “OP1” indicating that the operation is classified as cos, in a predetermined area of the memory 30b.

Similarly, the gen_op_add(v_log) function is a function that registers, in the memory 30b, that the log operation will be performed in the SIMD registers 35, by storing the character string “OP2” indicating that the type of operation is log, in a predetermined area of the memory 30b.

Similarly, the gen_op_add(v_sin) function is a function that registers, in the memory 30b, that the sin operation will be performed in the SIMD registers 35, by storing the character string “OP3” indicating that the type of operation is sin, in a predetermined area of the memory 30b.

Similarly, the gen_op_add(v_exp) function is a function that registers, in the memory 30b, that the exp operation will be performed in the SIMD registers 35, by storing the character string “OP4” indicating that the type of operation is exp, in a predetermined area of the memory 30b.

Meanwhile, the gen_code( ) function is a function that generates an instruction sequence, using operations represented by the character strings such as “OP1” to “OP4” stored in the memory 30b. Here, it is assumed that the gen_code( ) function generates an instruction sequence 60 for executing an operation exp(sin(log(cos))) that performs cos, log, sin, and exp in this order.

The gen_exec(NUM, a, b) function is a function that stores the execution result of the instruction sequence 60 generated by the gen_code( ) function, in an array b. Note that the input data for the operation executed by the instruction sequence is stored in each element of an array a. In addition, NUM denotes the number of elements of the arrays a and b targeted for the operation exp(sin(log(cos))) to be executed.

The information processing device 30 executes the instruction sequence generation program 31 obtained by compiling such an application program 50. A library 52 is linked to the instruction sequence generation program 31 at the time of compilation. The linked library 52 includes a table 53 in which the number of coefficients involved in an operation and the number of temporary registers to store values during the operation are associated with the operation.

For example, the number of coefficients involved in the cos operation is three, and the number of temporary registers to store values during the cos operation is one. In addition, the number of coefficients involved in the log operation is also three, and the number of temporary registers to store values during the log operation is also one. In addition, the number of coefficients involved in the sin operation is also three, and the number of temporary registers to store values during the sin operation is two. In addition, the number of coefficients involved in the exp operation is five, and the number of temporary registers to store values during the exp operation is three.

Furthermore, the library 52 includes templates 54 of a plurality of instructions involved in operations, for each operation. For example, the template 54 for cos indicates that the cos operation can be executed by executing the respective instructions “mov t0, c0”, “fmla t0.s, p0/m, in.s, c1”, “fmul in.s, in.s, in.s”, “fmla t0.s, p0/m, in.s, c2”, and “mov out.s, t0.s” in this order. Here, in means the input data, tN (N=0, 1, 2, . . . ) means the values during the operation, cN (N=0, 1, 2, . . . ) means coefficients, and out means SIMD registers to separately store the operation results. On the Armv8-A architecture, “.s” means that the SIMD registers are used as SIMD for 32-bit data, and besides, there are “.b”, “.h”, and “.d”, which represent SIMD for 8, 16, and 64-bit data, respectively.

In this case, the generation unit 43 specifies that cos, log, sin, and exp are the operations intended to be executed, by referring to the character strings “OP1”, “OP2”, “OP3”, and “OP4” stored in the memory 30b by the gen_op_add(v_cos), gen_op_add(v_log), gen_op_add(v_sin), and gen_op_add(v_exp) functions, respectively, by executing the gen_code( ) function.

Next, the generation unit 43 specifies each of the number of coefficients and the number of temporary registers corresponding to each of the specified operations cos, log, sin, and exp from the table 53, by executing the gen_code( ) function.

Furthermore, the generation unit 43 specifies the templates 54 corresponding to each of the specified operations cos, log, sin, and exp, by executing the gen_code( ) function.

Then, the generation unit 43 selects a generation method to be used to execute the instruction sequence generation process, based on each of the specified number of coefficients and number of temporary registers, by executing the gen_code( ) function. For example, the generation unit 43 selects one generation method from among the first generation method, the second generation method, the third generation method, and the fourth generation method.

Then, the generation unit 43 generates the instruction sequence 60 in the memory 30b by the selected generation method, based on each of the specified number of coefficients and number of temporary registers, and templates 54, by executing the gen_code( ) function. The generated instruction sequence 60 is an instruction sequence that performs cos, log, sin, and exp in this order as described above. Note that the generation unit 43 appends the ret instruction for returning to the main routine of the instruction sequence generation program 31, to the end of the instruction sequence 60, by executing the gen_code( ) function.

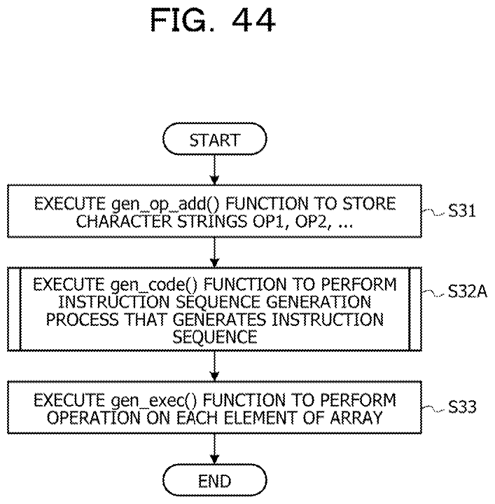

FIG. 44 is a flowchart of an instruction sequence generation method according to the third embodiment. As illustrated in FIG. 44, first, the generation unit 43 stores the character string “OPi” (i=1, 2, . . . ) indicating one or more operations, in the memory 30b, by executing the gen_op_add( ) function (step S31).

Next, the generation unit 43 performs an instruction sequence generation process that generates the instruction sequence 60, by executing the gen_code( ) function (step S32A). The details of the above-mentioned instruction sequence generation process will be described later.

Thereafter, the generation unit 43 performs the operation indicated by the instruction sequence 60 on each element of the array, by executing the gen_exec( ) function (step S33).

With the above, the basic process of the instruction sequence generation method according to the present embodiment is finished. Next, the instruction sequence generation process in step S32A will be described.

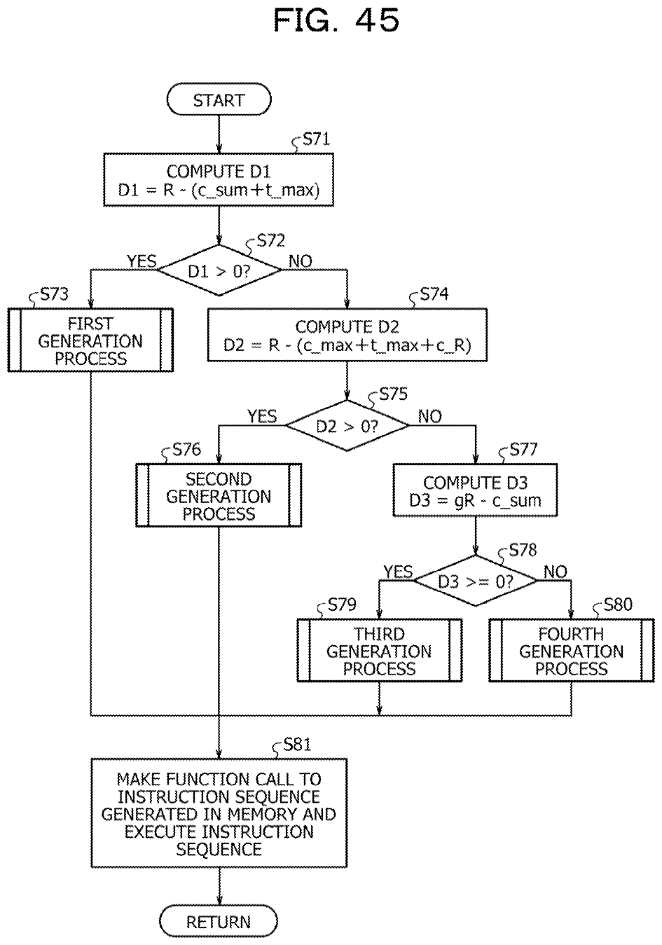

FIG. 45 is a flowchart of the instruction sequence generation process according to the third embodiment. First, the selection unit 43A computes the index value D1 indicating whether or not the SIMD registers 35 are sufficient when the instruction sequence generation process is executed by the first generation method (step S71). The index value D1 is simply computed, for example, based on formula (1) described above.

Then, the selection unit 43A determines whether or not the index value D1 is greater than zero (step S72). When determining that the index value D1 is greater than zero (step S72; Yes), the selection unit 43A selects the first generation method. Then, the first generation unit 43B executes the first generation process by the first generation method (step S73). Note that a flowchart of the first generation process will be described later. Then, the selection unit 43A proceeds to step S81.

On the other hand, when determining that the index value D1 is equal to or less than zero (step S72; No), the selection unit 43A computes the index value D2 indicating whether or not the SIMD registers 35 are sufficient when the instruction sequence generation process is executed by the second generation method (step S74). The index value D2 is simply computed, for example, based on formula (2) described above.

Then, the selection unit 43A determines whether or not the index value D2 is greater than zero (step S75). When determining that the index value D2 is greater than zero (step S75; Yes), the selection unit 43A selects the second generation method. Then, the second generation unit 43C executes the second generation process by the second generation method (step S76). Note that a flowchart of the second generation process will be described later. Then, the selection unit 43A proceeds to step S81.

On the other hand, when determining that the index value D2 is equal to or less than zero (step S75; No), the selection unit 43A computes the index value D3 indicating whether or not the SIMD registers 35 are sufficient when the instruction sequence generation process is executed by the third generation method (step S77). The index value D3 is simply computed, for example, based on formula (3) described above.

Then, the selection unit 43A determines whether or not the index value D3 is equal to or greater than zero (step S78). When determining that the index value D3 is equal to or greater than zero (step S78; Yes), the selection unit 43A selects the third generation method. Then, the third generation unit 43D executes the third generation process by the third generation method (step S79). Note that a flowchart of the third generation process will be described later. Then, the selection unit 43A proceeds to step S81.

On the other hand, when determining that the index value D3 is smaller than zero (step S78; No), the selection unit 43A selects the fourth generation method. Then, the fourth generation unit 43E executes the fourth generation process by the fourth generation method (step S80). Note that a flowchart of the fourth generation process will be described later. Then, the selection unit 43A proceeds to step S81.

Thereafter, in step S81, the generation unit 43 makes a function call (gen_exec( ) to the instruction sequence generated in the memory 30b and executes the instruction sequence (step S81).

With the above, the basic process of the instruction sequence generation process in step S32A is finished. Next, the second generation process in step S76 will be described.

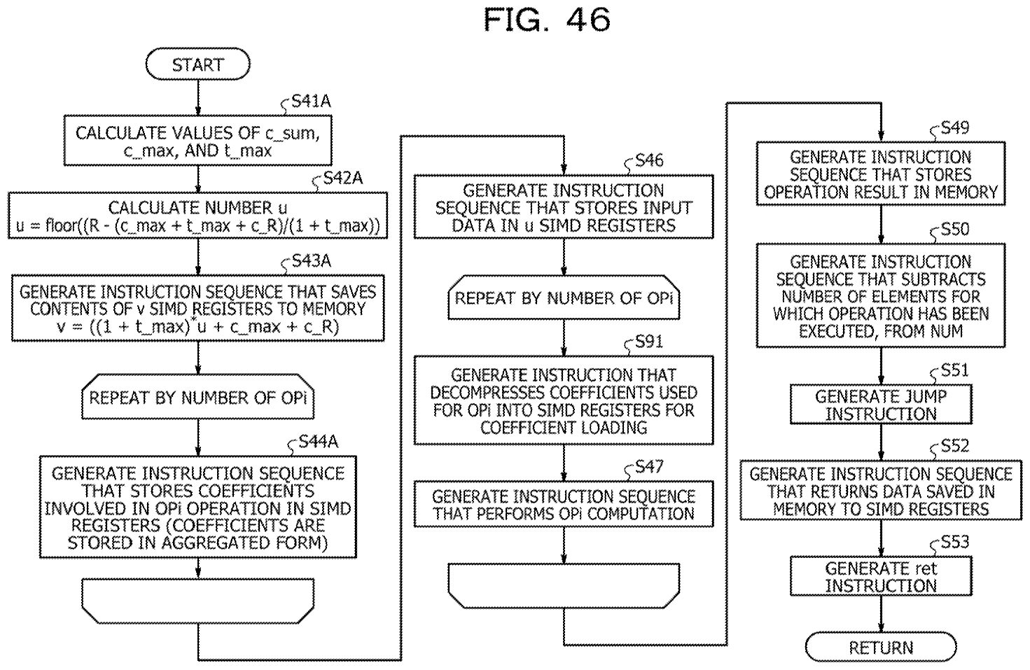

FIG. 46 is a flowchart of the second generation process according to the third embodiment. Note that, in FIG. 46, the same steps as in FIG. 16 will be given the same reference signs as in FIG. 16, and the description thereof will be shortened below.

First, the second generation unit 43C calculates the value of each of c_sum, c_max, and t_max, by referring to the table 53 (step S41A). Among these, c_sum denotes the sum of the number of coefficients involved in each operation indicated by the character strings stored in the memory 30b. Meanwhile, c_max denotes the maximum value of the number of coefficients involved in each operation. In addition, t_max denotes the maximum value of the number of temporary registers involved in each operation.

Next, the second generation unit 43C calculates the number u of SIMD registers 35 that can store the input data in one loop process (step S42A). The method for calculating the number u is not particularly limited, but in the present embodiment, the second generation unit 43C calculates the number u in accordance with the following formula.

u=floor((R−(c_max+t_max+c_R)/(1+t_max))

In the above, R denotes the number of SIMD registers 35, and floor denotes an operation for rounding down decimal places. In addition, the number of SIMD registers 35 involved when coefficient data is compressed and stored is denoted by c_R. In this formula, “R−(c_max+t_max+c_R)” is given for the reason in consideration that the total number of SIMD registers available for use purposes other than the use purpose of storing coefficients in all iterations of the loop process will be “R−(c_max+t_max+c_R)” because “c_max+c_R” of SIMD registers 35, of which the number is R in total, are used to store the compressed coefficients and to store the decompressed coefficients and t_max of SIMD registers 35 are used for operations. In “1+t_max”, it is represented that (1+t_max) SIMD registers 35 are used every time the input data is stored in one SIMD register. This gives the number u of SIMD registers 35 that can accept inputs in one loop process as “floor((R−(c_max+t_max+c_R)/(1+t_max))” as described above.

Next, the second generation unit 43C generates an instruction sequence that saves the contents of v SIMD registers 35 to the memory 30b (step S43A). The method for calculating the number v is not particularly limited, but in the present embodiment, the second generation unit 43C calculates the number v in accordance with the following formula.

v=(1+t_max)×u+c_max+c_R

This is because the maximum value of the number of SIMD registers 35 for storing coefficients is “c_max”, the number of SIMD registers 35 involved when coefficient data is compressed and stored is “c_R”, the number of SIMD registers 35 used in all loop processes is “(1+t_max)×u”, and the contents of all of these SIMD registers 35 have to be saved.

Next, the second generation unit 43C repeats the following process by the number of operations. The second generation unit 43C generates an instruction sequence that stores the coefficients involved in the operation corresponding to the character string “OPi” in the SIMD registers 35 for temporary registers (step S44A). In such a process, the coefficients are stored in an aggregated form, as illustrated in FIGS. 32A and 32B.

Next, the second generation unit 43C generates an instruction sequence that stores the input data in each element of the u SIMD registers 35 (step S46).

Then, the second generation unit 43C repeats the following processes by the number of operations. The second generation unit 43C generates an instruction that decompresses the coefficients used for the character string “OPi” into the SIMD registers 35 for coefficient loading (step S91). Thereafter, the second generation unit 43C generates an instruction sequence that performs the operation corresponding to the character string “OPi” (step S47).

By performing steps S47 by the number of operations in succession in this manner, the instruction sequence 60 (refer to FIG. 43) for executing the combined operations will be obtained.

Next, the second generation unit 43C generates an instruction sequence that stores the operation result in step S47 in the memory 30b (step S49).

Subsequently, the second generation unit 43C generates an instruction that subtracts the number of elements of the array a for which the combined operations have been executed, from NUM (step S50).

Next, the second generation unit 43C determines whether the value obtained by subtracting the number of elements of the array a for which the combined operations have been executed, from NUM is greater than zero and, when determining to be greater than zero, generates a jump instruction that jumps to the top of the instruction sequence generated in step S46 (step S51).

Subsequently, the second generation unit 43C generates an instruction sequence that returns the data saved beforehand in the memory 30b in step S43A to the SIMD registers 35 (step S52).

Thereafter, the second generation unit 43C generates the ret instruction for returning to the main routine (step S53).

With the above, the basic process of the second generation process in step S76 is finished.

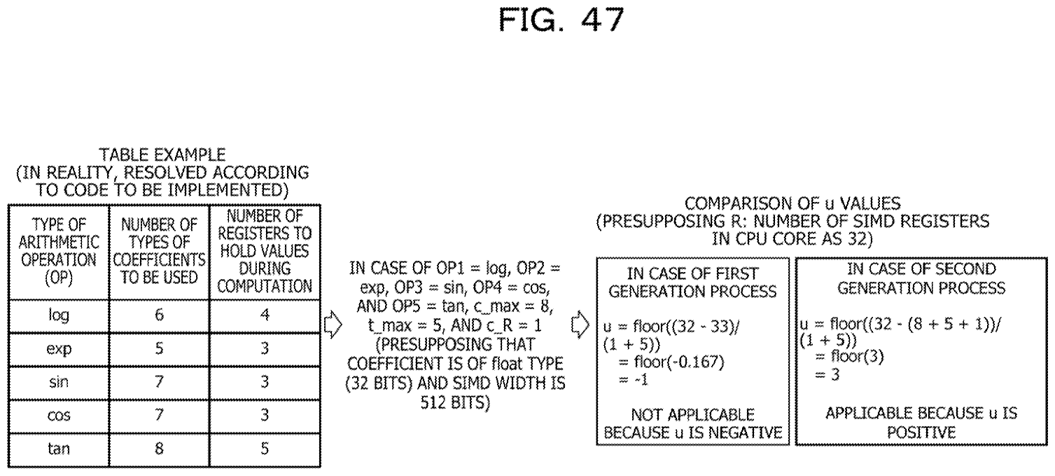

Here, an example of the number u of SIMD registers 35 that can store the input data in one loop process, which is calculated in step S42A, will be described with reference to FIG. 47. FIG. 47 is a diagram illustrating an example of the number u in the second generation process. In the following, it is assumed that the operations indicated by the character strings “OP1”, “OP2”, “OP3”, “OP4”, and “OP5” are log, exp, sin, cos, and tan, respectively. In this case, c_max is eight because c_max denotes the maximum value of the number of coefficients used by each operation. In addition, t_max is five because t_max denotes the maximum value of the number of temporary registers used by each operation. In addition, R denotes the number of SIMD registers 35 and is assumed to be 32. The number of SIMD registers 35 involved when coefficient data is compressed and stored is denoted by c_R, which is one. Note that it is presupposed here that the coefficient is of float type (32 bits) and the width of the SIMD register 35 is 512 bits.

Under such circumstances, in the case of the first generation process, u (=floor((R−c_sum)/(1+t_max))) is calculated as −1 (=floor(32−33)/(1+5)). In such a case, since u is negative, the first generation process is not applicable. Meanwhile, in the case of the second generation process, u (=floor((R−(c_max+t_max+c_R)/(1+t_max))) is calculated as 3 (=floor((32−(8+5+1))/(1+5))). Therefore, the second generation process is applicable because u is positive.

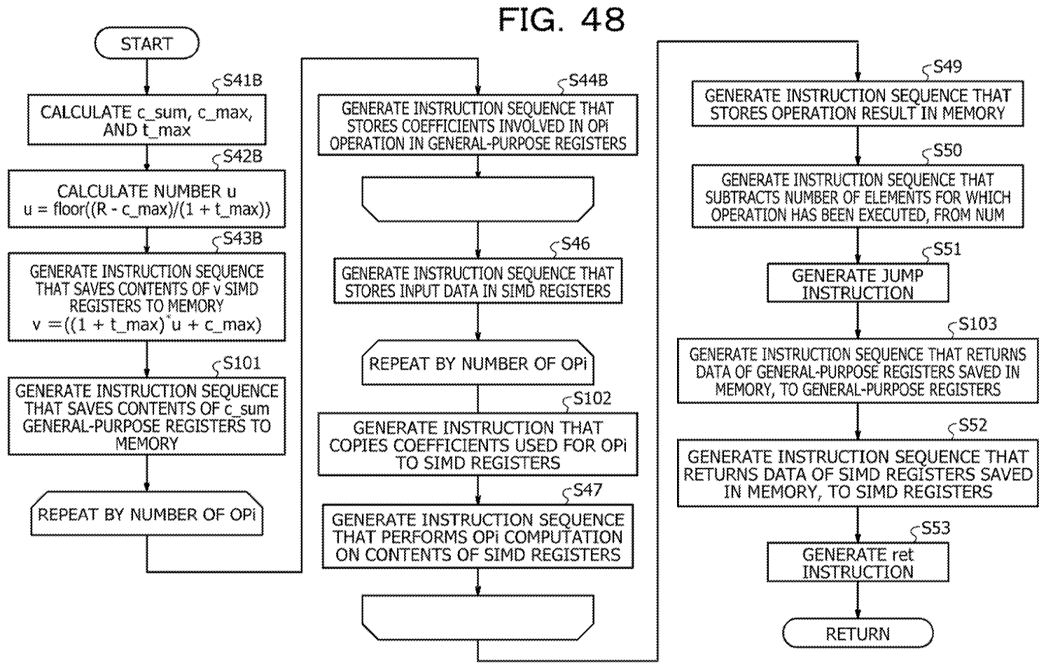

FIG. 48 is a flowchart of the third generation process according to the third embodiment. Note that, in FIG. 48, the same steps as in FIG. 16 will be given the same reference signs as in FIG. 16, and the description thereof will be shortened below.

First, the third generation unit 43D calculates the value of each of c_sum, c_max, and t_max, by referring to the table 53 (step S41B).

Among these, c_sum denotes the sum of the number of coefficients involved in each operation indicated by the character strings stored in the memory 30b. Meanwhile, c_max denotes the maximum value of the number of coefficients involved in each operation. In addition, t_max denotes the maximum value of the number of temporary registers involved in each operation.

Next, the third generation unit 43D calculates the number u of SIMD registers 35 that can store the input data in one loop process (step S42B). The method for calculating the number u is not particularly limited, but in the present embodiment, the third generation unit 43D calculates the number u in accordance with the following formula.

u=floor((R−c_max)/(1+t_max))

In the above, R denotes the number of SIMD registers 35, and floor denotes an operation for rounding down decimal places. In this formula, “R−c_max” is given for the reason in consideration that the total number of SIMD registers available for use purposes other than the use purpose of storing coefficients in all iterations of the loop process will be “R−c_max” because c_max of SIMD registers 35, of which the number is R in total, are used to store coefficients. The reason why the number of SIMD registers 35 used to store coefficients is c_max is that the maximum value of the number of coefficients involved in each operation can be adopted because the coefficients used in an operation are stored immediately before the operation. The maximum value “1+t_max” represents that (1+t_max) SIMD registers 35 are used every time the input data is stored in one SIMD register. This gives the number u of SIMD registers 35 that can accept inputs in one loop process as “floor((R−c_max)/(1+t_max))” as described above.

Next, the third generation unit 43D generates an instruction sequence that saves the contents of v SIMD registers 35 to the memory 30b (step S43B). The method for calculating the number v is not particularly limited, but in the present embodiment, the third generation unit 43D calculates the number v in accordance with the following formula.

v=(1+t_max)×u+c_max

This is because the maximum value of the number of SIMD registers 35 for storing coefficients is “c_max”, the number of SIMD registers 35 used in all loop processes is “(1+t_max)×u”, and the contents of all of these SIMD registers 35 have to be saved.

Then, the third generation unit 43D generates an instruction sequence that saves the contents of c_sum general-purpose registers to the memory 30b (step S101).

Next, the third generation unit 43D repeats the following process by the number of operations. The third generation unit 43D generates an instruction sequence that stores the coefficients involved in the operation corresponding to the character string “OPi” in the general-purpose registers (step S44B).

Next, the third generation unit 43D generates an instruction sequence that stores the input data in each element of the u SIMD registers 35 (step S46).

Then, the third generation unit 43D repeats the following processes by the number of operations. The third generation unit 43D generates an instruction that copies the coefficients used for the character string “OPi” to the SIMD registers 35 for coefficient loading (step S102). Thereafter, the third generation unit 43D generates an instruction sequence that performs the operation corresponding to the character string “OPi” (step S47).

By performing steps S47 by the number of operations in succession in this manner, the instruction sequence 60 (refer to FIG. 43) for executing the combined operations will be obtained.

Next, the third generation unit 43D generates an instruction sequence that stores the operation result in step S47 in the memory 30b (step S49).

Subsequently, the third generation unit 43D generates an instruction that subtracts the number of elements of the array a for which the combined operations have been executed, from NUM (step S50).

Next, the third generation unit 43D determines whether the value obtained by subtracting the number of elements of the array a for which the combined operations have been executed, from NUM is greater than zero and, when determining to be greater than zero, generates a jump instruction that jumps to the top of the instruction sequence generated in step S46 (step S51).

Subsequently, the third generation unit 43D generates an instruction sequence that returns the data saved beforehand in the memory 30b in step S101 to the general-purpose registers (step S103). In addition, the third generation unit 43D generates an instruction sequence that returns the data saved beforehand in the memory 30b in step S43B to the SIMD registers 35 (step S52).

Thereafter, the third generation unit 43D generates the ret instruction for returning to the main routine (step S53).

With the above, the basic process of the third generation process in step S79 is finished.

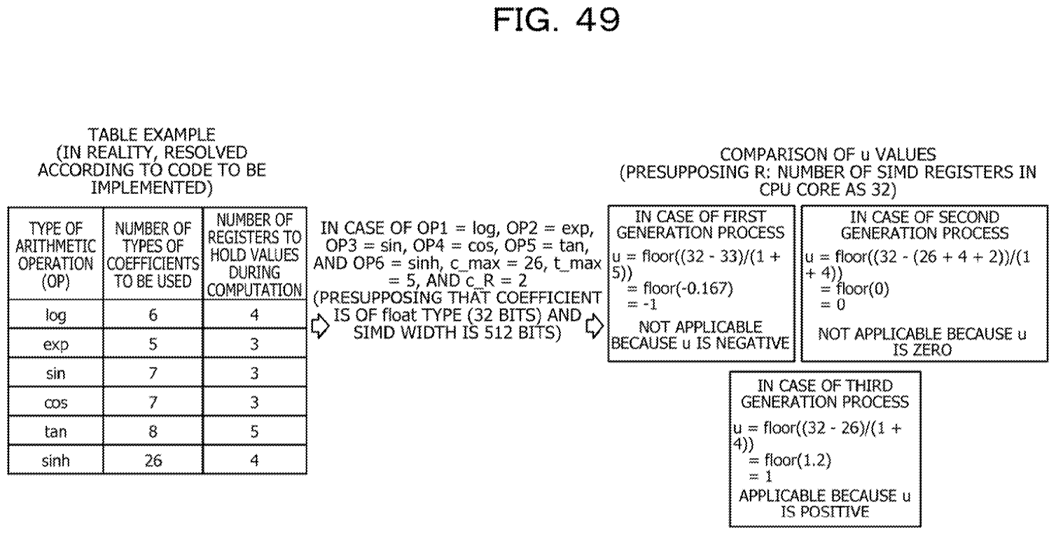

Here, an example of the number u of SIMD registers 35 that can store the input data in one loop process, which is calculated in step S42B, will be described with reference to FIG. 49. FIG. 49 is a diagram illustrating an example of the number u in the third generation process. In the following, it is assumed that the operations indicated by the character strings “OP1”, “OP2”, “OP3”, “OP4”, “OP5”, and “OP6” are log, exp, sin, cos, tan, and sinh, respectively. In this case, c_max is 26 because c_max denotes the maximum value of the number of coefficients used by each operation. In addition, t_max is five because t_max denotes the maximum value of the number of temporary registers used by each operation. In addition, R denotes the number of SIMD registers 35 and is assumed to be 32. The number of SIMD registers 35 involved when coefficient data is compressed and stored is denoted by c_R, which is two. Note that it is presupposed here that the coefficient is of float type (32 bits) and the width of the SIMD register 35 is 512 bits.

Under such circumstances, in the case of the first generation process, u (=floor((R−c_sum)/(1+t_max))) is calculated as −1 (=floor(32−33)/(1+5)). In such a case, since u is negative, the first generation process is not applicable. In addition, in the case of the second generation process, u (=floor((R−(c_max+t_max+c_R)/(1+t_max))) is calculated as −1 (=floor((32−(26+5+2))/(1+5))). In such a case, since u is negative, the second generation process is not applicable. On the other hand, in the case of the third generation process, u (=floor((R−c_max)/(1+t_max))) is calculated as 1 (=floor((32−26/(1+5))). Therefore, the third generation process is applicable because u is positive.

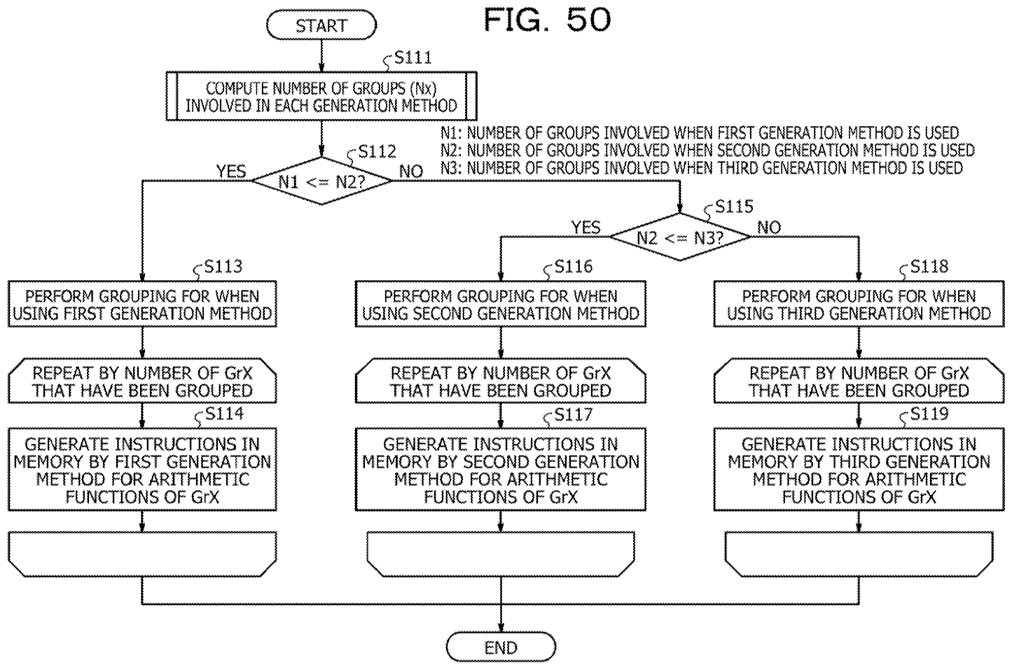

FIG. 50 is a flowchart of the fourth generation process according to the third embodiment.

First, the fourth generation unit 43E computes the number of groups (Nx) involved in each generation method (step S111). Note that a flowchart of the group count computation process will be described later. Here, the number of groups involved when the first generation method is used is assumed as N1. The number of groups involved when the second generation method is used is assumed as N2. The number of groups involved when the third generation method is used is assumed as N3.

Then, the fourth generation unit 43E determines whether or not N1 is equal to or less than N2 (step S112). When determining that N1 is equal to or less than N2 (step S112; Yes), the fourth generation unit 43E performs grouping for when using the first generation method (step S113).

Next, the fourth generation unit 43E repeats the following process by the number of groups GrX that have been grouped. The fourth generation unit 43E generates instructions in the memory 30b by the first generation method for the arithmetic functions included in the group GrX (step S114).

On the other hand, when determining that N1 is greater than N2 (step S112; No), the fourth generation unit 43E determines whether or not N2 is equal to or less than N3 (step S115). When determining that N2 is equal to or less than N3 (step S115; Yes), the fourth generation unit 43E performs grouping for when using the second generation method (step S116).

Next, the fourth generation unit 43E repeats the following process by the number of groups GrX that have been grouped. The fourth generation unit 43E generates instructions in the memory 30b by the second generation method for the arithmetic functions included in the group GrX (step S117).

On the other hand, when determining that N2 is greater than N3 (step S115; No), the fourth generation unit 43E performs grouping for when using the third generation method (step S118).

Next, the fourth generation unit 43E repeats the following process by the number of groups GrX that have been grouped. The fourth generation unit 43E generates instructions in the memory 30b by the third generation method for the arithmetic functions included in the group GrX (step S119).

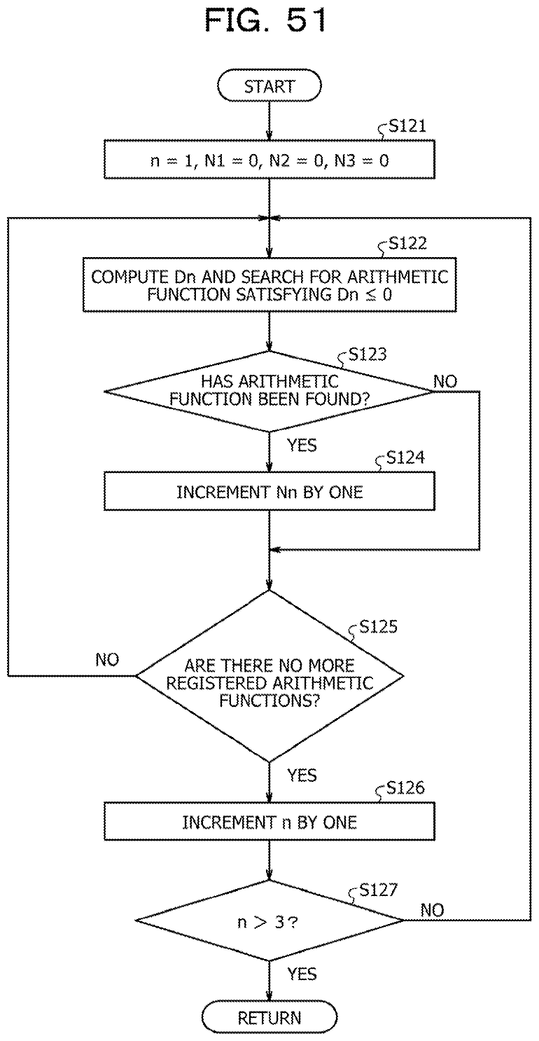

Here, a flowchart of the group count computation process will be described with reference to FIG. 51. FIG. 51 is a flowchart of the group count computation process.

First, the fourth generation unit 43E sets an index n to one and sets N1, N2, and N3 to zero as an initial value (step S121). Note that, when n has one, this means that the first generation method is concerned. When n has two, this means that the second generation method is concerned. When n has three, this means that the third generation method is concerned.

Then, the fourth generation unit 43E computes Dn for successive arithmetic functions and searches for an arithmetic function satisfying Dn≤0 (step S122). For example, when n has one, the fourth generation unit 43E computes D1 for successive arithmetic functions, using the selection formula indicated in step S71, and searches for an arithmetic function satisfying D1≤0. When n has two, the fourth generation unit 43E computes D2 for successive arithmetic functions, using the selection formula indicated in step S74, and searches for an arithmetic function satisfying D2≤0. When n has three, the fourth generation unit 43E computes D3 for successive arithmetic functions, using the determination formula indicated in step S77, and searches for an arithmetic function satisfying D3≤0.

Then, the fourth generation unit 43E determines whether or not an arithmetic function has been found (step S123). When determining that an arithmetic function has been found (step S123; Yes), the fourth generation unit 43E increments Nn by one (step S124). For example, when the i-th arithmetic function satisfying Dn≤0 has been found by computing Dn of the first to i-th arithmetic functions among the successive arithmetic functions, the fourth generation unit 43E treats the arithmetic functions 1 to i−1 as one group and increments Nn by one. In addition, when the i+k-th arithmetic function satisfying Dn≤0 has been found by computing Dn of the i-th to i+k-th arithmetic functions among the successive arithmetic functions, the fourth generation unit 43E treats the arithmetic functions i to i+k−1 as one group and increments Nn by one.

Then, the fourth generation unit 43E determines whether or not there are no more registered arithmetic functions (step S125). When not determining that there are no more registered arithmetic functions (step S125; No), the fourth generation unit 43E proceeds to step S122 to find the next group.

On the other hand, when determining that there are no more registered arithmetic functions (step S125; Yes), the fourth generation unit 43E increments the index n by one (step S126). Then, the fourth generation unit 43E determines whether or not the index n is greater than three (step S127). When determining that the index n is equal to or less than three (step S127; No), the fourth generation unit 43E proceeds to step S127 to compute the number of groups in the next generation method.

On the other hand, when determining that the index n is greater than three (step S127; Yes), the fourth generation unit 43E ends the group count computation process.

Consequently, the fourth generation unit 43E divides the arithmetic functions into groups on the basis of the selection formulas for D1, D2, and D3 and generates instruction sequences for each group, using a generation method with the smallest number of groups. As a result, even if the number of arithmetic functions increases so much that it is impracticable to generate instruction sequences by simply using the first generation method, the second generation method, and the third generation method, the fourth generation unit 43E may generate instruction sequences for each of operations to be combined.

With the above, the basic process of the fourth generation process in step S80 is finished. According to the third embodiment described above, even if the number of arithmetic functions to be combined increases, instruction sequences may be generated by using any one of the second to fourth generation methods for each of operations to be combined, and arithmetic by arithmetic functions to be combined may be performed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an instruction sequence generation program for causing a computer to execute a process comprising:
inputting an instruction sequence for an assembler that processes predetermined operations;
specifying first registers designated as transfer destination operands and second registers designated as transfer source operands, for each of a plurality of instructions;
specifying the first registers in a predetermined instruction as registers intended to hold data from an immediately following instruction to an instruction in which the first registers in the predetermined instruction are used as the transfer source operands;
propagating, for each of the instructions, an indication, as to whether the second registers and the registers intended to hold the data are registers that hold values dependent on input values of the predetermined operations, from immediately preceding instructions;
distinguishing, for each of the instructions, whether the first registers are the registers that are to hold the values dependent on the input values, according to whether the second registers of the instruction include the registers that are to hold the values dependent on the input values;
computing a first number of registers required to hold the values dependent on the input values and a second number of registers required to hold values independent on the input values, for the input instruction sequence;
generating, for each of the predetermined operations, count information on the registers in which the first number of the registers required to hold the values dependent on the input values is treated as a number of temporary registers that store the values during the operations, and the second number of registers required to hold the values independent of the input values is treated as a number of coefficients; and
generating a new instruction sequence that performs the predetermined operations on the input values, of which a number equals to the number of a plurality of first single instruction multiple data (SIMD) registers, by using the count information on the registers.

2. The non-transitory computer-readable recording medium according to claim 1, wherein in the generating the count information on the registers,
reallocating register numbers that distinguish between the registers that are to hold the values dependent on the input values and the registers that are to hold the values independent of the input values, from a top instruction to a last instruction of the instruction sequence for the predetermined operations, and generating the count information on the registers based on the reallocated register numbers.

3. The non-transitory computer-readable recording medium according to claim 2, the process further comprising
replacing operands of the instruction sequence for the predetermined operations with the registers indicated by the reallocated register numbers.

4. The non-transitory computer-readable recording medium according to claim 1, wherein in the generating the new instruction sequence,
specifying the number of the plurality of the first SIMD registers, based on the count information on the registers;
specifying a first instruction and a second instruction involved in a first operation;
duplicating the first instruction by the number of the first SIMD registers, by setting some of the plurality of the first SIMD registers for operands of the specified first instruction;
duplicating the second instruction by the number of the first SIMD registers, by setting some of the plurality of the first SIMD registers for the operands of the specified second instruction; and
generating a first instruction sequence that performs the first operation with the plurality of the first SIMD registers, by arranging a plurality of duplicates of the first instruction and a plurality of duplicates of the second instruction such that the first instruction and the second instruction in which same ones of the first SIMD registers are set as the operands are not adjacent to each other.

5. The non-transitory computer-readable recording medium according to claim 4, wherein in the generating the instruction sequence,
generating, at a position before the first instruction sequence, a third instruction that stores a first coefficient involved in the first operation in a second SIMD register;
generating, at the position after the first instruction sequence, a fourth instruction that jumps to a position between the first instruction sequence and the third instruction; and
wherein no instruction same as the third instruction is generated at any position between the third instruction and the fourth instruction.

6. The non-transitory computer-readable recording medium according to claim 5, wherein in the generating the instruction sequence,
specifying a fifth instruction and a sixth instruction involved in a second operation;
duplicating the fifth instruction by the number of the first SIMD registers, by setting some of the plurality of the first SIMD registers for operands of the specified fifth instruction;
duplicating the sixth instruction by the number of the first SIMD registers, by setting some of the plurality of the first SIMD registers for operands of the specified sixth instruction;
generating a second instruction sequence that performs the second operation with the plurality of the first SIMD registers, by arranging a plurality of duplicates of the fifth instruction and a plurality of duplicates of the sixth instruction such that the fifth instruction and the sixth instruction in which same ones of the first SIMD registers are set as the operands are not adjacent to each other;
generating, at the position before the second instruction sequence, a seventh instruction that stores a second coefficient involved in the second operation in a third SIMD register; and
wherein an eighth instruction that stores contents of the second SIMD register in a memory and a ninth instruction that stores the contents of the third SIMD register in the memory are not generated at any position between the first instruction sequence and the second instruction sequence.

7. The non-transitory computer-readable recording medium according to claim 6, wherein in the generating the instruction sequence,
generating the eighth instruction at a position before the third instruction; and
generating the ninth instruction at a position before the seventh instruction.

8. The non-transitory computer-readable recording medium according to claim 4, the process further comprising
executing a first generation process that generates the instruction sequence that performs each of the operations with the plurality of SIMD registers, when the number of the SIMD registers is more than a first number obtained by adding a maximum number of the number of the temporary registers that store the values during each of the operations to the number of the coefficients involved in each of the operations that include the first operation, and
executing generating the instruction sequence that performs each of the operations, by using a generation process different from the first generation process, when the number of the SIMD registers is less than the number that includes the first number.

9. The non-transitory computer-readable recording medium according to claim 8, wherein the generation process different from the first generation process is a second generation process that generates the instruction sequence that performs each of the operations with the plurality of SIMD registers,
the second operation process includes
compressing the coefficients involved in each of the operations to store the compressed coefficients in the SIMD registers, and
decompressing the compressed coefficients into other SIMD registers at a time of the operations, when the number of the SIMD registers is less than the number that includes the first number, and the number of the SIMD registers is more than a second number obtained by adding the maximum number of the number of the temporary registers that store the values during each of the operations and the number of the SIMD registers required when the coefficients involved in each of the operations are compressed and stored, to the maximum number of the number of the coefficients involved in each of the operations.

10. The non-transitory computer-readable recording medium according to claim 9, wherein the generation process different from the first generation process is a third generation process that generates the instruction sequence that performs each of the operations,
the third operation process uses general-purpose registers and the plurality of SIMD registers, when the number of the SIMD registers is less than the number that includes the second number, and the number of the general-purpose registers is more than the number that includes the number of the coefficients involved in each of the operations.

11. The non-transitory computer-readable recording medium according to claim 10, wherein
the executing includes grouping successive operations into groups from a top, for each of the first generation process, the second generation process, and the third generation process, and generating the instruction sequence that performs each of the operations, by using one of the first generation process, the second generation process, and the third generation process, based on the number of the groups, when the number of the SIMD registers is less than the number that includes the second number, and the number of the general-purpose registers is less than the number of the coefficients involved in each of the operations.

12. The non-transitory computer-readable recording medium according to claim 11, wherein
the executing includes generating the instruction sequence that performs each of the operations, by using a generation method in which the number of the groups has a least number, among the first generation process, the second generation process, and the third generation process.

13. A instruction sequence generation method performed by a computer, the method comprising:
inputting an instruction sequence for an assembler that processes predetermined operations;
specifying first registers designated as transfer destination operands and second registers designated as transfer source operands, for each of a plurality of instructions;
specifying the first registers in a predetermined instruction as registers intended to hold data from an immediately following instruction to an instruction in which the first registers in the predetermined instruction are used as the transfer source operands;
propagating, for each of the instructions, an indication, as to whether the second registers and the registers intended to hold the data are registers that hold values dependent on input values of the predetermined operations, from immediately preceding instructions;
distinguishing, for each of the instructions, whether the first registers are the registers that are to hold the values dependent on the input values, according to whether the second registers of the instruction include the registers that are to hold the values dependent on the input values;
computing a first number of registers required to hold the values dependent on the input values and a second number of registers required to hold values independent on the input values, for the input instruction sequence;
generating, for each of the predetermined operations, count information on the registers in which the first number of the registers required to hold the values dependent on the input values is treated as a number of temporary registers that store the values during the operations, and the second number of registers required to hold the values independent of the input values is treated as a number of coefficients; and
generating a new instruction sequence that performs the predetermined operations on the input values, of which a number equals to the number of a plurality of first single instruction multiple data (SIMD) registers, by using the count information on the registers.

14. An information processing device comprising:
a memory, and
a processor coupled to the memory and configured to:
input an instruction sequence for an assembler that processes predetermined operations;
specify first registers designated as transfer destination operands and second registers designated as transfer source operands, for each of a plurality of instructions;
specify the first registers in a predetermined instruction as registers intended to hold data from an immediately following instruction to an instruction in which the first registers in the predetermined instruction are used as the transfer source operands;
propagate, for each of the instructions, an indication, as to whether the second registers and the registers intended to hold the data are registers that hold values dependent on input values of the predetermined operations, from immediately preceding instructions;
distinguish, for each of the instructions, whether the first registers are the registers that are to hold the values dependent on the input values, according to whether the second registers of the instruction include the registers that are to hold the values dependent on the input values;
compute a first number of registers required to hold the values dependent on the input values and a second number of registers required to hold values independent on the input values, for the input instruction sequence;
generate, for each of the predetermined operations, count information on the registers in which the first number of the registers required to hold the values dependent on the input values is treated as a number of temporary registers that store the values during the operations, and the second number of registers required to hold the values independent of the input values is treated as a number of coefficients; and
generate a new instruction sequence that performs the predetermined operations on the input values, of which a number equals to the number of a plurality of first single instruction multiple data (SIMD) registers, by using the count information on the registers.
